(19) United States
(12) Patent Application Publication
(10) Pub. No.: US 2025/0293248 A1
(43) Pub. Date: Sep. 18, 2025

(54) SECONDARY BATTERY, ELECTRONIC DEVICE, POWER STORAGE SYSTEM, AND VEHICLE

(71) Applicant: SEMICONDUCTOR ENERGY LABORATORY CO., LTD., Atsugi-shi (JP)

(72) Inventors: Kazutaka KURIKI, Ebina (JP); Taisuke NAKAO, Atsugi (JP); Teruaki OCHIAI, Atsugi (JP); Tatsuyoshi TAKAHASHI, Atsugi (JP); Shunpei YAMAZAKI, Tokyo (JP)

(21) Appl. No.: 19/093,417

(22) Filed: Mar. 28, 2025

Related U.S. Application Data
(63) Continuation of application No. 18/257,335, filed on Jun. 14, 2023.

(30) Foreign Application Priority Data
Dec. 16, 2020 (JP) 2020-208653

(51) Int. Cl. H01M 4/36; H01G 11/36; H01G 11/50; H01M 4/02; H01M 4/133; H01M 4/134; H01M 4/38; H01M 4/587; H01M 10/0525; H01M 10/0568

(52) U.S. Cl. CPC H01M 4/366; H01M 4/133; H01M 4/134; H01M 4/386; H01M 4/587; H01M 10/0525; H01M 10/0568; H01G 11/36; H01G 11/50; H01M 2004/021; H01M 2004/027

(57) ABSTRACT

A secondary battery has a high capacity and little deterioration can be provided. Alternatively, a novel power storage device is provided. The secondary battery includes a positive electrode and a negative electrode. The negative electrode includes a first active material, a second active material, and a graphene compound. At least part of a surface of the first active material includes a region covered with the second active material. A surface of the second active material and at least part of the surface of the first active material each include a region covered with the graphene compound. The first active material includes graphite. The second active material includes silicon. The capacity of the positive electrode is greater than or equal to 50% and less than 100% of the capacity of the negative electrode.

### CROSS REFERENCE TO RELATED APPLICATIONS

This application is a continuation of U.S. application Ser. No. 18/257,335, filed Jun. 14, 2023, now pending, which is incorporated by reference and is a U.S. National Phase Application under 35 U.S.C. § 371 of International Application PCT/IB2021/061269, filed on Dec. 3, 2021, which is incorporated by reference and claims the benefit of a foreign priority application filed in Japan on Dec. 16, 2020, as Application No. 2020-208653.

### TECHNICAL FIELD

One embodiment of the present invention relates to an electrode and a method for fabricating the electrode. Another embodiment of the present invention relates to an active material included in an electrode and a method for fabricating the active material. Another embodiment of the present invention relates to a secondary battery and a method for fabricating the secondary battery. Another embodiment of the present invention relates to a moving vehicle such as a vehicle, a portable information terminal, an electronic device, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that power storage devices in this specification refer to any elements and devices having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential for today's information society as rechargeable energy supply sources.

### REFERENCE

### [Patent Document]

[Patent Document 1] Japanese Published Patent Application No. 2002-216751
[Patent Document 2] Japanese Translation of PCT International Application No. 2019-522886

### SUMMARY OF THE INVENTION

### Problems to be Solved by the Invention

Capacity of secondary batteries used in moving vehicles such as electric vehicles or hybrid vehicles need to be increased for longer driving ranges.

Furthermore, portable terminals and the like have more and more functions, resulting in an increase in power consumption. In addition, reductions in size and weight of secondary batteries used for portable terminals and the like are demanded. Therefore, secondary batteries used for portable terminals are also desired to have higher capacity.

It is important for secondary batteries to have high capacity as well as their stability. An alloy-based material such as a silicon-based material has high capacity and thus is promising as an active material of a secondary battery. However, an alloy-based material with high charge and discharge capacity causes problems such as pulverization and detachment of an active material due to a volume change in charging and discharging and thus has not achieved sufficient cycle performance.

In order to solve the above problems of an alloy-based material, a combination of an alloy-based material and graphite or a carbonaceous material has been considered. Patent Document 1 describes a composite material in which a covering layer formed of carbon is formed on a surface of a porous particle nucleus in which a silicon-containing particle and a carbon-containing particle are bonded to each other. Patent Document 2 describes a composite particle containing silicon (Si), lithium fluoride (LiF), and a carbon material. However, neither of the above documents has solved the problems such as pulverization and detachment of an active material due to expansion of an alloy-based material in charging and discharging.

An electrode of a secondary battery is formed using, for example, materials such as an active material, a conductive material, and a binder. As the proportion of a material that contributes to charge and discharge capacity, e.g., an active material, becomes higher, a secondary battery can have increased capacity. When an electrode includes a conductive material, the conductivity of the electrode is increased and excellent output characteristics can be obtained. Repeated expansion and contraction of an active material in charging and discharging of a secondary battery may cause collapse of the active material, blocking of a conductive path, or the like in an electrode. In such a case, a conductive material and a binder included in an electrode can inhibit collapse of an active material and blocking of a conductive path. Meanwhile, the use of a conductive material and a binder lowers the proportion of an active material, which might decrease the capacity of a secondary battery.

An object of one embodiment of the present invention is to provide an electrode with excellent characteristics. Another object of one embodiment of the present invention is to provide an active material with excellent characteristics. Another object of one embodiment of the present invention is to provide a novel electrode.

Another object of one embodiment of the present invention is to provide a negative electrode with mechanical strength. Another object of one embodiment of the present invention is to provide a positive electrode with mechanical strength. Another object of one embodiment of the present invention is to provide a negative electrode with high capacity. Another object of one embodiment of the present invention is to provide a positive electrode with high capacity. Another object of one embodiment of the present invention is to provide a negative electrode with little deterioration. Another object of one embodiment of the present invention is to provide a positive electrode with little deterioration.

Another object of one embodiment of the present invention is to provide a secondary battery with little deterioration. Another object of one embodiment of the present invention is to provide a secondary battery with high safety. Another object of one embodiment of the present invention is to provide a secondary battery with high energy density. Another object of one embodiment of the present invention is to provide a novel secondary battery

Note that the description of these objects does not preclude the existence of other objects. One embodiment of the present invention does not need to achieve all these objects. Other objects can be derived from the description of the specification, the drawings, and the claims.

### Means for Solving the Problems

One embodiment of the present invention is a secondary battery including a positive electrode and a negative electrode. The negative electrode includes a first active material, a second active material, and a graphene compound. At least part of a surface of the first active material includes a region covered with the second active material. A surface of the second active material and at least part of the surface of the first active material each include a region covered with the graphene compound. The first active material includes graphite. The second active material includes silicon. The capacity of the positive electrode is greater than or equal to 50% and less than 100% of the capacity of the negative electrode.

One embodiment of the present invention is a secondary battery including a positive electrode and a negative electrode. The negative electrode includes a first active material, a second active material, and a graphene compound. At least part of a surface of the first active material includes a region covered with the second active material. A surface of the second active material and at least part of the surface of the first active material each include a region covered with the graphene compound. The first active material includes graphite. The second active material includes silicon. The second active material has a Si—Si bond in a fully charged state.

One embodiment of the present invention is a secondary battery including a positive electrode, a negative electrode, and an electrolyte. The negative electrode includes a first active material, a second active material, and a graphene compound. At least part of a surface of the first active material includes a region covered with the second active material. A surface of the second active material and at least part of the surface of the first active material each include a region covered with the graphene compound. The first active material includes graphite. The second active material includes silicon. The capacity of the positive electrode is greater than or equal to 50% and less than 100% of the capacity of the negative electrode. The electrolyte includes an ionic liquid.

One embodiment of the present invention is a secondary battery including a positive electrode, a negative electrode, and an electrolyte. The negative electrode includes a first active material, a second active material, and a graphene compound. At least part of a surface of the first active material includes a region covered with the second active material. A surface of the second active material and at least part of the surface of the first active material each include a region covered with the graphene compound. The first active material includes graphite. The second active material includes silicon. The second active material has a Si—Si bond in a fully charged state. The electrolyte includes an ionic liquid.

In the secondary battery described in any of the above, the ionic liquid desirably contains LiFSI at 2 mol/L or more, and EMI-FSI.

In the secondary battery described in any of the above, it is desirable that the positive electrode contain lithium cobalt oxide containing magnesium, fluorine, aluminum, and nickel, and a surface portion of the lithium cobalt oxide include a region with the highest concentration of one or more selected from magnesium, fluorine, and aluminum.

In the secondary battery described in any of the above, it is desirable that the first active material include graphite with a particle diameter of greater than or equal to 5 μm, and the second active material include silicon with a particle diameter of less than or equal to 250 nm.

One embodiment of the present invention is a vehicle including the secondary battery described in any of the above.

One embodiment of the present invention is a power storage system including the secondary battery described in any of the above.

One embodiment of the present invention is an electronic device including the secondary battery described in any of the above.

### Effect of the Invention

According to one embodiment of the present invention, an active material with excellent characteristics can be provided. Alternatively, an electrode with excellent characteristics can be provided. According to one embodiment of the present invention, a novel electrode can be provided.

According to one embodiment of the present invention, a negative electrode with mechanical strength can be provided. According to one embodiment of the present invention, a positive electrode with mechanical strength can be provided. According to one embodiment of the present invention, a negative electrode with high capacity can be provided. According to one embodiment of the present invention, a positive electrode with high capacity can be provided. According to one embodiment of the present invention, a negative electrode with little deterioration can be provided. According to one embodiment of the present invention, a positive electrode with little deterioration can be provided.

According to one embodiment of the present invention, a secondary battery with little deterioration can be provided. According to one embodiment of the present invention, a secondary battery with high safety can be provided. According to one embodiment of the present invention, a secondary battery with high energy density can be provided. According to one embodiment of the present invention, a novel secondary battery can be provided.

Note that the description of these effects does not preclude the existence of other effects. One embodiment of the present invention does not need to have all these effects. Other effects will be apparent from and can be derived from the description of the specification, the drawings, the claims, and the like.

### BRIEF DESCRIPTION OF THE DRAWINGS

FIG. 1A and FIG. 1B are diagrams illustrating an example of a cross section of an electrode. FIG. 1C is a graph showing the capacity ratio between a positive electrode and a negative electrode.

FIG. 2A to FIG. 2C are graphs showing the capacity ratio between a positive electrode and a negative electrode and the voltage of a secondary battery.

FIG. 3A is a diagram illustrating an example of a particle included in a negative electrode. FIG. 3B and FIG. 3C are diagrams illustrating change in shape of a particle in charging and discharging.

FIG. 4A and FIG. 4B are diagrams relating to calculation for a negative electrode of one embodiment of the present invention.

FIG. 5 is a graph relating to calculation for a negative electrode of one embodiment of the present invention.

FIG. 6A to FIG. 6C are diagrams relating to calculation for a negative electrode of one embodiment of the present invention.

FIG. 7 is a chart showing an example of a method for fabricating an electrode.

FIG. 8A and FIG. 8B show examples of models of a graphene compound.

FIG. 9 is a diagram illustrating a cross-sectional structure of a positive electrode of one embodiment of the present invention.

FIG. 10A1 to FIG. 10C2 are diagrams illustrating cross-sectional structures of a positive electrode active material composite of one embodiment of the present invention.

FIG. 11A is a top view of a positive electrode active material of one embodiment of the present invention, and FIG. 11B and FIG. 11C are cross-sectional views of the positive electrode active material of one embodiment of the present invention.

FIG. 12 is a diagram illustrating crystal structures of a positive electrode active material of one embodiment of the present invention.

FIG. 13 shows XRD patterns calculated from crystal structures.

FIG. 14 is a diagram illustrating crystal structures of a positive electrode active material that is a comparative example.

FIG. 15 shows XRD patterns calculated from crystal structures.

FIG. 16 is an example of a TEM image in which crystal orientations are substantially aligned with each other.

FIG. 17A is an example of a STEM image in which crystal orientations are substantially aligned with each other. FIG. 17B shows FFT of a region of a rock-salt crystal RS, and FIG. 17C shows FFT of a region of a layered rock-salt crystal LRS.

FIG. 18A is an exploded perspective view of a coin-type secondary battery, FIG. 18B is a perspective view of the coin-type secondary battery, and FIG. 18C is a cross-sectional perspective view thereof.

FIG. 19A illustrates an example of a cylindrical secondary battery. FIG. 19B illustrates an example of a cylindrical secondary battery. FIG. 19C illustrates an example of a plurality of cylindrical secondary batteries. FIG. 19D illustrates an example of a power storage system including a plurality of cylindrical secondary batteries.

FIG. 20A and FIG. 20B are diagrams illustrating examples of a secondary battery, and FIG. 20C is a diagram illustrating the internal state of the secondary battery.

FIG. 21A to FIG. 21C are diagrams illustrating an example of a secondary battery.

FIG. 22A and FIG. 22B are diagrams illustrating external views of secondary batteries.

FIG. 23A to FIG. 23C are diagrams illustrating a method for fabricating a secondary battery.

FIG. 24A to FIG. 24C are diagrams illustrating structure examples of a battery pack.

FIG. 25A and FIG. 25B are diagrams illustrating examples of a secondary battery.

FIG. 26A to FIG. 26C are diagrams illustrating examples of a secondary battery.

FIG. 27A and FIG. 27B are diagrams illustrating examples of a secondary battery.

FIG. 28A is a perspective view of a battery pack of one embodiment of the present invention, FIG. 28B is a block diagram of the battery pack, and FIG. 28C is a block diagram of a vehicle having a motor.

FIG. 29A to FIG. 29D are diagrams illustrating examples of transport vehicles.

FIG. 30A and FIG. 30B are diagrams illustrating a power storage device of one embodiment of the present invention.

FIG. 31A is a diagram illustrating an electric bicycle, FIG. 31B is a diagram illustrating a secondary battery of the electric bicycle, and FIG. 31C is a diagram illustrating an electric motorcycle.

FIG. 32A to FIG. 32D are diagrams illustrating examples of electronic devices.

FIG. 33A illustrates examples of wearable devices, FIG. 33B is a perspective view of a watch-type device, and FIG. 33C is a diagram illustrating a side surface of the watch-type device. FIG. 33D is a diagram illustrating an example of wireless earphones.

FIG. 34A and FIG. 34B show SEM images of an electrode.

FIG. 35A and FIG. 35B are graphs showing cycle performance.

FIG. 36A and FIG. 36B are graphs showing cycle performance.

FIG. 37A and FIG. 37B are graphs showing discharge characteristics.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

In the drawings, the size, the layer thickness, or the region is exaggerated for clarity in some cases. Therefore, they are not limited to the illustrated scale.

The ordinal numbers such as “first” and “second” in this specification and the like are used for convenience and do not denote the order of steps or the stacking order of layers. Therefore, for example, the term “first” can be replaced with the term “second”, “third”, or the like as appropriate. In addition, the ordinal numbers in this specification and the like do not sometimes correspond to the ordinal numbers that are used to specify one embodiment of the present invention.

In this specification and the like, particles are not necessarily spherical (with a circular cross section). The cross-sectional shapes of particles may be an ellipse, a rectangle, a trapezoid, a triangle, a quadrilateral with rounded corners, and an asymmetrical shape, and a particle may have an indefinite shape.

### Embodiment 1

In this embodiment, examples of a secondary battery of one embodiment of the present invention will be described.

### Structure Example of Secondary Battery

A secondary battery including a positive electrode, a negative electrode, and an electrolyte will be described below.

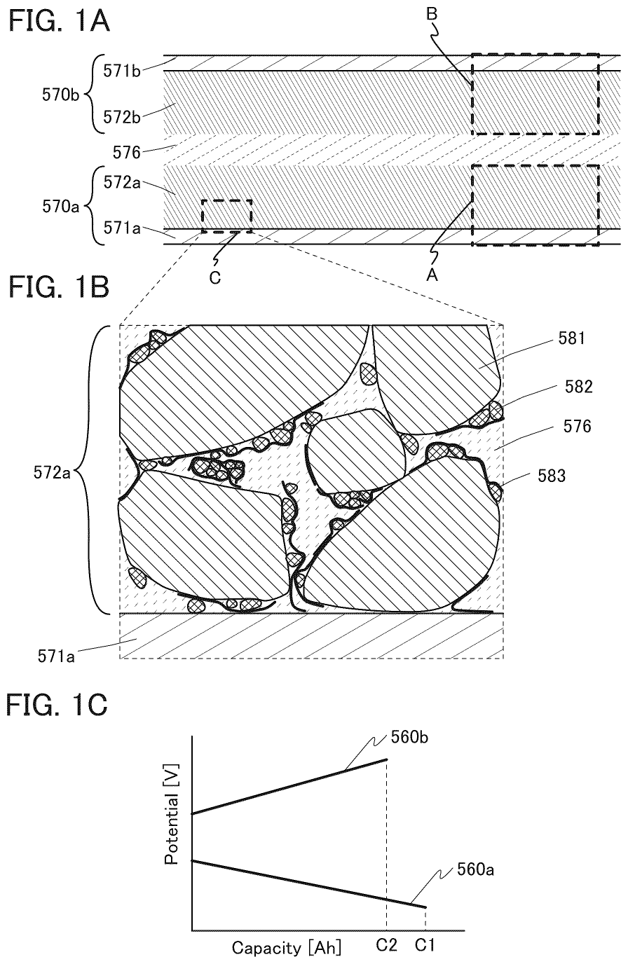

FIG. 1A is a schematic cross-sectional view illustrating the inside of the secondary battery of one embodiment of the present invention. A negative electrode 570a, a positive electrode 570b, and an electrolyte 576 illustrated in FIG. 1A can be used in a coin-type secondary battery, a cylindrical secondary battery, a laminated secondary battery, and the like in embodiments described later. The negative electrode 570a includes at least a negative electrode current collector 571a and a negative electrode active material layer 572a formed in contact with the negative electrode current collector 571a. The positive electrode 570b includes at least a positive electrode current collector 571b and a positive electrode active material layer 572b formed in contact with the positive electrode current collector 571b. FIG. 1B is an enlarged view of a region surrounded by a dashed line C in FIG. 1A. FIG. 1C is a graph showing the capacity ratio between the negative electrode 570a and the positive electrode 570b in regions surrounded by a dashed line A and a dashed line B in FIG. 1A. The secondary battery may include a separator between the negative electrode 570a and the positive electrode 570b.

### [Capacity Ratio Between Negative Electrode and Positive Electrode]

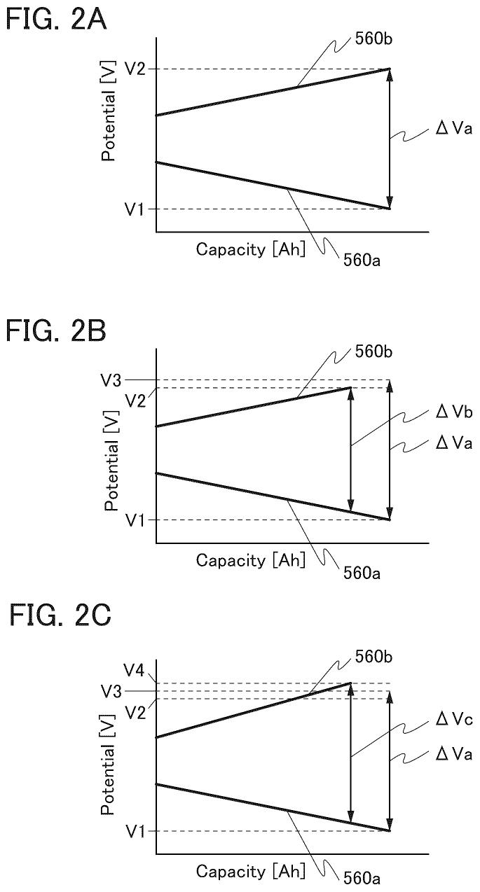

A negative electrode characteristic curve 560a and a positive electrode characteristic curve 560b shown in FIG. 1C, FIG. 2A, FIG. 2B, and FIG. 2C are characteristic curves showing the relationship between the capacities and the potentials of the negative electrode active material layer 572a and the positive electrode active material layer 572b included in the negative electrode 570a and the positive electrode 570b that have the same areas and face each other in the regions surrounded by the dashed line A and the dashed line B in FIG. 1A.

As for the negative electrode characteristic curve 560a in FIG. 1C, a capacity C1 is a total capacity that the negative electrode 570a can charge and discharge. The total capacity that the negative electrode 570a can charge and discharge refers to, for example, a charge capacity of the case where a half cell including the negative electrode 570a and a lithium metal is fabricated, a constant voltage discharging (lower current density of 0.02 C) is performed after constant current discharging (0.2 C and lower voltage limit of 0.01 V), and then constant-current charging (0.2 C, upper voltage limit of 1 V) is performed. As for the positive electrode characteristic curve 560b in FIG. 1C, a capacity C2 is the capacity of the positive electrode of the secondary battery in a fully charged state. In this specification, a fully charged state of a secondary battery refers to, for example, a charged state in which a rated capacity defined by JIS C8711 (2013) is obtained.

The capacity ratio between the negative electrode 570a and the positive electrode 570b in the secondary battery refers to the percentage of the capacity of the positive electrode 570b with the capacity of the negative electrode 570a being 100% when the negative electrode 570a and the positive electrode 570b have the same areas. For example, as shown in FIG. 2A, when the capacity of the negative electrode 570a is equal to the capacity of the positive electrode 570b, the capacity ratio between the negative electrode 570a and the positive electrode 570b is 100%.

Next, the case where the capacity ratio between the negative electrode 570a and the positive electrode 570b is lower than 100% is described using FIG. 1C. The case where the capacity ratio is lower than 100% means that the total capacity that the negative electrode 570a can charge and discharge is larger than the capacity that the positive electrode 570b can charge and discharge. In this case, the capacity C1 of the negative electrode 570a shown in FIG. 1C has a larger value than the capacity C2 of the positive electrode 570b.

When the capacity ratio is lower than 100% in the above manner, an excess capacity is generated in the capacity C1 of the negative electrode 570a, whereas there is an advantage that unintentional deposition of lithium ions in the negative electrode 570a can be easily reduced. Furthermore, the secondary battery including the negative electrode 570a of one embodiment of the present invention described later has a feature of having a high charge and discharge capacity and favorable charge and discharge cycle characteristics when the capacity ratio is preferably higher than or equal to 50% and lower than 100%, further preferably higher than or equal to 70% and lower than 90%.

Next, the voltage of the secondary battery is described. The voltage of the secondary battery can be regarded as the difference between a positive electrode potential and a negative electrode potential. For example, the voltage of the secondary battery of the case where the capacity ratio between the negative electrode 570a and the positive electrode 570b is 100% is denoted by ΔVa in FIG. 2A. In addition, the voltage of the secondary battery of the case where the capacity ratio is lower than 100% is denoted by ΔVb in FIG. 2B. As shown in FIG. 2B, in the case where the capacity ratio is lower than 100%, the voltage of the secondary battery decreases because the secondary battery is used in the state where the use potential range of the negative electrode 570a is high.

Next, FIG. 2C shows an example where the secondary battery voltage does not decrease even when the capacity ratio between the negative electrode 570a and the positive electrode 570b is lower than 100%. Here, it is shown that ΔVa and ΔVc in FIG. 2C have the same voltage values. In FIG. 2B, the use potential range of the positive electrode 570b is the same as the use potential range of the positive electrode 570b in FIG. 2A, in which case the secondary battery voltage ΔVb is smaller than ΔVa as described above. As shown in FIG. 2C, in the case where the use potential range of the positive electrode 570b is expanded to a higher potential, the secondary battery voltage ΔVc has a high value like ΔVa.

As shown in FIG. 2C, it is possible to obtain a secondary battery whose voltage does not decrease also in the case where the capacity ratio between the negative electrode 570a and the positive electrode 570b is lower than 100%. In this case, the positive electrode 570b is exposed to a relatively high potential; thus, the positive electrode 570b needs to have high resistance to high-potential charging and discharging. A positive electrode active material 100 described in one embodiment of the present invention can have a stable crystal structure in a high-potential charged state and thus is suitable as an active material included in the positive electrode 570b.

Details of the positive electrode active material 100 are described later.

### [Negative Electrode]

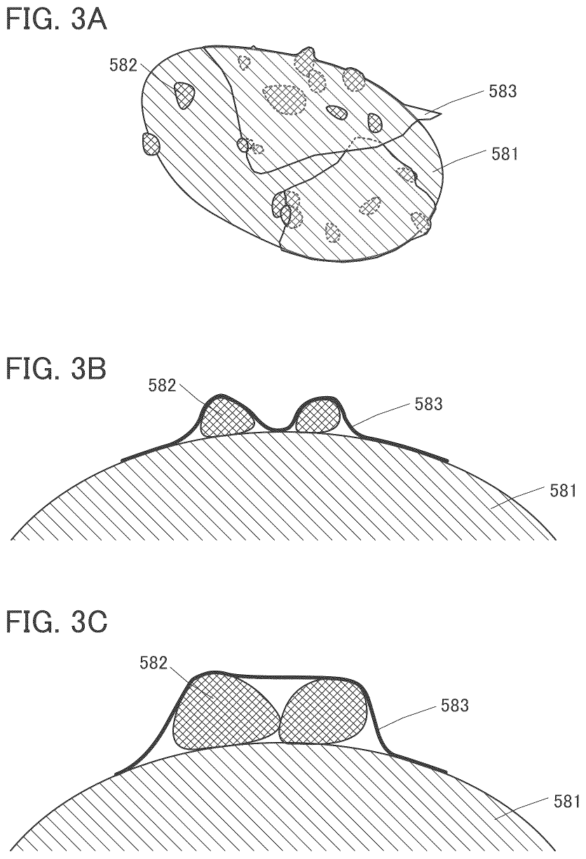

FIG. 1B is an enlarged view of the region surrounded by the dashed line C in FIG. 1A. As illustrated in FIG. 1B, the negative electrode active material layer 572a includes a first active material 581, a second active material 582, a graphene compound 583 as a sheet-like material, and the electrolyte 576. FIG. 3A is a schematic view illustrating a state where the graphene compound 583 is in contact with the first active material 581 so as to cover, surround, or cling to the second active material 582 positioned on the surface of the first active material 581. The graphene compound 583 included in the negative electrode 570a preferably functions as a conductive material, for example. One embodiment of the present invention can achieve an electrode having high conductivity because the conductive material can cling to the active material by a hydrogen bond.

A variety of materials can be used as the first active material 581 and the second active material 582. In the case where a particle that includes a functional group containing oxygen or fluorine in its surface portion or a particle that includes a region terminated with a functional group containing oxygen or a fluorine atom in its surface, which is a particle of one embodiment of the present invention, is used for the first active material 581 and the second active material 582, the affinity of the first active material 581 and the second active material 582 with the graphene compound 583 is improved, and the graphene compound 583 can be in contact with the first active material 581 so as to cover, surround, or cling to the second active material 582 positioned on the surface of the first active material 581, as illustrated in FIG. 1B and FIG. 3A. Since the graphene compound 583 can cling to the first active material 581 and the second active material 582, an electrode having high conductivity can be achieved. The state of being in contact with something so as to cling to it can be rephrased as a state of being in close contact with it, not making point contact with it. Alternatively, it can also be rephrased as a state of being in contact with a particle along its surface. Alternatively, it can be rephrased as a state of making surface contact with a plurality of particles. Materials that can be used as the first active material 581 and the second active material 582 will be described later.

A case where an active material with a large volume change in charging and discharging is used as the second active material 582 is described with reference to FIG. 3B and FIG. 3C. FIG. 3B illustrates a state where the first active material 581, the second active material 582, and the graphene compound 583 as a material having a sheet-like shape are included, and the graphene compound 583 is in contact with the first active material 581 so as to cover, surround, or cling to the second active material 582 positioned on the surface of the first active material 581. It can also be said that the second active material 582 is positioned between the first active material 581 and the graphene compound 583, and the graphene compound 583 is in contact with the first active material 581 and the second active material 582. FIG. 3C illustrates a case where the volume of the second active material 582 illustrated in FIG. 3B is increased by charging or discharging. Since the graphene compound 583 is in contact with the first active material 581 so as to cover, surround, or cling to the second active material 582 positioned on the surface of the first active material 581, electrical contact between the second active material 582 and the first active material 581 can be maintained even after the volume of the second active material 582 is increased by charging or discharging. Furthermore, collapse of the electrode can be inhibited.

In the case where the graphene compound 583 is in contact with the active materials such as the first active material 581 and the second active material 582 so as to cling to them, a contact area between the graphene compound 583 and the active materials is increased, so that conductivity of electrons moving through the graphene compound 583 is increased. In the case where the volume of the active materials largely change in charging and discharging, the graphene compound 583 in contact with the active materials so as to cling to them can effectively prevent detachment of the active material. These effects can be obtained significantly in the case where the graphene compound 583 is in contact with the active materials so as to tightly cling to them. The graphene compound 583 includes a vacancy that is large enough for Li ions to pass through, and desirably includes many vacancies to the extent that the electron conductivity of the graphene compound 583 is not hindered.

The negative electrode active material layer 572a can include a carbon-based material such as carbon black, graphite, carbon fiber, or fullerene in addition to the graphene compound 583. As the carbon black, acetylene black (AB) can be used, for example. As the graphite, natural graphite or artificial graphite such as mesocarbon microbeads can be used, for example. These carbon-based materials have high conductivity and can function as a conductive material in the active material layer. Note that these carbon-based materials may each function as an active material.

As carbon fiber, mesophase pitch-based carbon fiber, isotropic pitch-based carbon fiber, or the like can be used, for example. As the carbon fiber, carbon nanofiber, carbon nanotube, or the like can be used. Carbon nanotube can be formed by, for example, a vapor deposition method.

The active material layer may contain, as a conductive material, metal powder or metal fiber of copper, nickel, aluminum, silver, gold, or the like, a conductive ceramic material, or the like.

The content of the conductive material to the total amount of solid content in the active material layer is preferably greater than or equal to 0.5 wt % and less than or equal to 10 wt %, and further preferably greater than or equal to 0.5 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Hence, the discharge capacity of the secondary battery can be increased.

Furthermore, the graphene compound of one embodiment of the present invention has excellent permeability to lithium; therefore, the charging and discharging rate of the secondary battery can be increased.

A particulate carbon-containing compound such as carbon black or graphite and a fibrous carbon-containing compound such as carbon nanotube easily enter a microscopic space. A microscopic space refers to, for example, a region between a plurality of active materials. When a carbon-containing compound that easily enters a microscopic space and a sheet-like, carbon-containing compound such as graphene that can impart conductivity to a plurality of particles are used in combination, the density of the electrode increases and an excellent conductive path can be formed. When the secondary battery includes the electrolyte 576 of one embodiment of the present invention, the secondary battery can be operated more stably. That is, the secondary battery of one embodiment of the present invention can have both high energy density and stability, and is useful as an in-vehicle secondary battery. When a vehicle becomes heavier with increasing number of secondary batteries, more energy is required to move the vehicle, which shortens the driving range. With use of a secondary battery with high density, the driving range can be increased even with the same weight of secondary batteries included in the vehicle, that is, even with the same total weight of the vehicle.

Since more electric power is needed to charge a secondary battery with higher capacity in the vehicle, the secondary battery is desirably charged in a short time. What is called a regenerative charging, in which electric power is temporarily generated when the vehicle is braked and the electric power is used for charging, is performed under high rate charging conditions; thus, a secondary battery for a vehicle is desired to have favorable rate characteristics.

With the use of the electrolyte 576 of one embodiment of the present invention, an in-vehicle secondary battery having a wide operation temperature range can be obtained.

In addition, the secondary battery of one embodiment of the present invention can be downsized owing to its high energy density, and can be charged fast owing to its high conductivity. Thus, the structure of the secondary battery of one embodiment of the present invention is useful also in a portable information terminal.

The negative electrode active material layer 572a preferably includes a binder (not illustrated). The binder binds or fixes the electrolyte 576 and the active materials, for example. In addition, the binder can bind or fix the electrolyte 576 and a carbon-based material, the active material and a carbon-based material, a plurality of active materials, a plurality of carbon-based materials, or the like.

As the binder, it is preferred to use a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose.

Polyimide has extremely excellent thermal, mechanical, and chemical stability. In the case of using polyimide as a binder, a dehydration reaction and a cyclization (imidizing) reaction are performed. These reactions can be performed by heat treatment, for example. In an electrode of one embodiment of the present invention, when graphene including a functional group containing oxygen and polyimide are used as the graphene compound and the binder, respectively, the graphene compound can also be reduced by the heat treatment, leading to simplification of the process. Because of high heat-resistance, heat treatment can be performed at a heat temperature of 200° C. or higher. The heat treatment at a heat temperature of 200° C. or higher allows the graphene compound to be reduced sufficiently and the conductivity of the electrode to increase.

A fluorine polymer which is a high molecular material containing fluorine, specifically, polyvinylidene fluoride (PVDF) can be used, for example. PVDF is a resin having a melting point in the range higher than or equal to 134° C. and lower than or equal to 169° C., and is a material with excellent thermal stability.

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used. Alternatively, fluororubber can be used as the binder.

As the binder, for example, water-soluble polymers are preferably used. As the water-soluble polymers, a polysaccharide or the like can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferred that such water-soluble polymers be used in combination with any of the above-described rubber materials.

A plurality of the above-described materials may be used in combination for the binder.

The graphene compound 583 has flexibility and can cling to the first active material 581 and the second active material 582, like natto (fermented soybeans). For example, the first active material 581 and the second active material 582 can be likened to soybeans and the graphene compound 583 can be likened to a sticky ingredient, e.g., polyglutamic acid. By providing the graphene compound 583 as a bridge between materials included in the negative electrode active material layer 572a, such as the electrolyte 576, the plurality of active materials, and the plurality of carbon-based materials, it is possible to not only form an excellent conductive path in the negative electrode active material layer 572a but also bind or fix the materials with use of the graphene compound 583. In addition, for example, a three-dimensional net-like structure or an arrangement structure of polygons, e.g., a honeycomb structure in which hexagons are arranged in matrix, is formed using the plurality of graphene compounds 583, and materials such as the electrolyte 576, the plurality of active materials, and the plurality of carbon-based materials are placed in meshes, whereby the graphene compounds 583 form a three-dimensional conductive path and detachment of the electrolyte 576 from the current collector can be inhibited. In the arrangement structure of polygons, polygons with different number of sides may be intermingled. Thus, in the negative electrode active material layer 572a, the graphene compound 583 functions as a conductive material and may also function as a binder. The graphene compound 583 has a hole with a 9- or more-membered ring and does not inhibit the movement of Li ions even when covering the active material; thus, the graphene compound 583 is particularly preferred as the conductive material used in the negative electrode active material layer 572a.

### [Negative Electrode Active Material]

The first active material 581 and the second active material 582 can each have any of various shapes such as a rounded shape and an angular shape. In addition, on the cross section of the electrode, the first active material 581 and the second active material 582 can each have any of various cross-sectional shapes such as a circle, an ellipse, a shape having a curved line, and a polygon. For example, FIG. 1B and FIG. 3A illustrate an example where cross-sections of the first active material 581 and the second active material 582 have rounded shapes; however, the cross sections of the first active material 581 and the second active material 582 may each be angular. Alternatively, one part may be rounded and another part may be angular.

Examples of the negative electrode active material will be described below.

Silicon can be used as the negative electrode active material. In the negative electrode 570a, a particle containing silicon is preferably used as the second active material 582.

In addition, a metal or a compound containing one or more elements selected from tin, gallium, aluminum, germanium, lead, antimony, bismuth, silver, zinc, cadmium, and indium, can be used as the negative electrode active material included in the second active material 582. Examples of an alloy-based compound containing such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

A material whose resistance is lowered by addition of an impurity element such as phosphorus, arsenic, boron, aluminum, or gallium to silicon may be used. Furthermore, a silicon material pre-doped with lithium may be used. Examples of a pre-doping method include annealing of a mixture of silicon with lithium fluoride, lithium carbonate, or the like and mechanical alloying of a lithium metal and silicon. A secondary battery may be fabricated in the following manner: a first electrode including silicon as an active material is formed; lithium doping is performed on the silicon included in the first electrode through charge and discharge reaction with a combination of the first electrode and a second electrode of a lithium metal or the like; and then the first electrode subjected to doping is combined with a counter electrode (e.g., a positive electrode for a negative electrode subjected to pre-doping).

For example, a nanosilicon particle can be used as the second active material 582. The average diameter of nanosilicon particles is, for example, preferably greater than or equal to 5 nm and less than 1 μm, further preferably greater than or equal to 10 nm and less than or equal to 300 nm, still further preferably greater than or equal to 10 nm and less than or equal to 100 nm.

The nanosilicon particle may have a spherical shape, a flattened spherical shape, or a rectangular solid shape with rounded corners. The size (particle diameter) of the nanosilicon particle, which is measured as D50 by a laser diffraction particle size distribution measurement, is preferably greater than or equal to 5 nm and less than 1 μm, further preferably greater than or equal to 10 nm and less than or equal to 300 nm, still further preferably greater than or equal to 10 nm and less than or equal to 100 nm, for example. Here, D50 is a particle diameter when the accumulated amount of particles accounts for 50% of an accumulated particle amount curve which is the result of the particle size distribution measurement. The measurement of the size of a particle is not limited to laser diffraction particle size distribution measurement; the major axis of a particle cross section may be measured by analysis with a SEM, a TEM, or the like.

The nanosilicon particle preferably contains amorphous silicon. The nanosilicon particle preferably contains polycrystalline silicon. The nanosilicon particle preferably contains amorphous silicon and polycrystalline silicon. The nanosilicon particle may include a region with crystallinity and an amorphous region.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous. A particle in which the graphene compound 583 clings to a secondary particle of silicon may be used.

As a compound containing silicon, Li₂SiO₃ and Li₄SiO₄ may be included, for example. Each of Li₂SiO₃ and Li₄SiO₄ may have crystallinity, or may be amorphous.

The analysis of the compound containing silicon can be performed by NMR, XRD, Raman spectroscopy, SEM, TEM, EDX, or the like.

The first active material 581 included in the negative electrode 570a preferably contains graphite.

It is further preferable that the first active material 581 be a material with a small volume change in charging and discharging.

As for the volume change of the first active material 581 in charging or discharging, the maximum volume in charging or discharging as compared to the minimum volume in charging or discharging being 1 is preferably less than or equal to 2, further preferably less than or equal to 1.5, still further preferably less than or equal to 1.1.

The particle diameter of the first active material 581 is desirably larger than the particle diameter of the second active material 582.

For example, in a laser diffraction particle size distribution measurement, the D50 of the first active material 581 is preferably more than or equal to 1.5 times and less than 1000 times, further preferably more than or equal to 2 times and less than or equal to 500 times, still further preferably more than or equal to 10 times and less than or equal to 100 times the D50 of the second active material 582. Here, D50 is a particle diameter when the accumulated amount of particles accounts for 50% of an accumulated particle amount curve which is the result of the particle size distribution measurement. Note that the particle size distribution measurement is not limited to a laser diffraction particle size distribution measurement, and the diameter of the cross section of the particle may be measured by SEM or TEM analysis.

As the first active material 581, it is possible to use, for example, a carbon-based material such as graphite, graphitizing carbon, non-graphitizing carbon, carbon nanotube, carbon black, or the graphene compound 583, which has a small volume change in charging and discharging.

Furthermore, as the first active material 581, an oxide containing one or more elements selected from titanium, niobium, tungsten, and molybdenum can be used, for example.

As the first active material 581, a combination of two or more of the above-described metals, materials, compounds, and the like can be used.

As the first active material 581, an oxide such as SnO, SnO₂, titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used, for example.

Alternatively, a material that causes a conversion reaction can be used as the first active material 581. For example, a transition metal oxide that does not cause an alloying reaction with lithium, such as cobalt oxide (CoO), nickel oxide (NiO), and iron oxide (FeO), may be used as the first active material 581. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides may be used as the positive electrode material because of its high potential.

### [Calculation 1 for Negative Electrode]

First principles calculation of a diffusion coefficient of lithium in the first active material 581 and the second active material 582 is performed for the case where graphite is used as the first active material 581 and silicon is used as the second active material 582 in the negative electrode 570a of one embodiment of the present invention.

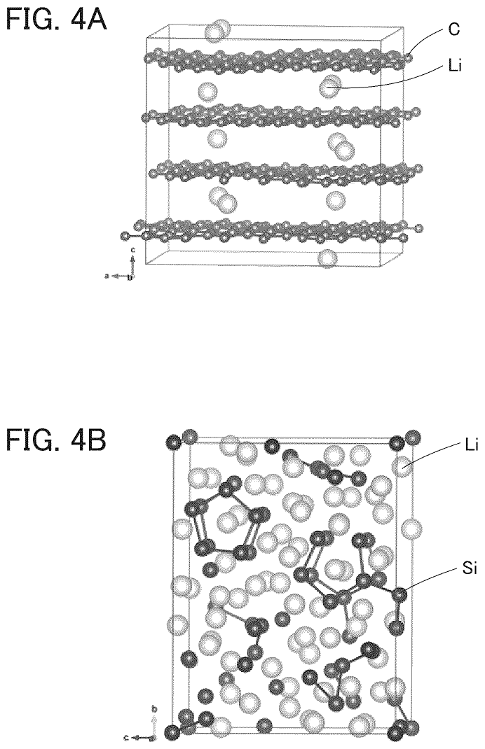

FIG. 4A shows a model of a crystal structure used in calculation for graphite (Li_{0.25}C₆), and FIG. 4B shows a model of a crystal structure used in calculation for silicon (Li_{1.25}Si).

For the calculation, a first-principles electronic state calculation package VASP are used. For other specific calculation conditions of the quantum molecular dynamics, the conditions shown in Table 1 are used.

TABLE 1

| | |
|---|---|
| Software | VASP |
| Functional | GGA + U (DFT-D2) |
| Pseudo | PAW |
| potential | |
| Cut-off | 600 |
| energy (eV) | |
| Number of | Graphite model: 288 C atoms and 12 Li atoms |
| atoms | Si model: 56 Si atoms and 70 Li atoms |
| k-points | 1 × 1 × 1 |
| Temperature | 200, 250, 300, 350, 400, 450 |
| (K) | |

After volume relaxation calculation, MD (molecular dynamics) calculation in volume fixed conditions is performed on the crystal structures shown in FIG. 4A and FIG. 4B at each of the temperatures. The MD calculation is performed by a plurality of steps, and a diffusion coefficient is derived from the relationship between the displacement amount of lithium in each step and the elapsed time.

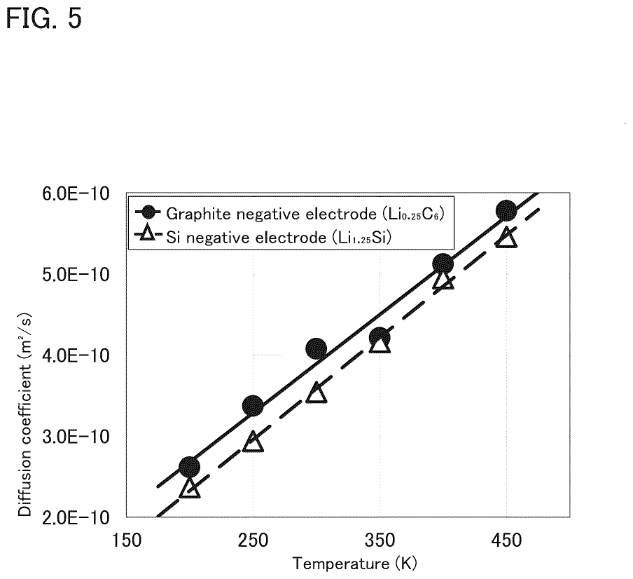

FIG. 5 shows the results of the calculation in FIG. 4A, FIG. 4B, and Table 1. The calculation results indicate that the diffusion coefficient of lithium is higher in the graphite than in the silicon.

As for the relationship of oxidation-reduction potentials of graphite and silicon, it is known that graphite has 0.05 V (vs. Li) and Si has 0.4 V (vs. Li). An oxidation-reduction potential correlates with a voltage at which charging (taking in of lithium) begins, and when the priority of lithium insertion at the time of charging is taken into consideration, lithium is probably taken preferentially in Si having a high oxidation-reduction potential.

With the calculation results of the diffusion coefficient shown in FIG. 5 and the relationship of the oxidation-reduction potentials, it is assumed that lithium is preferentially taken in silicon owing to the difference in oxidation-reduction potential at the initial stage of charging, but as the charging progresses, lithium can be preferentially taken in graphite having a large diffusion coefficient (a high taking in speed) gradually. Accordingly, in the case where capacity limitation is imposed on the negative electrode 570a of one embodiment of the present invention, it is assumed that the graphite of the first active material 581 takes in lithium to near the theoretical capacity of graphite, and the silicon of the second active material 582 takes in the residual lithium. In other words, in the case where capacity limitation is imposed on the negative electrode 570a of one embodiment of the present invention, there is a possibility that the graphite of the first active material 581 is used for charging and discharging preferentially as compared with the silicon of the second active material 582, and the capacity limitation affects mainly on the silicon of the second active material 582.

### [Calculation 2 for Negative Electrode]

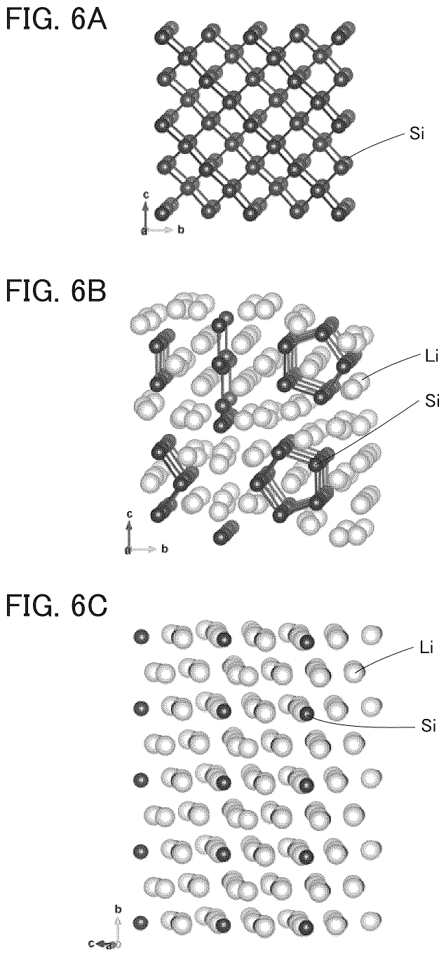

FIG. 6A shows a silicon crystal not containing lithium, and FIG. 6B and FIG. 6C each show the structure in the state where silicon is charged (in the state of being alloyed with Li).

FIG. 6B illustrates the structure with Li/Si=1.714, showing that Si—Si bonds remain in the structure. Meanwhile, it is found from the crystal structure with Li/Si=4.4, which is the limit value of the theoretical capacity, shown in FIG. 6C that no Si—Si bond exists in the structure because the Li proportion is increased. It is known that the crystal structure of silicon collapses due to repeated charging and discharging so that the silicon becomes amorphous and is thinned; however, for example, when the Si—Si bonds shown in FIG. 6B remain in the secondary battery in a fully charged state, it is highly probable that the structure is kept to some extent even when charging and discharging are repeated. Preferably, in the case of use with a lithium ratio (molar ratio) of Li/Si=1.714 or less shown in FIG. 6B, there is a possibility that favorable charge and discharge cycle characteristics are exhibited.

### [Capacity Limitation on Negative Electrode]

It is preferable that the negative electrode 570a of one embodiment of the present invention be used in the secondary battery so as to have a smaller capacity than the theoretical capacities of the first active material 581 and the second active material 582. For capacity limitation on the negative electrode 570a, for example, the capacity ratio is preferably greater than or equal to 50% and less than 100%, further preferably greater than or equal to 70% and less than 90% of the theoretical capacities of the first active material 581 and the second active material 582, in which case the secondary battery can have a high charge and discharge capacity and favorable charge and discharge cycle characteristics.

### [Method for Fabricating Negative Electrode]

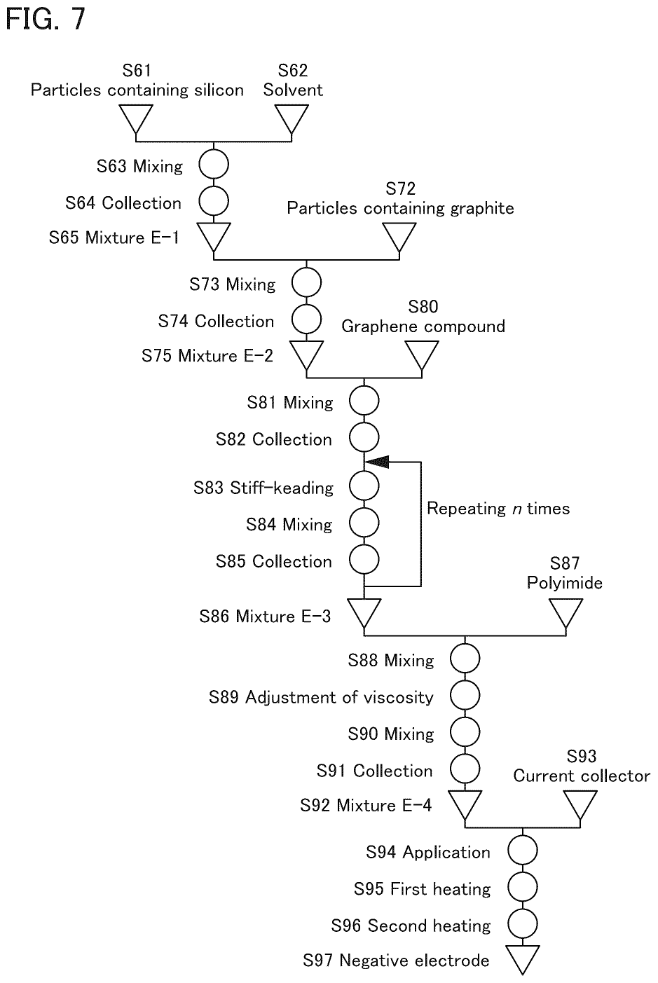

FIG. 7 is a flow chart showing an example of a method for fabricating the negative electrode 570a of one embodiment of the present invention.

First, particles containing silicon are prepared as the second active material 582 in Step S61. For the particles containing silicon, the particle mentioned above as the second active material 582 can be used.

In Step S62, a solvent is prepared. For example, one of water, methanol, ethanol, acetone, tetrahydrofuran (THF), dimethylformamide (DMF), N-methylpyrrolidone (NMP), and dimethyl sulfoxide (DMSO), or a mixed solution of two or more of the above can be used as the solvent.

Next, the particles containing silicon prepared in Step S61 and the solvent prepared in Step S62 are mixed in Step S63 and the mixture is collected in Step S64, so that a mixture E-1 is obtained in Step S65. A kneader or the like can be used for the mixing. As the kneader, a planetary centrifugal mixer can be used, for example.

Next, particles containing graphite are prepared as the first active material 581 in Step S72. For the particles containing graphite, the particle mentioned above as the first active material 581 can be used.

Next, the mixture E-1 and the particles containing graphite prepared in Step S72 are mixed in Step S73 and the mixture is collected in Step S74, so that a mixture E-2 is obtained in Step S75. A kneader or the like can be used for the mixing. As the kneader, a planetary centrifugal mixer can be used, for example.

Then, the graphene compound 583 is prepared in Step S80.

Next, the mixture E-2 and the graphene compound 583 prepared in Step S80 are mixed in Step S81 and the mixture is collected in Step S82. The collected mixture preferably has a high viscosity. Because of the high viscosity, stiff kneading (kneading in high viscosity) can be performed in the following Step S83.

Next, stiff kneading is performed in Step S83. The stiff kneading can be performed with use of a spatula, for example. By performing the stiff kneading, a mixture with high dispersibility of the graphene compound 583, in which the particles containing silicon and the graphene compound 583 are mixed well, can be formed.

Next, a solvent is added to the stiff-kneaded mixture and mixing is performed in Step S84. A kneader or the like can be used for the mixing, for example. The mixture subjected to the mixing is collected in Step S85.

The steps of Step S83 to Step S85 are preferably repeated n times on the mixture collected in Step S85. For example, n is a natural number of greater than or equal to 2 and less than or equal to 10. In the step of Step S83, when the mixture is dried, a solvent is preferably added thereto. However, when a solvent is added too much, the viscosity is lowered and the effect of stiff-kneading is decreased.

Step S83 to Step S85 are repeated n times, and then a mixture E-3 is obtained (Step S86). Next, a binder is prepared in Step S87. As the binder, any of the above-described materials can be used, and especially polyimide is preferable. Note that in Step S87, a precursor of a material used as the binder is prepared in some cases. For example, a precursor of polyimide is prepared.

Next, in Step S88, the mixture E-3 is mixed with the binder prepared in Step S87. Then, in Step S89, the viscosity is adjusted. Specifically, for example, a solvent of the same kind as the solvent prepared in Step S62 is prepared and is added to the mixture obtained in Step S88. By adjusting the viscosity, for example, the thickness, density, and the like of the electrode obtained in Step S97 can be adjusted in some cases.

Next, a solvent is added to the mixture whose viscosity is adjusted in Step S89, mixing is performed in Step S90, and the mixture is collected in Step S91, so that a mixture E-4 is obtained (Step S92). The mixture E-4 obtained in Step S92 is referred to as a slurry, for example.

Next, a current collector is prepared in Step S93.

In Step S94, the mixture E-4 is applied on the current collector prepared in Step S93. For the application, a slot die method, a gravure method, a blade method, or combination of any of the methods can be used, for example. Furthermore, a continuous coater or the like may be used for the application.

Next, first heating is performed in Step S95. By the first heating, the solvent is volatilized. The first heating is preferably performed at a temperature in the range from 40° C. to 200° C. inclusive, preferably 50° C. to 150° C. inclusive. Note that the first heating is referred to as drying in some cases.

The first heat treatment may be performed using a hot plate at 30° C. or higher and 70° C. or lower in an air atmosphere for 10 minutes or longer, and then, for example, heat treatment may be performed at room temperature or higher and 100° C. or lower in a reduced-pressure environment for 1 hour or longer and 10 hours or shorter.

Alternatively, heating treatment may be performed using a drying furnace or the like. In the case of using a drying furnace, for example, heat treatment at a temperature of 30° C. or higher and 120° C. or lower for 30 seconds or longer and 2 hours or shorter may be performed.

In addition, the temperature may be increased in stages. For example, after heat treatment is performed at 60° C. or lower for 10 minutes or shorter, heat treatment may further be performed at 65° C. or higher for 1 minute or longer.

Next, second heating is performed in Step S96. When polyimide is used as a binder, a cycloaddition reaction of polyimide is preferably caused by the second heating. In addition, a dehydration reaction of polyimide is caused by the second heating in some cases. Alternatively, a dehydration reaction is caused by the first heating in some cases. In the first heating, a cycloaddition reaction of polyimide may be caused. Moreover, a reduction reaction of the graphene compound 583 is preferably caused by the second heating. Note that the second heating is sometimes referred to as imidizing heat treatment, reduction heat treatment, or thermal reduction treatment.

Note that the electrode density can be increased without deterioration of battery characteristics when pressing treatment is performed before the second heating; therefore, pressing treatment is preferably performed before Step S96.

The second heating is preferably performed at a temperature in the range from 150° C. to 500° C. inclusive, further preferably from 200° C. to 450° C. inclusive.

The second heating is performed at 200° C. or higher and 450° C. or lower for 1 hour or longer and 10 hours or shorter in a reduced-pressure environment of 10 Pa or lower or an inert gas atmosphere of nitrogen, argon, or the like.

In Step S97, the negative electrode 570a provided with an active material layer over the current collector is obtained.

The thickness of the active material layer formed in this manner is preferably greater than or equal to 5 μm and less than or equal to 300 μm, further preferably greater than or equal to 10 μm and less than or equal to 150 μm, for example. The loading amount of the active material of the active material layer may be greater than or equal to 2 mg/cm² and less than or equal to 50 mg/cm², for example.

The active material layer may be formed on both surfaces of the current collector or on only one surface of the current collector. Alternatively, there may be regions of both surfaces where the active material layer is partly formed.

After the solvent is volatilized from the active material layer, pressing is preferably performed by a compression method such as a roll press method or a flat plate press method. In the pressing, heat may be applied.

### [Positive Electrode]

The positive electrode 570b includes at least the positive electrode current collector 571b and the positive electrode active material layer 572b formed in contact with the positive electrode current collector 571b. Details of the positive electrode 570b are described in the following embodiment.

### [Conductive Material]

A conductive material is also referred to as a conductivity-imparting agent or a conductive additive, and a carbon material is used as the conductive additive. A conductive additive is attached between a plurality of active materials, whereby the plurality of active materials are electrically connected to each other, and the conductivity increases. Note that the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

For example, one kind or two or more kinds of carbon black such as acetylene black and furnace black, graphite such as artificial graphite and natural graphite, carbon fiber such as carbon nanofiber and carbon nanotube, and the graphene compound 583 can be used as the conductive material.

In the positive electrode 570b of the secondary battery, a binder (a resin) is mixed in order to fix the positive electrode current collector 571b such as metal foil and the active material. The binder is also referred to as a binding agent. Since the binder is a high molecular material, a large amount of the binder lowers the proportion of the active material in the positive electrode active material layer 572b, thereby reducing the discharge capacity of the secondary battery. Therefore, the amount of the binder mixed is reduced to a minimum.

Graphene, which has electrically, mechanically, or chemically remarkable characteristics, is a carbon material that is expected to be used in a variety of fields, such as field-effect transistors and solar batteries.

Carbon fiber can be used as the conductive material. Carbon fiber such as mesophase pitch-based carbon fiber or isotropic pitch-based carbon fiber can be used, for example. As the carbon fiber, carbon nanofiber, carbon nanotube, or the like can be used. Carbon nanotube can be formed by, for example, a vapor deposition method.

### [Graphene Compound]

The graphene compound 583 in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. The graphene compound 583 contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. The graphene compound 583 may include a functional group containing oxygen. The graphene compound 583 preferably has a bent shape. The graphene compound 583 may be rounded like a carbon nanofiber.

In this specification and the like, for example, graphene oxide contains carbon and oxygen, has a sheet-like shape, and has a functional group, in particular, an epoxy group, a carboxy group, or a hydroxy group.

In this specification and the like, for example, reduced graphene oxide contains carbon and oxygen, has a sheet-like shape, and has a two-dimensional structure formed of a six-membered ring composed of carbon atoms. The reduced graphene oxide may be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

The reduced graphene oxide can sometimes be provided with vacancies by reduction of graphene oxide.

A material obtained by terminating an edge portion of graphene with fluorine may be used as the graphene compound.

In the longitudinal cross section of the active material layer, the sheet-like graphene compounds 583 are dispersed substantially uniformly in a region inside the active material layer. The plurality of graphene compounds are formed to partly cover a plurality of particulate active materials or adhere to the surfaces of the plurality of particulate active materials, so that the graphene compounds make surface contact with the particulate active materials.

Here, the plurality of graphene compounds 583 can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume and the electrode weight. That is, the charge and discharge capacity of the secondary battery can be increased.

Here, after graphene oxide used as the graphene compound 583 is mixed with the active material to form a layer to be the active material layer, the graphene oxide is preferably reduced. That is, the formed active material layer preferably contains reduced graphene oxide. When graphene oxide with extremely high dispersibility in a polar solvent is used to form the active material layer including the graphene compounds 583, the graphene compounds 583 can be substantially uniformly dispersed in a region inside the active material layer.

In an active material layer formed in such a manner that a dispersion liquid in which graphene oxide is substantially uniformly dispersed in a solvent is applied on a current collector, the solvent is removed by volatilization, and then the graphene oxide is reduced, the graphene compounds 583 included in the active material layer partly overlap with each other. As described above, the reduced graphene oxides are dispersed to make surface contact with each other, whereby a three-dimensional conductive path can be formed. Note that the graphene oxide may be reduced by heat treatment or with the use of a reducing agent, for example.

Alternatively, a conductive path can be formed in the following manner: the surface of the active material is covered with a graphene compound in advance to form a conductive covering film on the surface of the active material, and the active materials are electrically connected to each other by the graphene compound.

The graphene compound 583 of one embodiment of the present invention preferably includes a vacancy in part of a carbon sheet. In the graphene compound 583 of one embodiment of the present invention, a vacancy through which carrier ions such as lithium ions can pass is provided in part of a carbon sheet, which can facilitate insertion and extraction of carrier ions in the surface of the active material covered with the graphene compound 583 to increase the rate characteristics of the secondary battery. The vacancy provided in part of the carbon sheet is referred to as a hole, a defect, or a gap in some cases.

The graphene compound 583 of one embodiment of the present invention preferably includes a vacancy formed with a plurality of carbon atoms and one or more fluorine atoms. The plurality of carbon atoms are preferably bonded to each other in a ring, and one or more of the plurality of carbon atoms bonded to each other in a ring are preferably terminated by the fluorine atom. Fluorine has high electronegativity and is easily negatively charged. Approach of positively-charged lithium ions causes interaction, whereby energy is stable and the barrier energy in passage of lithium ions through a vacancy can be lowered. Thus, fluorine contained in a vacancy in the graphene compound 583 allows a lithium ion to easily pass through even a small vacancy; therefore, the graphene compound 583 can have excellent conductivity. One or more of the carbon atoms bonded to each other in a ring shape may be terminated by hydrogen.

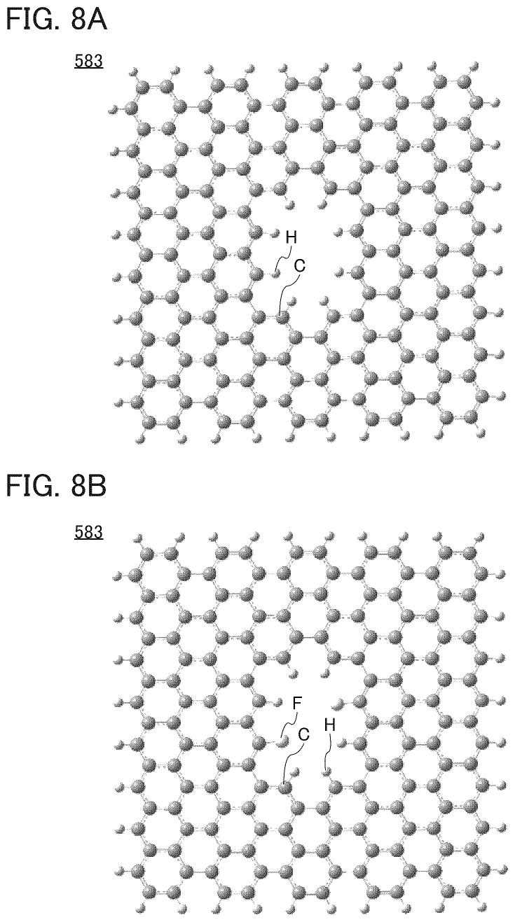

FIG. 8A and FIG. 8B each illustrate an example of the structure of the graphene compound 583 having a vacancy. The graphene compound 583 having a vacancy illustrated in FIG. 8A and FIG. 8B is also referred to as graphene having a vacancy or reduced graphene having a vacancy.

The structure illustrated in FIG. 8A includes a 22-membered ring, and eight carbon atoms of carbon atoms contained in the 22-membered ring are each terminated by hydrogen. In the structure, it can be said that two connected six-membered rings are removed from the graphene compound 583 and carbon atoms bonded to the removed six-membered rings are terminated by hydrogen.

The structure illustrated in FIG. 8B includes a 22-membered ring, and six carbon atoms of eight carbon atoms of carbon atoms contained in the 22-membered ring are terminated by hydrogen, and two carbon atoms thereof are terminated by fluorine. In the structure, it can be said that two connected six-membered rings are removed from the graphene compound 583 and carbon atoms bonded to the removed six-membered rings is terminated by hydrogen or fluorine.

Silicon terminated by a hydroxyl group forms a hydrogen bond between hydrogen contained in the hydroxyl group on the surface of the silicon and a hydrogen atom contained in the graphene compound 583 or a fluorine atom contained in the graphene compound 583, which indicates strong interaction between the silicon terminated by a hydroxyl group and the graphene compound 583 having a vacancy.

When the graphene compound 583 contains fluorine as well as hydrogen, it is indicated that in addition to the hydrogen bond between an oxygen atom of the hydroxy group and a hydrogen atom of the graphene compound 583, the hydrogen bond between a hydrogen atom of the hydroxy group and a fluorine atom of the graphene compound 583 is also formed, thereby making the interaction between the particle containing silicon and the graphene compound 583 stronger and more stable.

For example, in the case where the graphene compound 583 has a vacancy, it is possible that a spectrum based on a feature caused by the vacancy is observed in Raman spectroscopic mapping measurement. Furthermore, it is possible that a bond, a functional group, and the like included in the vacancy are observed with ToF-SIMS. It is also possible that the vicinity, surrounding, and the like of the vacancy are analyzed in TEM observation.

### [Binder]

In this specification and the like, a binder refers to a high molecular compound mixed only for binding an active material, a conductive material, and the like onto a current collector. A binder refers to, for example, a rubber material such as poly vinylidene difluoride (PVDF), styrene-butadiene rubber (SBR), styrene-isoprene-styrene rubber, butadiene rubber, or ethylene-propylene-diene copolymer; or a material such as fluorine rubber, polystyrene, polyvinyl chloride, polytetrafluoroethylene, polyethylene, polypropylene, polyisobutylene, or ethylene-propylene-diene polymer.

Since the lithium-ion conductive polymer is a high molecular compound, the active material and the conductive material can be bound onto the current collector when the lithium-ion conductive polymer is sufficiently mixed in the active material layer. Thus, the electrode can be fabricated without a binder. A binder is a material that does not contribute to charge and discharge reactions. Thus, a smaller number of binders enable higher proportion of materials that contribute to charging and discharging, such as an active material and an electrolyte. As a result, the secondary battery can have higher discharge capacity, improved cycle performance, or the like.

The electrolyte layer is preferably dried sufficiently so that the electrolyte 576 can be an electrolyte layer containing no or extremely little organic solvent. In this specification and the like, the electrolyte layer can be regarded as being dried sufficiently when a change in the weight after drying at 90° C. under reduced pressure for one hour is within 5%.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the active material layer is subjected to suspension using a solvent to separate the active material from the other materials.

Moreover, in each of the above structures, a solid electrolyte material may be further contained in the negative electrode 570a to increase incombustibility. As the solid electrolyte material, an oxide-based solid electrolyte is preferably used.

Examples of the oxide-based solid electrolyte include lithium composite oxides and lithium oxide materials such as LiPON, Li₂O, Li₂CO₃, Li₂MoO₄, Li₃PO₄, Li₃VO₄, Li₄SiO₄, LLT(La_{2/3-x}Li₃ₓTiO₃), and LLZ(Li₇La₃Zr₂O₁₂).

LLZ is a garnet-type oxide containing Li, La, and Zr and may be a compound containing Al, Ga, or Ta.

Alternatively, a polymer solid electrolyte such as PEO (polyethylene oxide) formed by an application method or the like may be used. Such a polymer solid electrolyte can also function as a binder; thus, in the case of using a polymer solid electrolyte, the number of components of the electrode can be reduced and the manufacturing cost can also be reduced.

### [Current Collector]

For each of the positive electrode current collector 571b and the negative electrode current collector 571a, it is possible to use a material which has high conductivity and is not alloyed with carrier ions of lithium or the like, e.g., a metal such as stainless steel, gold, platinum, zinc, iron, copper, aluminum, or titanium, an alloy thereof, or the like. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions of lithium or the like is preferably used for the negative electrode current collector 571a.

As the current collector, a titanium compound may be stacked over the above-described metal element. As a titanium compound, for example, it is possible to use one selected from titanium nitride, titanium oxide, titanium oxynitride (TiOₓN_{y}, where 0<x<2 and 0<y<1), and titanium oxide in which part of oxygen is substituted by nitrogen, or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

### [Separator]

A separator is positioned between the positive electrode 570b and the negative electrode 570a. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode 570b and the negative electrode 570a.

The separator is a porous material having a pore with a diameter of approximately 20 nm, preferably a pore with a diameter of greater than or equal to 6.5 nm, further preferably a pore with a diameter of at least 2 nm. In the case of the above-described semi-solid-state secondary battery, the separator can be omitted.

The separator may have a multilayer structure. For example, an organic material film of polypropylene, polyethylene, or the like can be coated with a ceramic-based material, a fluorine-based material, a polyamide-based material, a mixture thereof, or the like. As the ceramic-based material, aluminum oxide particles or silicon oxide particles can be used, for example. As the fluorine-based material, PVDF or polytetrafluoroethylene can be used, for example. Examples of the polyamide-based material include nylon and aramid (meta-based aramid and para-based aramid).

When the separator is coated with the ceramic-based material, the oxidation resistance is improved; hence, deterioration of the separator in high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode 570b may be coated with a mixed material of aluminum oxide and aramid, and a surface of the polypropylene film that is in contact with the negative electrode 570a may be coated with the fluorine-based material.

With the use of a separator having a multilayer structure, the capacity per volume of the secondary battery can be increased because the safety of the secondary battery can be maintained even when the total thickness of the separator is small.

### [Electrolyte]

In the case of using the electrolyte 576 in a liquid state for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio as the electrolyte 576, for example.

Alternatively, the use of one or more ionic liquids (room temperature molten salts) that are less likely to burn and volatize as the solvent of the electrolyte 576 can prevent a secondary battery from exploding or catching fire even when the secondary battery internally shorts out or the temperature of the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

In particular, in the case where silicon is used as the second active material 582 included in the negative electrode 570a in the secondary battery of one embodiment of the present invention, the electrolyte 576 in a liquid state that contains an ionic liquid is preferably used.

The secondary battery of one embodiment of the present invention includes, as a carrier ion, any one or more of an alkali metal ion such as a lithium ion, a sodium ion, and a potassium ion, and an alkaline earth metal ion such as a calcium ion, a strontium ion, a barium ion, a beryllium ion, and a magnesium ion, for example.

In the case where a lithium ion is used as a carrier ion, for example, an electrolyte contains lithium salt. As the lithium salt, for example, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), or LiN(C₂F₅SO₂)₂ can be used.

The electrolyte preferably contains fluorine. As an electrolyte containing fluorine, for example, an electrolyte containing one kind or two or more kinds of fluorinated cyclic carbonates and lithium ions can be used. The fluorinated cyclic carbonate can improve nonflammability and increase the safety of the lithium-ion secondary battery.

As the fluorinated cyclic carbonate, ethylene fluoride carbonate such as monofluoroethylene carbonate (fluoroethylene carbonate, FEC, or FIEC), difluoroethylene carbonate (DFEC or F2EC), trifluoroethylene carbonate (F3EC), or tetrafluoroethylene carbonate (F4EC) can be used, for example. Note that DFEC includes an isomer such as cis-4,5 or trans-4,5. For operation at low temperatures, as the electrolyte, it is important to use one kind or two or more kinds of fluorinated cyclic carbonates to solvate a lithium ion and transport the lithium ion in the electrolyte included in the electrode in charging and discharging. When the fluorinated cyclic carbonate is not used as a small amount of additive but contributes to transportation of a lithium ion in charging and discharging, operation can be performed at low temperatures. In the secondary battery, a group of approximately several to several tens of lithium ions moves.

The use of the fluorinated cyclic carbonate for the electrolyte can reduce desolvation energy that is necessary for a solvated lithium ion to enter an active material particle in the electrolyte included in an electrode. The reduction in the desolvation energy can facilitate insertion or extraction of a lithium ion into or from the active material particle even in a low-temperature range. Although a lithium ion sometimes moves remaining in a solvated state, a hopping phenomenon in which coordinated solvent molecules are interchanged occurs in some cases. When desolvation of a lithium ion becomes easy, movement owing to the hopping phenomenon is facilitated and the lithium ion may easily move. A decomposition product of the electrolyte generated by charging and discharging of the secondary battery clings to the surface of the active material, which might cause deterioration of the secondary battery. However, since the electrolyte containing fluorine is smooth, the decomposition product of the electrolyte is less likely to attach to the surface of the active material. Thus, the deterioration of the secondary battery can be inhibited.

In some cases, solvated lithium ions form a cluster in the electrolyte and the cluster moves in the negative electrode 570a, between the positive electrode 570b and the negative electrode 570a, or in the positive electrode 570b, for example.

In this specification, an electrolyte is a general term of a solid material, a liquid material, a semi-solid-state material, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. In addition, a structure may be employed in which a binder, a graphene compound, or the like clings to or is held by the electrolyte containing fluorine. This structure can maintain the state where the viscosity of the electrolyte is low, i.e., the state where the electrolyte is smooth, and can improve the reliability of the secondary battery. Note that DFEC to which two fluorine atoms are bonded and F4EC to which four fluorine atoms are bonded have lower viscosities, are smoother, and are coordinated to lithium more weakly as compared with FEC to which one fluorine atom is bonded. Accordingly, it is possible to reduce attachment of a decomposition product with a high viscosity to an active material particle. When a decomposition product with a high viscosity is attached to or clings to an active material particle, a lithium ion is less likely to move at an interface between active material particles. The solvating fluorine-containing electrolyte reduces generation of a decomposition product that is to be attached to the surface of the active material (the positive electrode active material or the negative electrode active material). Moreover, the use of the electrolyte containing fluorine prevents attachment of a decomposition product, which can prevent generation and growth of a dendrite.

The use of the electrolyte containing fluorine as a main component is also a feature, and the amount of the electrolyte containing fluorine is higher than or equal to 5 volume % or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume % of the whole electrolyte.

With use of the electrolyte containing fluorine, it is possible to provide a secondary battery that can operate in a wide temperature range, specifically, higher than or equal to −40° C. and lower than or equal to 150° C., preferably higher than or equal to −40° C. and lower than or equal to 85° C.

An additive such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 volume % and lower than 5 volume %.

The electrolyte may contain one or more aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

Although the above structure is an example of a secondary battery using a liquid electrolyte, one embodiment of the present invention is not particularly limited thereto. For example, a semi-solid-state battery and an all-solid-state battery can be fabricated.

In this specification and the like, a layer provided between the positive electrode 570b and the negative electrode 570a is referred to as an electrolyte layer in both the case of a secondary battery using a liquid electrolyte and the case of a semi-solid-state battery. An electrolyte layer of a semi-solid-state battery is a layer formed by deposition, and can be distinguished from a liquid electrolyte layer.

In this specification and the like, a semi-solid-state battery refers to a battery in which at least one of the electrolyte layer, the positive electrode 570b, and the negative electrode 570a includes a semi-solid-state material. The semi-solid-state here does not mean that the proportion of a solid-state material is 50%. The semi-solid-state means having properties of a solid, such as a small volume change, and also having some of properties close to those of a liquid, such as flexibility. A single material or a plurality of materials can be used to satisfy the above properties. For example, a porous solid-state material infiltrated with a liquid material may be used.

In this specification and the like, a polymer electrolyte secondary battery refers to a secondary battery in which the electrolyte layer between the positive electrode 570b and the negative electrode 570a includes a polymer. Polymer electrolyte secondary batteries include a dry (or true) polymer electrolyte battery and a polymer gel electrolyte battery.

The electrolyte 576 contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound including a polar group to which cations can coordinate. The polar group is preferably an ether group, an ester group, a nitrile group, a carbonyl group, siloxane, or the like.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions are broken to increase amorphous regions, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.0590 nm in the case of tetracoordination, 0.076 nm in the case of hexacoordination, and 0.092 nm in the case of octacoordination. The radius of a bivalent oxygen ion is 0.135 nm in the case of bicoordination, 0.136 nm in the case of tricoordination, 0.138 nm in the case of tetracorrdination, 0.140 nm in the case of hexacoordination, and 0.142 nm in the case of octacoordination. The distance between polar groups included in adjacent lithium-ion conductive polymer chains is preferably greater than or equal to the distance that allows lithium ions and anion ions contained in the polar groups to exist stably while the above ionic radius is maintained. Furthermore, the distance between the polar groups is preferably close enough to cause interaction between the lithium ions and the polar groups. Note that the distance is not necessarily always kept constant because the segmental motion occurs as described above. The distance needs to be appropriate only when lithium ions are transferred.

As the lithium salt, it is possible to use a compound containing lithium and at least one or more of phosphorus, fluorine, nitrogen, sulfur, oxygen, chlorine, arsenic, boron, aluminum, bromine, and iodine. For example, one of lithium salts such as LiPF₆, LiN(FSO₂)₂ (lithiumbis(fluorosulfonyl)imide, LiFSI), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂ (lithium bis(trifluoromethanesulfonyl)imide, LiTFSA), LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination at an appropriate ratio.

It is particularly preferable to use LiFSI because favorable characteristics at low temperatures can be obtained. Note that LiFSI and LiTFSA are less likely to react with water than LiPF₆ or the like. This can relax the dew point control in fabricating an electrode and an electrolyte layer that use LiFSI. For example, the fabrication can be performed even in a normal air atmosphere, not only in an inert atmosphere such as argon in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSI and LiTFSA, in which case the operating temperature range can be wide.

When containing no or extremely little organic solvent, the secondary battery can be less likely to catch fire or ignite and thus can have higher level of safety, which is preferable.

### [Exterior Body]

For an exterior body included in the secondary battery, a metal material such as aluminum and a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. As the film, a fluorine resin film is preferably used. The fluorine resin film has high stability to acid, alkali, an organic solvent, and the like and suppresses a side reaction, corrosion, or the like caused by a reaction of a secondary battery or the like, whereby an excellent secondary battery can be provided. Examples of the fluorine resin film include PTFE (polytetrafluoroethylene), PFA (perfluoroalkoxy alkane: a copolymer of tetrafluoroethylene and perfluoroalkyl vinyl ether), FEP (a perfluoroethylene-propene copolymer: a copolymer of tetrafluoroethylene and hexafluoropropylene), and ETFE (an ethylene-tetrafluoroethylene copolymer: a copolymer of tetrafluoroethylene and ethylene).

This embodiment can be used in appropriate combination with the other embodiments.

### Embodiment 2

In this embodiment, a positive electrode and a positive electrode active material composite of one of the present invention will be described.

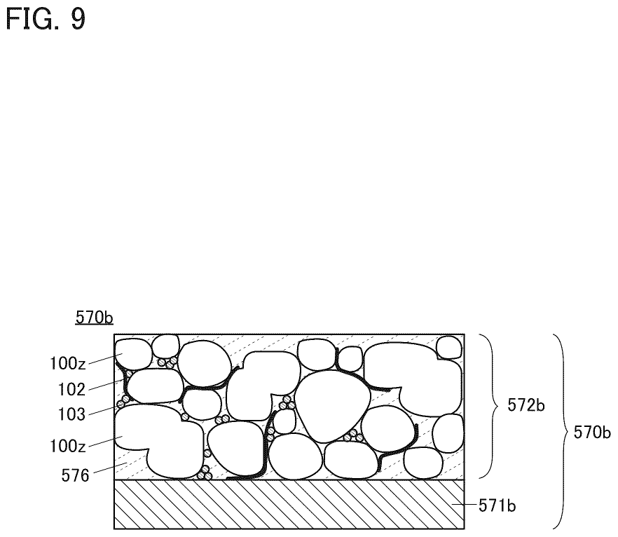

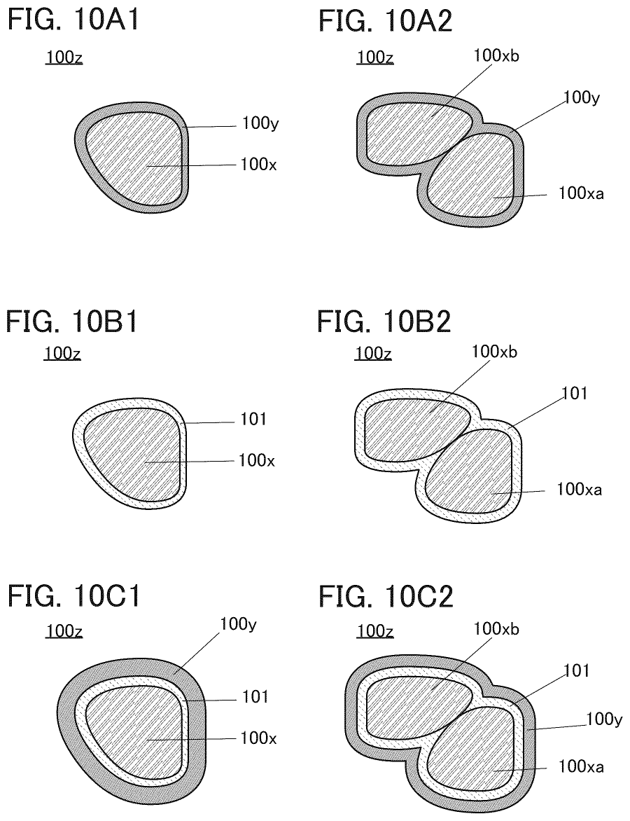

An example of the positive electrode 570b of one embodiment of the present invention is illustrated in FIG. 9. The positive electrode 570b includes the positive electrode current collector 571b and the positive electrode active material layer 572b. The positive electrode active material layer 572b includes a positive electrode active material composite 100z. As illustrated in FIG. 10A1 and FIG. 10A2, the positive electrode active material composite 100z includes, for example, a first active material 100x and a second active material 100y that are capable of occluding and releasing carrier ions. Although FIG. 9 illustrates the example where a graphene compound 102 and carbon black 103 are used as conductive materials, no conductive material may be used in the positive electrode active material layer 572b when the positive electrode active material composite 100z has sufficient electron conductivity. The kind of conductive material is not limited to the example illustrated in FIG. 9, and only a graphene compound, carbon black, or carbon fiber such as carbon nanotube may be used, or carbon fiber such as carbon nanotube and carbon black may be used in combination. Although not illustrated in FIG. 9, the positive electrode active material layer 572b preferably includes a binder. As the binder, a high molecular material such as polyvinylidene fluoride and a molecular crystalline electrolyte such as Li(FSI)(SN)₂ can be used.

The positive electrode active material composite 100z is placed in a state where electrons can be donated to and accepted from the positive electrode current collector 571b. That is, the positive electrode active material composite 100z is electrically connected to the positive electrode current collector 571b. The positive electrode current collector 571b may be provided with an undercoat layer. In that case, the positive electrode active material composite 100z is electrically connected to the positive electrode current collector 571b with the undercoat layer therebetween. The positive electrode active material composite 100z may be electrically connected to the positive electrode current collector 571b with the conductive material therebetween.

Note that the density of the positive electrode active material layer 572b is preferably higher than or equal to 3.0 g/cm³, further preferably higher than or equal to 3.5 g/cm³, still further preferably higher than or equal to 3.8 g/cm³; therefore, pressing treatment may be performed to increase the density of the positive electrode active material layer 572b. Note that in the case of performing pressing treatment, conditions of the pressing treatment are desirably set as appropriate so as not to lose structures of the first active material 100x and the positive electrode active material composite 100z described later.

### [Positive Electrode Active Material Composite]

FIG. 10A1 to FIG. 10C2 are schematic cross-sectional views each illustrating the positive electrode active material composite 100z.

FIG. 10A1 and FIG. 10A2 are diagrams each illustrating the positive electrode active material composite 100z including the first active material 100x functioning as a positive electrode active material and the second active material 100y covering at least part of the first active material 100x. Note that although one first active material 100x is covered with the second active material 100y in FIG. 10A1, the present invention is not limited thereto, and a plurality of the first active materials 100x may be covered with the second active material 100y.

For example, as illustrated in FIG. 10A2, at least parts of a first active material 100xa and a first active material 100xb may be covered with the second active material 100y. FIG. 10A2 illustrates a case where at least parts of the first active material 100xa and the first active material 100xb are in contact with each other; however, the first active material 100xa and the first active material 100xb are not necessarily directly in contact with each other. In the state where at least part of the particle surface, desirably, substantially the entire particle surface of the particulate first active material 100x functioning as a positive electrode active material is covered with second active material 100y, a region where the first active material 100x is directly in contact with the electrolyte 576 is reduced. This can inhibit release of a transition metal element and/or oxygen from the first active material 100x in a high-voltage charged state to inhibit a capacity reduction due to repeated charging and discharging. Since the first active material 100x is covered with the second active material 100y that is electrochemically stable even in a high-voltage charged state at high temperatures, a secondary battery using the positive electrode active material composite 100z of one embodiment of the present invention can have effects such as an improvement in stability at high temperatures and an improvement in fire resistance.

FIG. 10B1 and FIG. 10B2 are diagrams each illustrating the positive electrode active material composite 100z including the first active material 100x functioning as a positive electrode active material and glass 101 covering at least part of the first active material 100x. Note that although one first active material 100x is covered with the glass 101 in FIG. 10B1, the present invention is not limited thereto, and a plurality of the first active materials 100x may be covered with the glass 101.

For example, as illustrated in FIG. 10B2, at least parts of the first active material 100xa and the first active material 100xb may be covered with the glass 101. FIG. 10B2 illustrates a case where at least parts of the first active material 100xa and the first active material 100xb are in contact with each other; however, the first active material 100xa and the first active material 100xb are not necessarily directly in contact with each other. In the state where at least part of the particle surface, desirably, substantially the entire particle surface of the particulate first active material 100x functioning as a positive electrode active material is covered with the glass 101, a region where the first active material 100x is directly in contact with the electrolyte 576 is reduced. This can inhibit release of a transition metal element and/or oxygen from the first active material 100x in a high-voltage charged state to inhibit a capacity reduction due to repeated charging and discharging. Since the first active material 100x is covered with the glass 101 that is electrochemically stable even in a high-voltage charged state at high temperatures, a secondary battery using the positive electrode active material composite 100z of one embodiment of the present invention can have effects such as an improvement in stability at high temperatures and an improvement in fire resistance.

FIG. 10C1 and FIG. 10C2 are diagrams each illustrating the positive electrode active material composite 100z including the first active material 100x functioning as a positive electrode active material and the second active material 100y in contact with the first active material 100x with the glass 101 covering at least part of the first active material 100x therebetween. Note that although one first active material 100x is covered with the glass 101 in FIG. 10C1, the present invention is not limited thereto, and a plurality of the first active materials 100x may be covered with the glass 101.

For example, as illustrated in FIG. 10C2, at least parts of the first active material 100xa and the first active material 100xb may be covered with the glass 101. FIG. 10C2 illustrates a case where at least parts of the first active material 100xa and the first active material 100xb are in contact with each other; however, the first active material 100xa and the first active material 100xb are not necessarily directly in contact with each other. In the state where at least part of the particle surface, desirably, substantially the entire particle surface of the particulate first active material 100x functioning as a positive electrode active material is covered with the glass 101, in the positive electrode active material composite 100z including the second active material 100y in contact with the first active material 100x with the glass 101 therebetween, a region where the first active material 100x is directly in contact with the electrolyte 576 is reduced. This can inhibit release of a transition metal element and/or oxygen from the first active material 100x in a high-voltage charged state to inhibit a capacity reduction due to repeated charging and discharging. Since the first active material 100x is covered with the glass 101 that is electrochemically stable even in a high-voltage charged state at high temperatures and the second active material 100y that is stable in a high charge voltage state, a secondary battery using the positive electrode active material composite 100z of one embodiment of the present invention can have effects such as an improvement in stability at high temperatures and an improvement in fire resistance.

In the positive electrode active material composite 100z illustrated in FIG. 10A1 to FIG. 10C2, the use of the material having excellent stability in a high-voltage charged state as the first active material 100x, such as lithium cobalt oxide containing magnesium and fluorine, lithium cobalt oxide containing magnesium, fluorine, aluminum, and nickel, or lithium nickel-cobalt-manganese oxide with a molar ratio of nickel:cobalt:manganese=8:1:1, nickel:cobalt:manganese=9:0.5:0.5, or the like allows the positive electrode active material composite 100z to have further improved durability and further improved stability in a high-voltage charged state. In addition, the secondary battery using the positive electrode active material composite 100z can have further improved heat resistance and/or fire resistance.

Note that the lithium cobalt oxide containing magnesium, fluorine, aluminum, and nickel has features in which a large amount of magnesium, fluorine, or aluminum is contained in a surface portion of the positive electrode active material and nickel is widely distributed in the whole particle, and exhibits remarkably excellent repeated high-voltage charge and discharge performance, and thus is a material particularly preferred as the first active material 100x. In the case where the surface portion of the positive electrode active material contains a large amount of magnesium, fluorine, or aluminum, the count number of the characteristic X-rays derived from magnesium, fluorine, or aluminum has the maximum value in the surface portion in, for example, a STEM-EDX line analysis. Here, the surface portion refers to a region within approximately 10 nm from a surface of a positive electrode active material. Note that a crack portion included in the positive electrode active material includes a surface portion, and a crack portion generated before the addition of magnesium, fluorine, or aluminum in the formation of the positive electrode active material includes a surface portion containing a large amount of magnesium, fluorine, or aluminum.

The positive electrode active material composite 100z like those illustrated in FIG. 10A1 and FIG. 10A2 can be obtained by a composing process using at least the first active material 100x and the second active material 100y. As the composing process, one or more of the following composing processes can be used: a composing process using mechanical energy, e.g., a mechanochemical method, a mechanofusion method, or a ball mill method; a composing process using a liquid phase reaction, e.g., a coprecipitation method, a hydrothermal method, or a sol-gel method; and a composing process using a gas phase reaction, e.g., a barrel sputtering method, an ALD (Atomic Layer Deposition) method, an evaporation method, or a CVD (Chemical Vapor Deposition) method. Heat treatment is preferably performed once or more times in the composing process. Note that a composing process in this specification is sometimes referred to as a surface coating process or a coating process.

The positive electrode active material composite 100z like those illustrated in FIG. 10B1 and FIG. 10B2 can be obtained by a composing process using at least the first active material 100x and the glass 101. As the composing process, one or more of the following composing processes can be used: a composing process using mechanical energy, e.g., a mechanochemical method, a mechanofusion method, or a ball mill method; a composing process using a liquid phase reaction, e.g., a coprecipitation method, a hydrothermal method, or a sol-gel method; and a composing process using a gas phase reaction, e.g., a barrel sputtering method, an ALD method, an evaporation method, or a CVD method. Heat treatment is preferably performed once or more times in the composing process.

The positive electrode active material composite 100z like those illustrated in FIG. 10C1 and FIG. 10C2 can be obtained by a composing process using at least the first active material 100x, the second active material 100y, and the glass 101. As the composing process, one or more of the following composing processes can be used: a composing process using mechanical energy, e.g., a mechanochemical method, a mechanofusion method, or a ball mill method; a composing process using a liquid phase reaction, e.g., a coprecipitation method, a hydrothermal method, or a sol-gel method; and a composing process using a gas phase reaction, e.g., a barrel sputtering method, an ALD method, an evaporation method, or a CVD method. Heat treatment is preferably performed once or more times in the composing process.

In the positive electrode active material composite 100z of one embodiment of the present invention as described above, the first active material 100x is not in contact with the electrolyte 576 and thus is inhibited from deteriorating due to the electrolyte. The deterioration results from defects generated in the first active material 100x in some cases, and examples of the defects include a pit. A pit refers to a region from which some layers of main components, for example, cobalt and oxygen, of the first active material 100x are extracted in a charge and discharge cycle test. For example, it is considered that cobalt is sometimes eluted into an electrolyte. A pit sometimes develops in the inner side direction of the active material in a charge and discharge cycle test. Note that an opening shape of a pit is not circular but a wide groove-like shape. With a structure in which the electrolyte 576 and the first active material 100x are not in contact with each other, generation and development of the defects, particularly a pit, can be inhibited.

When the positive electrode active material composite 100z includes the second active material 100y in contact with the first active material 100x with the glass 101 therebetween, the positive electrode active material composite 100z can be regarded as having a two-layer structure in the surface portion. Note that the positive electrode active material composite 100z of one embodiment of the present invention is not limited to the case of having a two-layer structure of the glass 101 and the second active material 100y. As another example of the positive electrode active material composite 100z of one embodiment of the present invention, a structure may be employed in which a glass active material mixed layer including the glass 101 and the second active material 100y cover at least part of the surface of the first active material 100x.

In the positive electrode active material composite 100z of one embodiment of the present invention, the graphene compound 102 may be contained in the surface portion or the glass active material mixed layer of the positive electrode active material composite 100z. Here, carbon fiber such as carbon black or carbon nanotube may be used instead of the graphene compound 102.

A material including an amorphous part can be used for the glass 101. Examples of the material including an amorphous part include a material containing one or more selected from SiO₂, SiO, Al₂O₃, TiO₂, Li₄SiO₄, Li₃PO₄, Li₂S, SiS₂, B₂S₃, GeS₄, AgI, Ag₂O, Li₂O, P₂O₅, B₂₀₃, V₂O₅, and the like; Li₇P₃S₁₁; and Li_{1+x+y}AlₓTi₂₋ₓSi_{y}P_{3-y}O₁₂ (0<x<2 and 0<y<3). The material including an amorphous part can be used in the state where the entire part is amorphous or in the state of crystallized glass part of which is crystallized (also referred to as glass ceramic). The glass 101 desirably has lithium-ion conductivity. Having the lithium-ion conductivity can also be regarded as having a diffusion property of lithium ions and a penetration property of lithium ions. The melting point of the glass 101 is preferably 800° C. or lower, further preferably 500° C. or lower. The glass 101 preferably has electron conductivity. Furthermore, the glass 101 preferably has a softening point of 800° C. or lower, and Li₂O—B₂O₃—SiO₂ based glass can be used, for example.

Note that the glass 101 desirably has electron conductivity, but when the glass 101 has low electron conductivity, mixing a carbon fiber conductive material such as a graphene compound, carbon black, or carbon nanotube with the glass 101 can impart electron conductivity to the glass 101.

Note that at least part of the surface of the positive electrode active material composite 100z may be covered with a graphene compound. It is preferable that 80% or more of the particle surface of the positive electrode active material composite 100z and/or 80% or more of an aggregate including the positive electrode active material composite 100z be covered with a graphene compound. The graphene compound will be described later.

The positive electrode active material composite 100z is preferably covered with a molecular crystalline electrolyte. The molecular crystalline electrolyte can function as a binder of the positive electrode active material layer 572b. The molecular crystalline electrolyte is preferably a material having high ionic conductivity, and the positive electrode active material composite 100z covered with the molecular crystalline electrolyte can donate and accept carrier ions to and from the electrolyte 576.

### [Positive Electrode Active Material]

As the first active material 100x, a composite oxide represented by LiM1O₂ (M1 is one or more selected from Fe, Ni, Co, and Mn) and having a layered rock-salt crystal structure can be used. Furthermore, as the first active material 100x, a composite oxide that is represented by LiM1O₂ and to which an additive element X is added can be used. As the additive element X included in the first active material 100x, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used. These elements further stabilize the crystal structure included in the first active material 100x in some cases. That is, the first active material 100x can contain lithium cobalt oxide containing magnesium and fluorine; lithium cobalt oxide containing magnesium, fluorine, aluminum, and nickel; lithium cobalt oxide containing magnesium, fluorine, and titanium; lithium nickel-cobalt oxide containing magnesium and fluorine; lithium cobalt-aluminum oxide containing magnesium and fluorine; lithium nickel-cobalt-aluminum oxide; lithium nickel-cobalt-aluminum oxide containing magnesium and fluorine; lithium nickel-cobalt-manganese oxide containing magnesium and fluorine; or the like. Here, as for the proportions of the transition metals of the lithium nickel-cobalt-manganese oxide, the proportion of nickel is preferably high; e.g., a material with a molar ratio of nickel:cobalt:manganese=8:1:1 or nickel:cobalt:manganese=9:0.5:0.5 is preferred. Lithium nickel-cobalt-manganese oxide containing calcium is preferably included as the above-described lithium nickel-cobalt-manganese oxide.

Alternatively, as the first active material 100x, a material in which secondary particles of the composite oxide represented by LiM1O₂ (M1 is one or more selected from Fe, Ni, Co, and Mn) are coated with a metal oxide may be used. As the metal oxide, an oxide of one or more metals selected from Al, Ti, Nb, Zr, La, and Li can be used. For example, a metal-oxide-coated composite oxide in which secondary particles of the composite oxide represented by LiM1O₂ (M1 is one or more selected from Fe, Ni, Co, and Mn) are coated with aluminum oxide can be used as the first active material 100x. For example, a metal-oxide-coated composite oxide in which secondary particles of lithium nickel-cobalt-manganese oxide with a molar ratio of nickel:cobalt:manganese=8:1:1 or nickel:cobalt:manganese=9:0.5:0.5 are coated with aluminum oxide can be used. Here, the thickness of the coating layer is preferably small, for example, greater than or equal to 1 nm and less than or equal to 200 nm, further preferably greater than or equal to 1 nm and less than or equal to 100 nm. Lithium nickel-cobalt-manganese oxide containing calcium is preferably included as the above-described lithium nickel-cobalt-manganese oxide.

As the first active material 100x, the positive electrode active material 100 described in the following embodiments can be used.

As the second active material 100y, one or more of an oxide and LiM2PO₄ having an olivine crystal structure (M2 is one or more selected from Fe, Ni, Co, and Mn) can be used. Examples of the oxide include aluminum oxide, zirconium oxide, hafnium oxide, and niobium oxide. Examples of LiM2PO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFe_{f}Ni_{g}CoₕMnᵢPO₄ (f+g+h+i is 1 or less, 0<f<1, 0<g<1, 0<h<1, and 0<i<1). In addition, a carbon coating layer may be provided on the particle surface of the second active material 100y.

For example, one kind or two or more kinds of carbon black such as acetylene black or furnace black, graphite such as artificial graphite or natural graphite, carbon fiber such as carbon nanofiber or carbon nanotube, and a graphene compound can be used as the conductive material.

This embodiment can be used in appropriate combination with the other embodiments.

### Embodiment 3

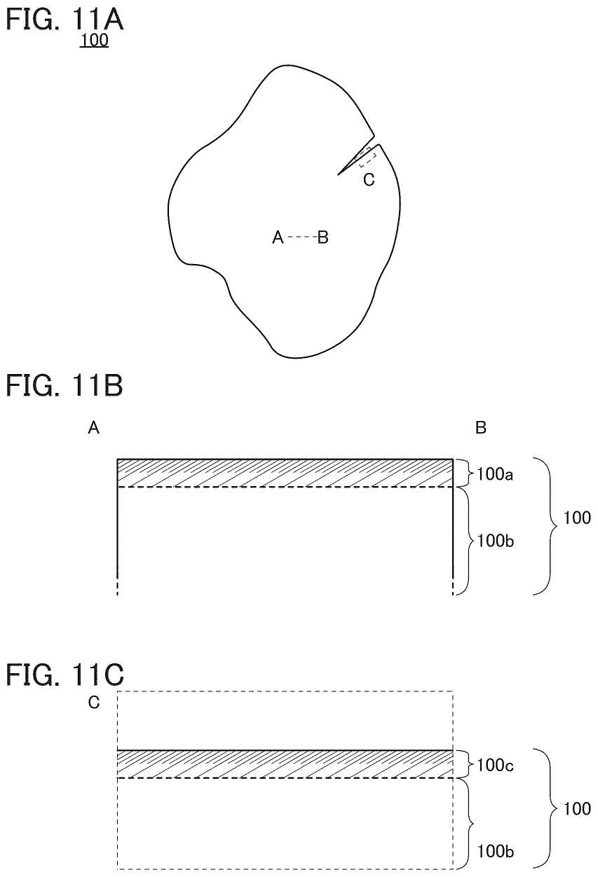

In this embodiment, a positive electrode active material of one embodiment of the present invention is described with reference to FIG. 11 to FIG. 17.

In this specification and the like, crystal planes and orientations are indicated by the Miller index. In the crystallography, a bar is placed over a number in the expression of crystal planes and orientations; however, in this specification and the like, because of application format limitations, crystal planes and orientations are sometimes expressed by placing-(a minus sign) before the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. As the Miller indices of trigonal system and hexagonal system such as R-3m, not only (hkl) but also (hkil) are used in some cases. Here, i is −(h+k).

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist in part of the crystal structure.

In this specification and the like, the theoretical capacity of a positive electrode active material refers to the amount of electricity for the case where all the lithium that can be inserted into and extracted from the positive electrode active material is extracted. For example, the theoretical capacity of LiFePO₄ is 170 mAh/g, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂ or LiₓMO₂. In this specification, LiₓCoO₂ can be replaced with LiₓMO₂ as appropriate. It can be said that x is an occupancy rate, and in the case of a positive electrode active material in a secondary battery, x may be represented by (theoretical capacity-charge capacity)/theoretical capacity. For example, when a secondary battery using LiCoO₂ as a positive electrode active material is charged to 219.2 mAh/g, the positive electrode active material can be represented by Li_{0.2}CoO₂ or x=0.2. Small x in LixCoO₂ means, for example, 0.1<x≤0.24.

In the case where lithium cobalt oxide almost satisfies the stoichiometric composition proportion, lithium cobalt oxide is LiCoO₂ and the occupancy rate of Li in the lithium sites is x=1. For a secondary battery after its discharge ends, it can be said that lithium cobalt oxide is LiCoO₂ and x=1. Here, “discharging ends” means that a voltage becomes lower than or equal to 2.5 V (lithium counter electrode) at a current of 100 mA/g, for example. In a lithium-ion secondary battery, the voltage of the lithium-ion secondary battery rapidly decreases when the occupancy rate of lithium in the lithium sites becomes x=1 and more lithium cannot enter the lithium-ion secondary. At this time, it can be said that the discharge is terminated. In general, in a lithium-ion secondary battery using LiCoO₂, the discharge voltage rapidly decreases until discharge voltage reaches 2.5 V; thus, discharge is terminated under the above-described conditions

In this specification and the like, the charge depth obtained when all the lithium that can be inserted into and extracted from a positive electrode material is inserted is 0, and the charge depth obtained when all the lithium that can be inserted into and extracted from the positive electrode active material is extracted is 1, in some cases.

### [Positive Electrode Active Material]

In this embodiment, a positive electrode active material of one embodiment of the present invention is described with reference to FIG. 11 to FIG. 15.

FIG. 11A is a schematic top view of the positive electrode active material 100 which is one embodiment of the present invention. FIG. 11B is a schematic cross-sectional view taken along A-B in FIG. 11A.

### <Included Elements and Distribution>

The positive electrode active material 100 contains lithium, a transition metal, oxygen, and an additive element X. The positive electrode active material 100 can be regarded as a composite oxide represented by LiM1O₂ (M1 is one or more selected from Fe, Ni, Co, and Mn) to which the additive element X is added.

As the transition metal contained in the positive electrode active material 100, a metal that can form, together with lithium, a composite oxide having the layered rock-salt structure belonging to the space group R-3m is preferably used. For example, at least one of manganese, cobalt, and nickel can be used. That is, as the transition metal contained in the positive electrode active material 100, only cobalt may be used, only nickel may be used, two metals of cobalt and manganese may be used or two metals of cobalt and nickel may be used, or three metals of cobalt, manganese, and nickel may be used. In other words, the positive electrode active material 100 can include a composite oxide containing lithium and the transition metal, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide. Nickel is preferably contained as the transition metal in addition to cobalt, in which case a crystal structure may be more stable in a high-voltage charged state.

As the additive element X included in the positive electrode active material 100, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used. These elements further stabilize the crystal structure of the positive electrode active material 100 in some cases. The positive electrode active material 100 can contain lithium cobalt oxide containing magnesium and fluorine; lithium cobalt oxide containing magnesium, fluorine, and titanium; lithium nickel-cobalt oxide containing magnesium and fluorine; lithium cobalt-aluminum oxide containing magnesium and fluorine; lithium nickel-cobalt-aluminum oxide; lithium nickel-cobalt-aluminum oxide containing magnesium and fluorine; lithium nickel-manganese-cobalt oxide containing magnesium and fluorine; or the like. In this specification and the like, the additive element X may be rephrased as a constituent of a mixture or a raw material or the like.

As illustrated in FIG. 11B, the positive electrode active material 100 includes a surface portion 100a and an inner portion 100b. The surface portion 100a preferably has a higher concentration of the additive element X than the inner portion 100b. The concentration of the additive element X preferably has a gradient as illustrated in FIG. 11B by gradation, in which the concentration increases from the inner portion toward the surface. In this specification and the like, the surface portion 100a refers to a region within approximately 10 nm from a surface of the positive electrode active material 100. A plane generated by a split and/or a crack may also be referred to as a surface, and a region within approximately 10 nm from the surface is referred to as a surface portion 100c as illustrated in FIG. 11C. A region which is deeper than the surface portion 100a and the surface portion 100c of the positive electrode active material 100 is referred to as the inner portion 100b. When the positive electrode active material 100 forms the positive electrode active material composite 100z, a plane generated by a crack is desirably covered with the glass 101 as well.

In order to prevent the breakage of a layered structure formed of octahedrons of cobalt and oxygen even when lithium is extracted from the positive electrode active material 100 of one embodiment of the present invention by charge, the surface portion 100a having a high concentration of the additive element X, i.e., the outer portion of a particle, is reinforced.

The concentration gradient of the additive element X preferably exists uniformly in the entire surface portion 100a of the positive electrode active material 100. A situation where only part of the surface portion 100a has reinforcement is not preferable because stress might be concentrated on parts that do not have reinforcement. The concentration of stress on part of a particle might cause defects such as cracks from that part, leading to breakage of the positive electrode active material and a decrease in charge and discharge capacity.

Magnesium is divalent and is more stable in lithium sites than in transition metal sites in the layered rock-salt crystal structure; thus, magnesium is likely to enter the lithium sites. An appropriate concentration of magnesium in the lithium sites of the surface portion 100a facilitates maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charging and discharging, and is thus preferable. However, excess magnesium might adversely affect insertion and extraction of lithium.

Aluminum is trivalent and can exist at a transition metal site in the layered rock-salt crystal structure. Aluminum can inhibit dissolution of surrounding cobalt. The bonding strength of aluminum with oxygen is high, thereby inhibiting extraction of oxygen around aluminum. Hence, aluminum included as the additive element X enables the positive electrode active material 100 to have the crystal structure that is unlikely to be broken by repetitive charging and discharging.

When fluorine, which is a monovalent anion, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

A titanium oxide is known to have superhydrophilicity. Accordingly, the positive electrode active material 100 including an oxide of titanium in the surface portion 100a presumably has good wettability with respect to a high-polarity solvent. Such the positive electrode active material 100 and a high-polarity electrolyte solution can have favorable contact at the interface therebetween and presumably inhibit a resistance increase when a secondary battery is formed using the positive electrode active material 100. Note that in this specification and the like, an electrolyte solution corresponds to a liquid electrolyte.

The voltage of a positive electrode generally increases with increasing charge voltage of a secondary battery. The positive electrode active material of one embodiment of the present invention has a stable crystal structure even at high voltage. The stable crystal structure of the positive electrode active material in a charged state can inhibit a capacity decrease due to repetitive charging and discharging.

A short circuit of a secondary battery might cause not only malfunction in charge operation and/or discharge operation of the secondary battery but also heat generation and firing. In order to obtain a safe secondary battery, a short-circuit current is preferably inhibited even at high charge voltage. In the positive electrode active material 100 of one embodiment of the present invention, a short-circuit current is inhibited even at high charge voltage. Thus, a secondary battery with high capacity and safety can be obtained.

It is preferable that a secondary battery using the positive electrode active material 100 of one embodiment of the present invention have high capacity, excellent charge and discharge cycle performance, and safety simultaneously.

The gradient of the concentration of the additive element X can be evaluated using energy dispersive X-ray spectroscopy (EDX). In the EDX measurement, to measure a region while scanning the region and evaluate the region two-dimensionally is referred to as EDX planar analysis in some cases. In addition, to extract data of a linear region from EDX planar analysis and evaluate the atomic concentration distribution in a positive electrode active material particle is referred to as linear analysis in some cases.

By EDX surface analysis (e.g., element mapping), the concentrations of the additive element X in the surface portion 100a, the inner portion 100b, the vicinity of the crystal grain boundary, and the like of the positive electrode active material 100 can be quantitatively analyzed. By EDX linear analysis, the concentration distribution of the additive element X can be analyzed.

When the positive electrode active material 100 is analyzed with the EDX linear analysis, a peak of the magnesium concentration (the position where the concentration has the maximum value) in the surface portion 100a preferably exists in a region from the surface of the positive electrode active material 100 to a depth of 3 nm toward the center, further preferably to a depth of 1 nm, and still further preferably to a depth of 0.5 nm.

In addition, the distribution of fluorine contained in the positive electrode active material 100 preferably overlaps with the distribution of magnesium. Thus, when the EDX linear analysis is performed, a peak of the fluorine concentration (the position where the concentration has the maximum value) in the surface portion 100a preferably exists in a region from the surface of the positive electrode active material 100 to a depth of 3 nm toward the center, further preferably to a depth of 1 nm, and still further preferably to a depth of 0.5 nm.

Note that the concentration distribution may differ between the additive elements X. For example, in the case where the positive electrode active material 100 contains aluminum as the additive element X, the distribution of aluminum is preferably slightly different from that of magnesium and that of fluorine. For example, in the EDX linear analysis, the peak of the magnesium concentration (the position where the concentration has the maximum value) is preferably closer to the surface than the peak of the aluminum concentration (the position where the concentration has the maximum value) is in the surface portion 100a. For example, the peak of the aluminum concentration preferably exists in a region from the surface of the positive electrode active material 100 to a depth of 0.5 nm or more and 20 nm or less toward the center, and further preferably to a depth of 1 nm or more and 5 nm or less.

When the linear analysis or the surface analysis is performed on the positive electrode active material 100, the ratio (X/M1) between an additive element X and the transition metal M1 in the vicinity of the grain boundary is preferably greater than or equal to 0.020 and less than or equal to 0.50. It is further preferably greater than or equal to 0.025 and less than or equal to 0.30. It is still further preferably greater than or equal to 0.030 and less than or equal to 0.20. For example, when the additive element X is magnesium and the transition metal M1 is cobalt, the atomic ratio (Mg/Co) between magnesium and cobalt is preferably greater than or equal to 0.020 and less than or equal to 0.50. It is further preferably greater than or equal to 0.025 and less than or equal to 0.30. It is still further preferably greater than or equal to 0.030 and less than or equal to 0.20.

As described above, an excess amount of the additive element X in the positive electrode active material 100 might adversely affect insertion and extraction of lithium. The use of such a positive electrode active material 100 for a secondary battery might cause a resistance increase, a capacity decrease, and the like. Meanwhile, when the amount of additive is insufficient, the additive element is not distributed over the whole surface portion 100a, which might reduce the effect of maintaining the crystal structure. In this manner, the additive element X is adjusted so as to obtain an appropriate concentration in the positive electrode active material 100

For this reason, the positive electrode active material 100 may include a region where excess additive element X is unevenly distributed, for example. With such a region, the excess additive element X is removed from the other region, and the additive element X concentration in most of the inner portion and the surface portion of the positive electrode active material 100 can be appropriate. An appropriate additive element X concentration in most of the inner portion and the surface portion of the positive electrode active material 100 can inhibit a resistance increase, a capacity decrease, and the like when the positive electrode active material 100 is used for a secondary battery. A feature of inhibiting a resistance increase of a secondary battery is extremely preferable especially in charge and discharge at a high rate.

In the positive electrode active material 100 including the region where the excess additive element X is unevenly distributed, mixing of the excess additive element X to some extent in the formation process is acceptable. This is preferable because the margin of production can be increased.

Note that in this specification and the like, uneven distribution means that the concentration of an element differs between a region A and a region B. It may be rephrased as segregation, precipitation, unevenness, deviation, high concentration, low concentration, or the like.

### <Crystal Structure>

A material with the layered rock-salt crystal structure, such as lithium cobalt oxide (LiCoO₂), is known to have a high discharge capacity and excel as a positive electrode active material of a secondary battery. As an example of the material with the layered rock-salt crystal structure, a composite oxide represented by LiM1O₂ (M1 is one or more selected from Fe, Ni, Co, and Mn) is given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charging and discharging are performed on LiNiO₂, the crystal structure might be broken because of the distortion. The influence of the Jahn-Teller effect is suggested to be small in LiCoO₂; hence, LiCoO₂ is preferable because the resistance to high-voltage charging and discharging is higher in some cases.

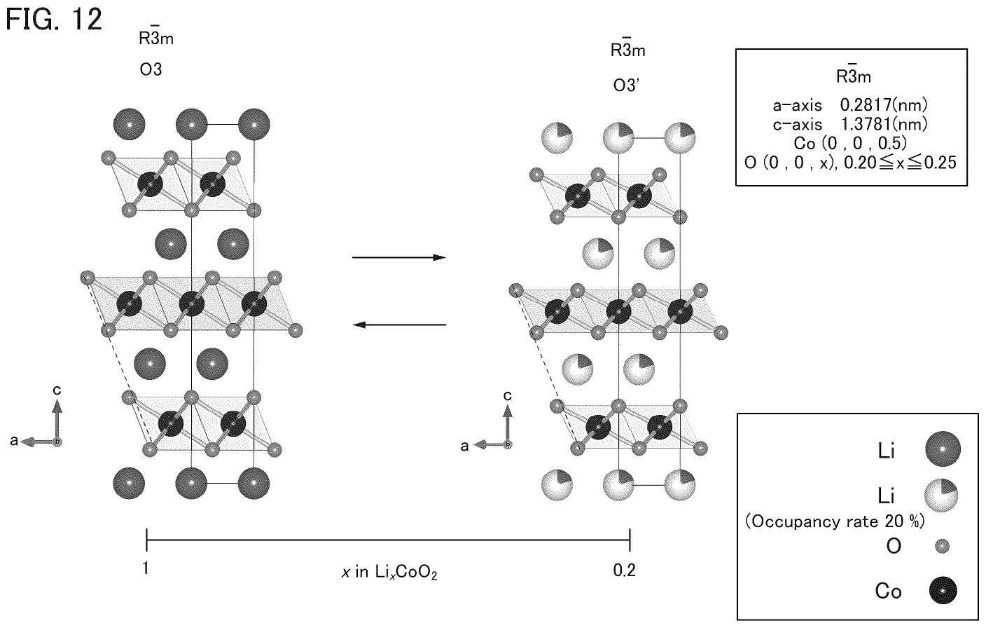

The structures of positive electrode active materials are described with reference to FIG. 12 to FIG. 17. In FIG. 12 to FIG. 17, the case where cobalt is used as the transition metal contained in the positive electrode active material is described.

### <Conventional Positive Electrode Active Material>

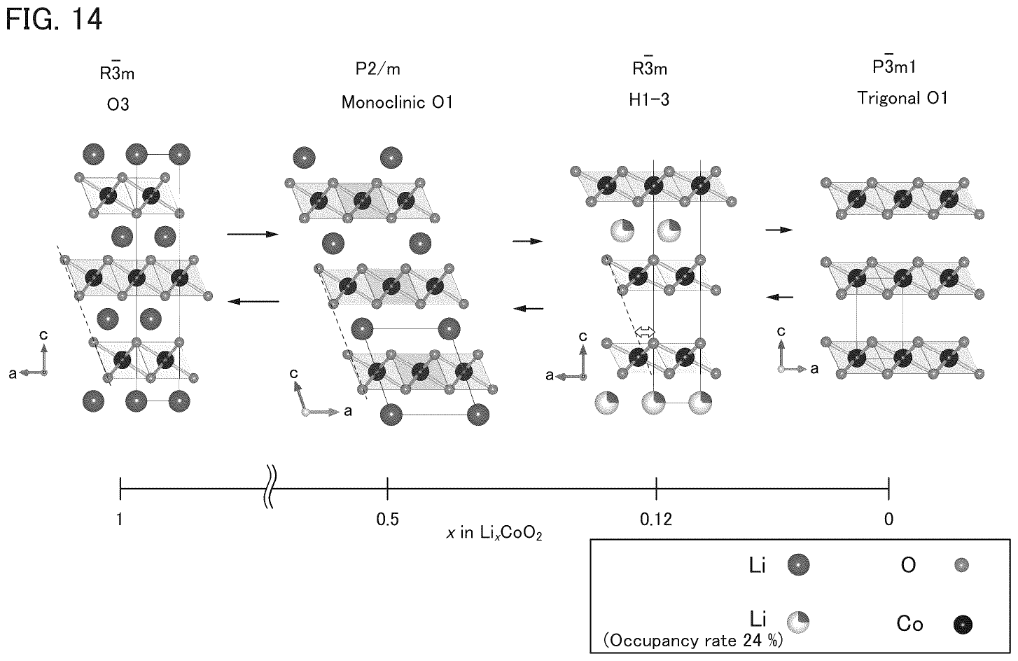

A positive electrode active material illustrated in FIG. 14 is lithium cobalt oxide (LiCoO₂ or LCO) to which halogen and magnesium are not added. The crystal structure of the lithium cobalt oxide illustrated in FIG. 14 changes depending on the charge depth. In other words, the crystal structure changes depending on the occupancy rate x of lithium in the lithium sites when the lithium cobalt oxide is referred to as LixCoO₂.

As illustrated in FIG. 14, lithium cobalt oxide in a state with x of 1 (discharged state) includes a region having the crystal structure belonging to the space group R-3m, and includes three CoO₂ layers in a unit cell. Thus, this crystal structure is referred to as an O3 type crystal structure in some cases. Note that the CoO₂ layer has a structure in which an octahedral structure with cobalt coordinated to six oxygen atoms continues in a plane direction in an edge-shared state.

Lithium cobalt oxide with x of 0 has a crystal structure belonging to the space group P-3m1 and includes one CoO₂ layer in a unit cell. Thus, this crystal structure is referred to as an O1 type crystal structure in some cases.

Lithium cobalt oxide with x of approximately 0.12 has the crystal structure belonging to the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. The number of cobalt atoms per unit cell in the actual H1-3 type crystal structure is twice that in other structures. However, in this specification including FIG. 14, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type crystal structure is represented by a unit cell including one cobalt atom and two oxygen atoms. Meanwhile, the O3′ type crystal structure of embodiments of the present invention are preferably represented by a unit cell including one cobalt atom and one oxygen atom, as described later. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (goodness of fit) is smaller in Rietveld analysis of XRD patterns, for example.

When charge at a high charge voltage of 4.6 V or more with reference to the redox potential of a lithium metal or charge with a large depth with x of 0.24 or less and discharge are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted lines and the double arrow in FIG. 14, the CoO₂ layer in the H1-3 type crystal structure largely shifts from R-3m (O3). Such a dynamic structural change can adversely affect the stability of the crystal structure.

A difference in volume is also large. The O3 type crystal structure in a discharged state and the H1-3 type crystal structure which contain the same number of cobalt atoms have a difference in volume of more than or equal to 3.0%.

In addition, a structure in which CoO₂ layers are arranged continuously, such as P-3m1 (O1), included in the H1-3 type crystal structure is highly likely to be unstable.

Thus, the repeated high-voltage charging and discharging causes loss of the crystal structure of lithium cobalt oxide. The broken crystal structure triggers deterioration of the cycle performance. This is probably because the loss of the crystal structure reduces sites where lithium can stably exist and makes it difficult to insert and extract lithium.

### <Positive Electrode Active Material of One Embodiment of the Present Invention>

### <Inner Portion>

In the positive electrode active material 100 of one embodiment of the present invention, the shift in CoO₂ layers can be small in repeated high-voltage charging and discharging. Furthermore, the change in the volume can be small. Accordingly, the positive electrode active material of one embodiment of the present invention can enable excellent cycle performance. In addition, the positive electrode active material of one embodiment of the present invention can have a stable crystal structure in a high-voltage charged state. Thus, the positive electrode active material of one embodiment of the present invention inhibits a short circuit in some cases while the high-voltage charged state is maintained. This is preferable because the safety is further improved.

The positive electrode active material of one embodiment of the present invention has a small crystal-structure change and a small volume difference per the same number of atoms of the transition metal between a sufficiently discharged state and a high-voltage charged state.

FIG. 12 illustrates the crystal structures of the positive electrode active material 100 before and after being charged and discharged. The positive electrode active material 100 is a composite oxide containing lithium, cobalt as the transition metal, and oxygen. In addition to the above, the positive electrode active material 100 preferably contains magnesium as the additive element X. Furthermore, the positive electrode active material 100 preferably contains halogen such as fluorine or chlorine as the additive element X.

The crystal structure with x of 1 (discharged state) in FIG. 12 is R-3m (O3), which is the same as that in FIG. 14. Meanwhile, the positive electrode active material 100 of one embodiment of the present invention with a charge depth in a sufficiently charged state includes a crystal whose structure is different from the H1-3 type crystal structure. This structure belongs to the space group R-3m and is a structure in which an ion of cobalt, magnesium, or the like occupies a site coordinated to six oxygen atoms. Furthermore, the symmetry of CoO₂ layers of this structure is the same as that in an O3 type crystal structure. This structure is thus referred to as the O3′ type crystal structure in this specification and the like. Note that although the indication of lithium is omitted in the diagram of the O3′ type crystal structure illustrated in FIG. 12 to explain the symmetry of cobalt atoms and the symmetry of oxygen atoms, a lithium of 20 atomic % or less, for example, with respect to cobalt practically exists between the CoO₂ layers.

Note that in the O3′ type crystal structure, a light element such as lithium sometimes occupies a site coordinated to four oxygen atoms.

The O3′ type crystal structure can be regarded as a crystal structure that contains lithium between layers randomly and is similar to a CdCl₂ crystal structure. The crystal structure similar to the CdCl₂ crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

In the positive electrode active material 100 of one embodiment of the present invention, a change in the crystal structure caused when a large amount of lithium is extracted by charging with high voltage is smaller than that in a conventional positive electrode active material. As indicated by dotted lines in FIG. 12, for example, CoO₂ layers hardly shift between the crystal structures.

Specifically, the crystal structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of a lithium metal, there is a region within which the O3′ type crystal structure can be obtained.

Thus, in the positive electrode active material 100 of one embodiment of the present invention, the crystal structure is unlikely to be broken even when high-voltage charging and discharging are repeated.

In addition, in the positive electrode active material 100, a difference in the volume per unit cell between the O3 type crystal structure with x of 1 and the O3′ type crystal structure with x of 0.2 is less than or equal to 2.5%, specifically, less than or equal to 2.2%.

Note that in the unit cell of the O3′ type crystal structure, the coordinates of cobalt and oxygen can be represented by Co (0, 0, 0.5) and O (0, 0, x) within the range of 0.20≤x≤0.25.

A slight amount of the additive element X such as magnesium randomly existing between the CoO₂ layers, i.e., in lithium sites, can inhibit a shift in the CoO₂ layers. Thus, magnesium between the CoO₂ layers makes it easier to obtain the O3′ type crystal structure. Therefore, magnesium is distributed in at least part of the surface portion of the positive electrode active material 100 of one embodiment of the present invention, preferably distributed throughout the surface portion of the positive electrode active material 100. To distribute magnesium throughout the surface portion of the positive electrode active material 100, heat treatment is preferably performed in the formation process of the positive electrode active material 100 of one embodiment of the present invention.

However, cation mixing occurs when the heat treatment temperature is excessively high, so that the additive element X, e.g., magnesium, is highly likely to enter the cobalt sites. Magnesium existing in the cobalt sites does not have the effect of maintaining the R-3m structure in a high-voltage charged state. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium throughout the surface portion of the positive electrode active material 100. The addition of the halogen compound decreases the melting point of lithium cobalt oxide. The decreased melting point makes it easier to distribute magnesium throughout the surface portion of the positive electrode active material 100 at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably larger than or equal to 0.001 times and less than or equal to 0.1 times, further preferably larger than 0.01 times and less than 0.04 times, still further preferably approximately 0.02 times the number of transition metal atoms such as cobalt atoms. The magnesium concentration described here may be a value obtained by element analysis on the whole of the positive electrode active material using ICP-MS or the like, or may be a value based on the ratio of the raw materials mixed in the process of forming the positive electrode active material 100, for example.

As a metal other than cobalt (hereinafter, the additive element X), one or more metals selected from nickel, aluminum, manganese, titanium, vanadium, and chromium may be added to lithium cobalt oxide, for example, and in particular, at least one of nickel and aluminum is preferably added. In some cases, manganese, titanium, vanadium, and chromium are stable when having a valence of four, and thus highly contribute to structure stability. The addition of the additive element X may enable the crystal structure to be more stable in a high-voltage charged state. The addition of the additive element X may enable the crystal structure to be more stable in a high-voltage charged state. Here, in the positive electrode active material of one embodiment of the present invention, the additive element X is preferably added at a concentration that does not greatly change the crystallinity of the lithium cobalt oxide. For example, the additive element is preferably added at an amount with which the aforementioned Jahn-Teller effect is not exhibited.

Aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the capacity of the positive electrode active material decreases in some cases. As an example, one possible reason is that the amount of lithium that contributes to charging and discharging decreases when magnesium enters the lithium sites. When the positive electrode active material of one embodiment of the present invention contains nickel as the additive element X in addition to magnesium, the charge and discharge cycle performance can be improved in some cases. When the positive electrode active material of one embodiment of the present invention contains aluminum as the additive element X in addition to magnesium, the charge and discharge cycle performance can be improved in some cases. When the positive electrode active material of one embodiment of the present invention contains magnesium, nickel, and aluminum as the additive element X, the charge and discharge cycle performance can be improved in some cases.

The concentrations of the elements of the positive electrode active material containing magnesium, nickel, and aluminum as the additive element X are described below.

The number of nickel atoms in the positive electrode active material of one embodiment of the present invention is preferably less than or equal to 10%, further preferably less than or equal to 7.5%, and still further preferably greater than or equal to 0.05% and less than or equal to 4%, and especially preferably greater than or equal to 0.1% and less than or equal to 2% of the number of cobalt atoms. The nickel concentration described here may be a value obtained by element analysis on the whole of the positive electrode active material using ICP-MS or the like, or may be a value based on the ratio of the raw materials mixed in the process of forming the positive electrode active material, for example.

When a state being charged with high voltage is held for a long time, the constitution element of the positive electrode active material dissolves in an electrolyte solution, and the crystal structure might be broken. However, when nickel is included at the above-described proportion, dissolution of the constitution element from the positive electrode active material 100 can be inhibited in some cases.

The number of aluminum atoms in the positive electrode active material of one embodiment of the present invention is preferably greater than or equal to 0.05% and less than or equal to 4%, and further preferably greater than or equal to 0.1% and less than or equal to 2% of the number of cobalt atoms. The aluminum concentration described here may be a value obtained by element analysis on the whole of the positive electrode active material using ICP-MS or the like, or may be a value based on the ratio of the raw materials mixed in the process of forming the positive electrode active material, for example.

It is preferable that the positive electrode active material containing the additive element X of one embodiment of the present invention use phosphorus as the additive element X. The positive electrode active material of one embodiment of the present invention further preferably contains a compound containing phosphorus and oxygen.

When the positive electrode active material of one embodiment of the present invention contains a compound containing phosphorus as the additive element X, a short circuit is unlikely to occur in some cases while a high-temperature and high-voltage charged state is maintained.

When the positive electrode active material of one embodiment of the present invention contains phosphorus as the additive element X, phosphorus may react with hydrogen fluoride generated by the decomposition of the electrolyte solution, which might decrease the hydrogen fluoride concentration in the electrolyte solution.

In the case where the electrolyte solution contains LiPF₆ as a lithium salt, hydrogen fluoride might be generated by hydrolysis. In some cases, hydrogen fluoride is generated by the reaction of PVDF used as a component of the positive electrode and alkali. The decrease in hydrogen fluoride concentration in the electrolyte solution can inhibit corrosion of a current collector and/or separation of a coating film in some cases. Furthermore, the decrease in hydrogen fluoride concentration in the electrolyte solution can inhibit a reduction in adhesion properties due to gelling and/or insolubilization of PVDF in some cases.

When containing phosphorus and magnesium as the additive element X, the positive electrode active material 100 of one embodiment of the present invention is extremely stable in a high-voltage charged state. When phosphorus and magnesium are contained as the additive element X, the number of phosphorus atoms is preferably greater than or equal to 1% and less than or equal to 20%, further preferably greater than or equal to 2% and less than or equal to 10%, and still further preferably greater than or equal to 3% and less than or equal to 8% of the number of cobalt atoms. In addition, the number of magnesium atoms is preferably greater than or equal to 0.1% and less than or equal to 10%, further preferably greater than or equal to 0.5% and less than or equal to 5%, and still further preferably greater than or equal to 0.7% and less than or equal to 4% of the number of cobalt atoms. The phosphorus concentration and the magnesium concentration described here may each be a value obtained by element analysis on the whole of the positive electrode active material 100 using ICP-MS or the like, or may be a value based on the ratio of the raw materials mixed in the process of forming the positive electrode active material 100, for example.

In the case where the positive electrode active material 100 has a crack, phosphorus, more specifically, a compound containing phosphorus and oxygen, in the inner portion of the positive electrode active material with the crack may inhibit crack development, for example.

In FIG. 12, the symmetry of the oxygen atoms slightly differs between the 03 type crystal structure and the O3′ type crystal structure. Specifically, the oxygen atoms in the O₃ type crystal structure are aligned with the dotted line, whereas strict alignment of the oxygen atoms is not observed in the O3′ type crystal structure. This is caused by an increase in the amount of tetravalent cobalt along with a decrease in the amount of lithium in the O3′ type crystal structure, resulting in an increase in the Jahn-Teller distortion. Consequently, the octahedral structure of CoO₆ is distorted. In addition, repelling of oxygen atoms in the CoO₂ layer becomes stronger along with a decrease in the amount of lithium, which also affects the difference in symmetry of oxygen atoms.

<Surface Portion 100a>

It is preferable that magnesium be distributed throughout the surface portion of the positive electrode active material 100 of one embodiment of the present invention, and it is further preferable that the magnesium concentration in the surface portion 100a be higher than the average magnesium concentration in the whole. For example, the magnesium concentration in the surface portion 100a measured by XPS or the like is preferably higher than the average magnesium concentration in the whole measured by ICP-MS or the like

In the case where the positive electrode active material 100 of one embodiment of the present invention contains an element other than cobalt, for example, one or more metals selected from nickel, aluminum, manganese, iron, and chromium, the concentration of the metal in the vicinity of the surface of the particle is preferably higher than the average concentration in the whole. For example, the concentration of the element other than cobalt in the surface portion 100a measured by XPS or the like is preferably higher than the average concentration of the element in the whole measured by ICP-MS or the like.

The surface portion of the positive electrode active material 100 is a kind of crystal defects and lithium is extracted from the surface during charge; thus, the lithium concentration in the surface portion tends to be lower than that in the inner portion. Therefore, the surface tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The concentration of halogen such as fluorine in the surface portion 100a of the positive electrode active material 100 of one embodiment of the present invention is preferably higher than the average concentration in the whole. When halogen exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the additive elements such as magnesium and fluorine are preferably higher than those in the inner portion. The surface portion 100a having such a composition preferably has a crystal structure stable at room temperature. Accordingly, the surface portion 100a may have a crystal structure different from that of the inner portion 100b. For example, at least part of the surface portion 100a of the positive electrode active material 100 of one embodiment of the present invention may have the rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ type crystal are presumed to form a cubic close-packed structure. Note that in this specification and the like, a structure where A layer, B layer, and C layer having anions are shifted and stacked like “ABCABC” is referred to as a cubic close-packed structure. Accordingly, anions do not necessarily form a cubic lattice structure. At the same time, actual crystals always have a defect and thus, analysis results are not necessarily consistent with the theory. For example, in electron diffraction or FFT (fast Fourier transform) of a TEM image or the like, a spot may appear in a position slightly different from a theoretical position. For example, anions may be regarded as forming a cubic close-packed structure when a difference in orientation from a theoretical position is 5° or less or 2.5° or less.

When a layered rock-salt crystal and a rock-salt crystal are in contact with each other, there is a crystal plane at which orientations of cubic close-packed structures composed of anions are aligned with each other.

The description can also be made as follows. Anions on the (111) plane of a cubic crystal structure has a triangular arrangement. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangular lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a TEM (transmission electron microscope) image, a STEM (scanning transmission electron microscope) image, a HAADF-STEM (high-angle annular dark-field scanning TEM) image, an ABF-STEM (annular bright-field scanning transmission electron microscope) image, electron diffraction, and FFT of a TEM image or the like. X-ray diffraction (XRD), electron diffraction, neutron diffraction, and the like can also be used for judging.

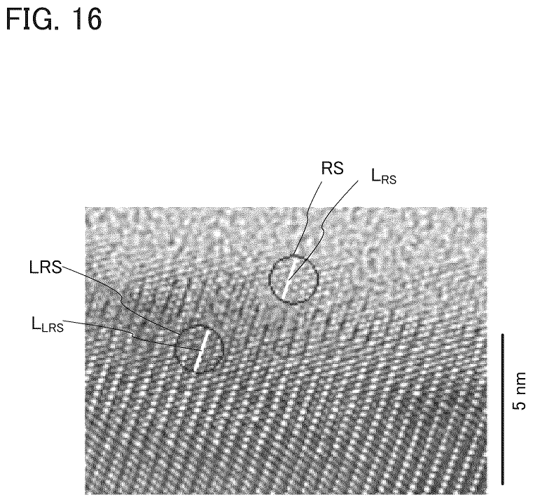

FIG. 16 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a composite hexagonal lattice of a layered rock-salt structure, for example, a contrast derived from the (0003) plane is obtained as repetition of bright lines and dark lines because of diffraction and interference of the electron beam. Thus, when repetition of bright lines and dark lines is observed and the angle between the bright lines (e.g., L_{RS} and L_{LRS} in FIG. 16) is 5 degrees or less or 2.5 degrees or less in the TEM image, it can be judged that the crystal planes are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having the layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5 degrees or less or 2.5 degrees or less in a HAADF-STEM image, it can be judged that arrangements of the atoms are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

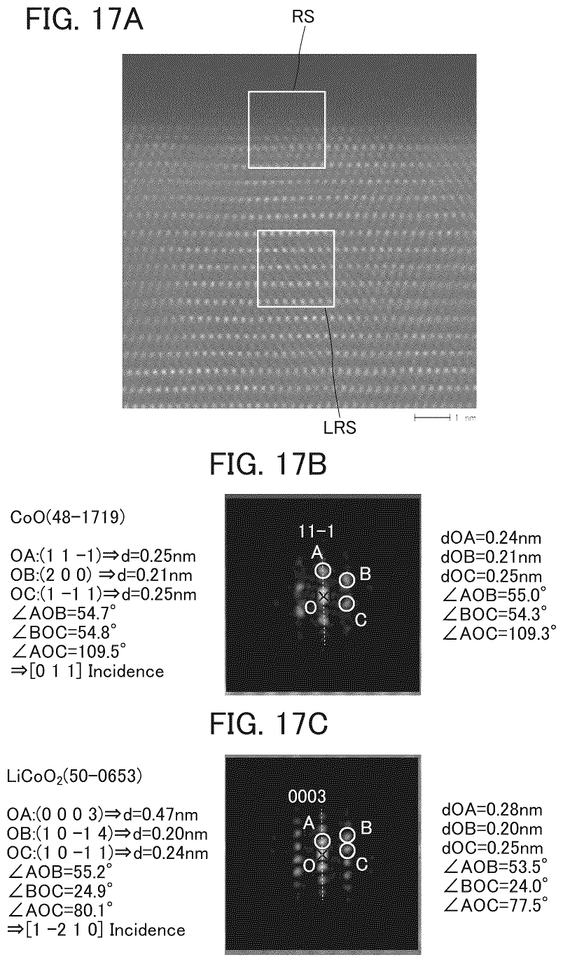

FIG. 17A shows an example of a STEM image in which orientations of the layered rock-salt crystal LRS and the rock-salt crystal RS are substantially aligned with each other. FIG. 17B shows FFT of a region of the rock-salt crystal RS, and FIG. 17C shows FFT of a region of the layered rock-salt crystal LRS. In FIG. 17B and FIG. 17C, the literature values are shown on the left, and the measured values are shown on the right. A spot denoted by O is zero-order diffraction.

A spot denoted by A in FIG. 17B is derived from 11-1 reflection of a cubic structure. A spot denoted by A in FIG. 17C is derived from 0003 reflection of a layered rock-salt structure. Here, it is found that a straight line that passes through AO in FIG. 17B is substantially parallel to a straight line that passes through AO in FIG. 17C. That is, FIG. 17B and FIG. 17C shows that the direction of the 11-1 reflection of the cubic structure and the direction of the 0003 reflection of the layered rock-salt structure are substantially aligned with each other. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in FFT and electron diffraction, the <0003> orientation of the layered rock-salt crystal or a plane orientation equivalent thereto and the <11-1> orientation of the rock-salt crystal or a plane orientation equivalent thereto are substantially aligned with each other in some cases. In that case, it is preferred that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 17C is derived from 1014 reflection of the layered rock-salt structure. This is sometimes observed at a position where the difference in orientation from the reciprocal lattice point derived from the 0003 reflection of the layered rock-salt structure (A in FIG. 17C) is greater than or equal to 52° and less than or equal to 56° (i.e., ∠AOB is 52° to) 56° and d is greater than or equal to 0.19 nm and less than or equal to 0.21 nm. Note that these indices are just examples, and the spot does not necessarily correspond with them. For example, the spot may be a reciprocal lattice point equivalent to 0003 and 1014.

Similarly, a spot that is not derived from the 11-1 of the cubic structure may be observed on a reciprocal lattice space different from the direction where the 11-1 of the cubic structure is observed. For example, a spot denoted by B in FIG. 17B is derived from 200 reflection of the cubic structure. The spot derived from 200 reflection of the cubic structure is sometimes observed at a position where the difference in orientation from the reciprocal lattice point derived from the 11-1 reflection of the cubic structure (A in FIG. 17B) is greater than or equal to 54° and less than or equal to 56° (i.e., ∠AOB is 54° to) 56°. Note that these indices are just examples, and the spot does not necessarily correspond with them. For example, the spot may be a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin using FIB or the like such that an electron beam of a TEM, for example, enters in [1-210], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The additive element X is preferably positioned in the surface portion 100a of the particle of the positive electrode active material 100 of one embodiment of the present invention. For example, the positive electrode active material 100 of one embodiment of the present invention may be covered with the coating film containing the additive element X.

### <Grain Boundary>

The additive element X included in the positive electrode active material 100 of one embodiment of the present invention may randomly exist in the inner portion at a slight concentration, but part of the additive element is preferably segregated in a grain boundary.

In other words, the concentration of the additive element X in the crystal grain boundary and its vicinity of the positive electrode active material 100 of one embodiment of the present invention is preferably higher than that in the other regions in the inner portion.

The crystal grain boundary can be regarded as a plane defect. Thus, the crystal grain boundary tends to be unstable and the crystal structure easily starts to change like the surface of the particle. Therefore, when the concentration of the added element X in the crystal grain boundary and its vicinity is higher, the change in the crystal structure can be inhibited more effectively.

In the case where the concentration of the additive element X is high in the crystal grain boundary and its vicinity, even when a crack is generated along the crystal grain boundary of the particle of the positive electrode active material 100 of one embodiment of the present invention, the concentration of the additive element X is increased in the vicinity of the surface generated by the crack. Thus, the positive electrode active material can have an increased corrosion resistance to hydrofluoric acid even after a crack is generated.

Note that in this specification and the like, the vicinity of the crystal grain boundary refers to a region within approximately 10 nm from the grain boundary.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material is the positive electrode active material 100 of one embodiment of the present invention that has an O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 100 of one embodiment of the present invention features in a small change in the crystal structure between a high-voltage charged state and a discharged state. A material 50 wt % or more of which has the crystal structure that largely changes between a high-voltage charged state and a discharged state is not preferable because the material cannot withstand high-voltage charging and discharging. In addition, it should be noted that an objective crystal structure is not obtained in some cases only by addition of additive elements. For example, although the positive electrode active material that is lithium cobalt oxide containing magnesium and fluorine is a commonality, the positive electrode active material has the O3′ type crystal structure at 60 wt % or more in some cases, and has the H1-3 type crystal structure at 50 wt % or more in other cases, when charged at a high voltage. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <Charge Method>

High-voltage charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated with the above conditions is charged with constant current at 4.6 V and 0.5 C and then charged with constant voltage until the current value reaches 0.01 C. Note that here, 1 C is set to 137 mA/g. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode active material enclosed in an airtight container with an argon atmosphere.

### <XRD>

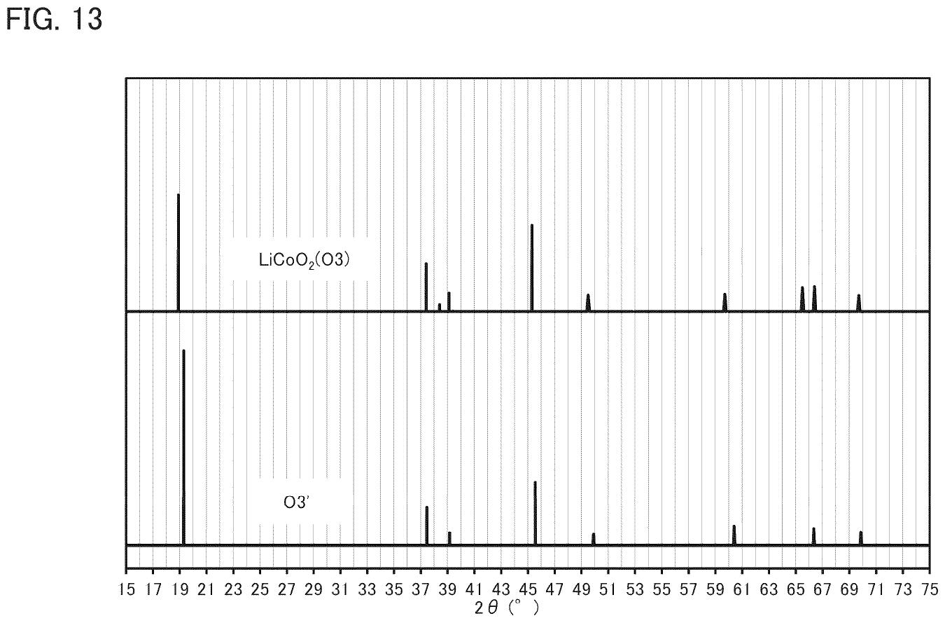

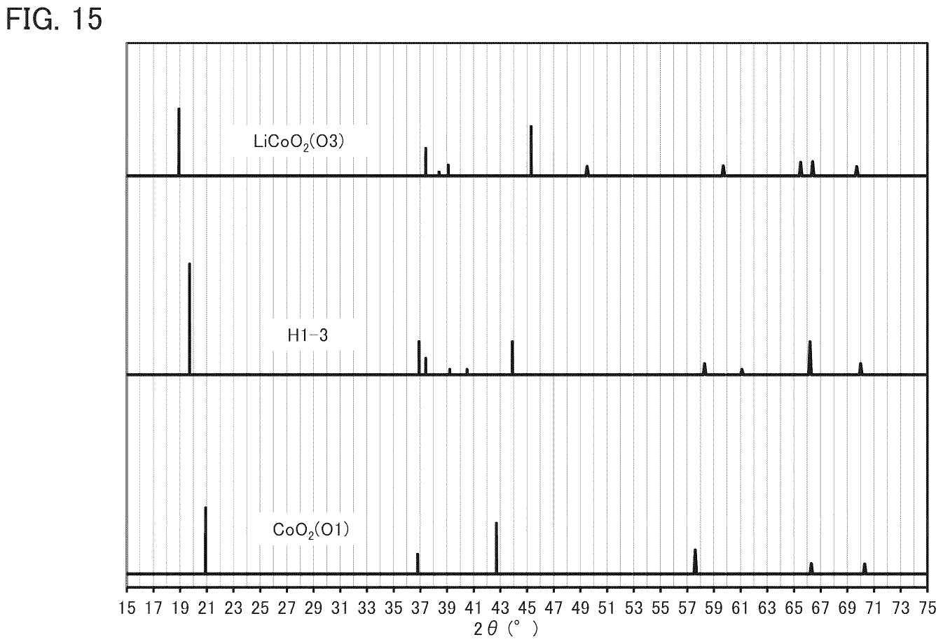

FIG. 13 and FIG. 15 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with x of 1 and the crystal structure of CoO₂ (O1) with x of 0 are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The range of 20 was from 15° to 75°, the step size was 0.01, the wavelength λ1 was 1.540562×10⁻¹⁰ m, the wavelength λ2 was not set, and a single monochromator was used. The pattern of the O3′ type crystal structure was estimated from the XRD pattern of the positive electrode active material of one embodiment of the present invention, the crystal structure was fitted with TOPAS ver. 3 (crystal structure analysis software manufactured by Bruker Corporation), and XRD patterns were made in a manner similar to those of other structures.

As shown in FIG. 13, the O3′ type crystal structure exhibits diffraction peaks at 2θ of 19.30±0.20° (greater than or equal to 19.10° and less than or equal to) 19.50° and 2θ of 45.55±0.10° (greater than or equal to 45.45° and less than or equal to) 45.65°. More specifically, sharp diffraction peaks appear at 2θ of 19.30±0.10° (greater than or equal to 19.20° and less than or equal to) 19.40° and 2θ of 45.55±0.05° (greater than or equal to 45.50° and less than or equal to) 45.60°. By contrast, as shown in FIG. 15, the H1-3 type crystal structure and CoO₂ (P-3m1, O1) do not exhibit peaks at these positions. Thus, the peaks at 2θ of 19.30±0.20° and 2θ of 45.55±0.10° in a high-voltage charged state can be the features of the positive electrode active material 100 of one embodiment of the present invention.

It can be said that the positions of the XRD diffraction peaks exhibited by the crystal structure with x of 1 are close to those of the XRD diffraction peaks exhibited by the crystal structure in a high-voltage charged state. More specifically, it can be said that a difference in the positions of two or more, preferably three or more of the main diffraction peaks between the crystal structures is 2θ=0.7 or less, preferably 2θ=0.5 or less.

Although the positive electrode active material 100 of one embodiment of the present invention has the O3′ type crystal structure when charged with high voltage, the entire crystal structure of the positive electrode active material 100 is not necessarily the O3′ type crystal structure. The positive electrode active material 100 may have another crystal structure or be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charging and discharging after the measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material particle is only decreased to approximately one-tenth that of LiCoO₂ (O3) in a discharged state. Thus, a clear peak of the O3′ type crystal structure can be observed in a high-voltage charged state, even under the same XRD measurement conditions as those of a positive electrode before the charging and discharging. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described additive element X in addition to cobalt as long as the influence of the Jahn-Teller effect is small.

Preferable ranges of the lattice constants of the positive electrode active material of one embodiment of the present invention are examined. In the layered rock-salt crystal structure of the particle of the positive electrode active material in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be the state of a powder before the formation of a positive electrode of a secondary battery.

Alternatively, in the layered rock-salt crystal structure of the particle of the positive electrode active material in the discharged state or the state where charging and discharging are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charging and discharging are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a or the like can be analyzed by electron diffraction of a cross section of the positive electrode active material 100, for example.

### <XPS>

A region that is approximately 2 to 8 nm (normally, approximately 5 nm) in depth from a surface can be analyzed by X-ray photoelectron spectroscopy (XPS); thus, the concentration of each element in approximately half of the surface portion 100a can be quantitatively analyzed. The bonding states of the elements can be analyzed by narrow scanning. Note that the quantitative accuracy of XPS is approximately ±1 atomic % in many cases, and the lower detection limit is approximately 1 atomic % but depends on the element.

In the XPS analysis, monochromatic aluminum can be used as an X-ray source, for example. An extraction angle is, for example, 45°.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from both the bonding energy of lithium fluoride, which is 685 eV, and the bonding energy of magnesium fluoride, which is 686 eV. That is, in the case where the positive electrode active material 100 of one embodiment of the present invention contains fluorine, the fluorine is preferably in a bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride, which is 1305 eV, and close to the bonding energy of magnesium oxide. That is, in the case where the positive electrode active material 100 of one embodiment of the present invention contains magnesium, the magnesium is preferably in a bonding state other than magnesium fluoride.

The concentration of the additive element X that preferably exists in the surface portion 100a in a large amount, such as magnesium or aluminum, measured by XPS or the like is preferably higher than the concentration measured by ICP-MS (inductively coupled plasma mass spectrometry), GD-MS (glow discharge mass spectrometry), or the like.

When a cross section is exposed by processing and analyzed by TEM-EDX, the concentrations of magnesium and aluminum in the surface portion 100a are preferably higher than that in the inner portion 100b. An FIB can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals, not be unevenly distributed in the surface portion 100a but be distributed in the entire positive electrode active material 100. Note that one embodiment of the present invention is not limited thereto in the case where the above-described region where the excess additive element X is unevenly distributed exists.

### <Surface Roughness and Specific Surface Area>

The positive electrode active material 100 of one embodiment of the present invention preferably has a smooth surface with little unevenness. A smooth surface with little unevenness indicates favorable distribution of the additive element X in the surface portion 100a. For the positive electrode active material 100, it is particularly preferable to perform initial heating on lithium cobalt oxide or lithium nickel-cobalt-manganese oxide before the addition of the additive element X in the formation process of the positive electrode active material 100, in which case remarkably excellent repeated high-voltage charge and discharge performance is exhibited.

When the positive electrode active material 100 has a smooth surface with little unevenness, the surface of the positive electrode active material 100 can be more stable and generation of a pit can be inhibited.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with a magic hand tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness in at least 400 nm of the particle periphery of the positive electrode active material.

On the particle surface of the positive electrode active material 100 of this embodiment, root-mean-square (RMS) surface roughness, which is an index of roughness, is less than or equal to 10 nm, less than 3 nm, preferably less than 1 nm, further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter D50 (A_{R}/Aᵢ) is preferably greater than or equal to 1 and less than or equal to 2.

The contents in this embodiment can be freely combined with the contents in the other embodiments.

### Embodiment 4

This embodiment will describe examples of shapes of several types of secondary batteries including a positive electrode or a negative electrode formed by the fabrication method described in the foregoing embodiment.

### [Coin-Type Secondary Battery]

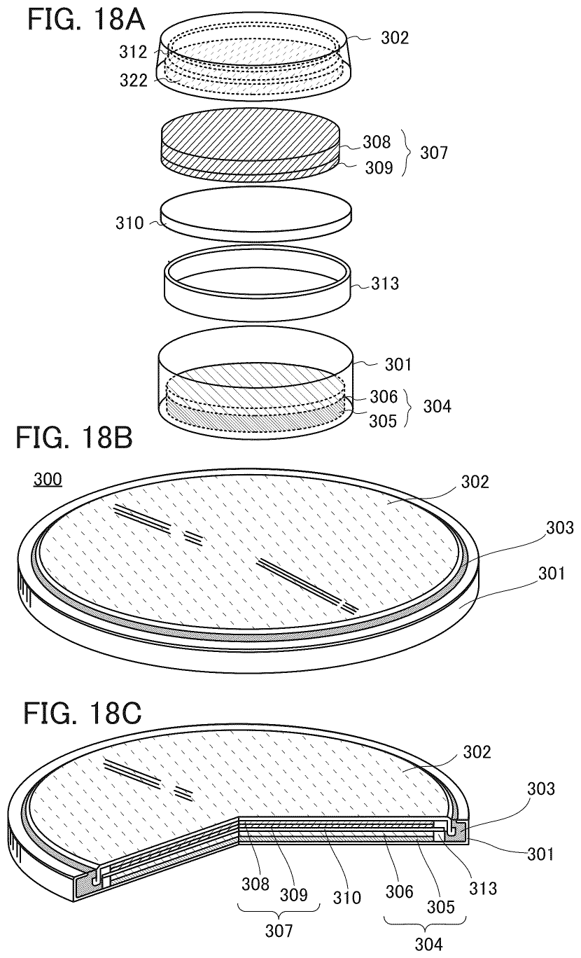

An example of a coin-type secondary battery will be described. FIG. 18A is an exploded perspective view of a coin-type (single-layer flat) secondary battery, FIG. 18B is an external view, and FIG. 18C is a cross-sectional view thereof. Coin-type secondary batteries are mainly used in small electronic devices. In this specification and the like, coin-type batteries include button-type batteries.

For easy understanding, FIG. 18A is a schematic view illustrating overlap (a vertical relation and a positional relation) between components. Thus, FIG. 18A and FIG. 18B do not completely correspond with each other.

In FIG. 18A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 18A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 18B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 18C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above structure, the coin-type secondary battery 300 can have high capacity, high charge and discharge capacity, and excellent cycle performance. Note that in the case where a secondary battery including a solid electrolyte layer is provided between provided between the negative electrode 307 and the positive electrode 304, the separator 310 can be unnecessary.

### [Cylindrical Secondary Battery]

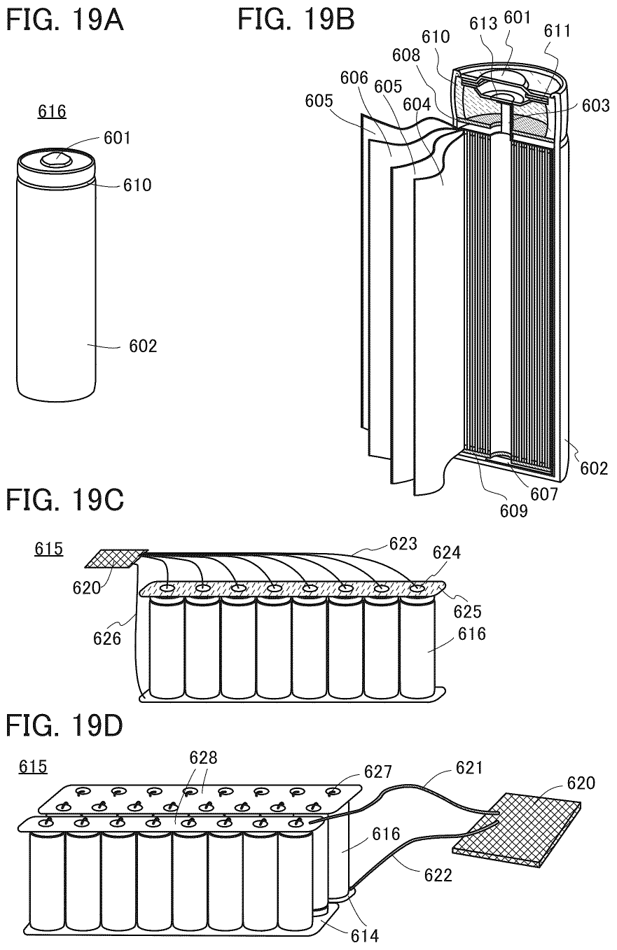

Next, an example of a cylindrical secondary battery is described with reference to FIG. 19A and FIG. 19B. FIG. 19B schematically illustrates a cross section of a cylindrical secondary battery. As illustrated in FIG. 19A and FIG. 19B, a cylindrical secondary battery 616 includes a positive electrode cap (battery cap) 601 on the top surface and a battery can (outer can) 602 on the side surface and the bottom surface. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. Although FIG. 19A to FIG. 19D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The negative electrode 570a obtained in the foregoing embodiment is used as the negative electrode 606, whereby the cylindrical secondary battery 616 can have high capacity, high charge and discharge capacity, and excellent cycle performance. The positive electrode active material composite 100z obtained in the foregoing embodiment is used in the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 19C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge or the like can be used, for example.

FIG. 19D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 19D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

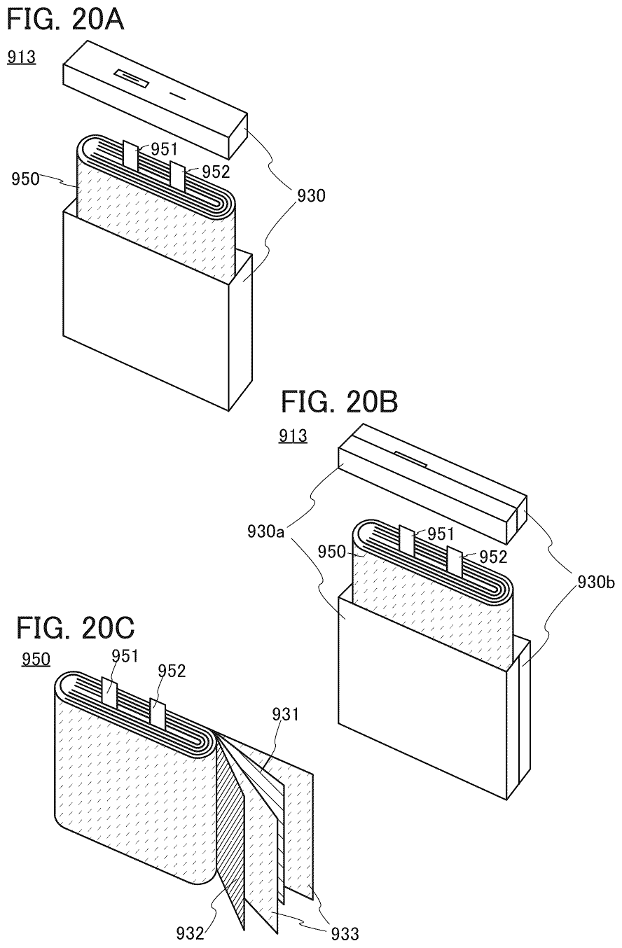

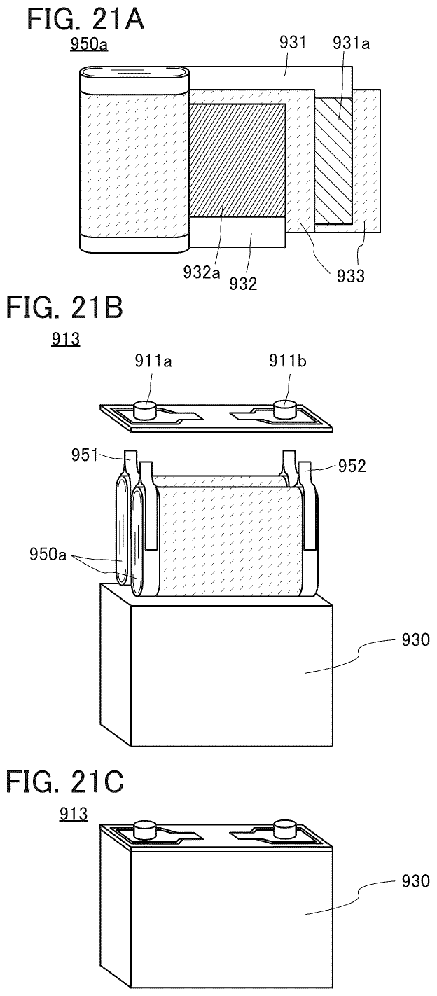

Structure examples of secondary batteries are described with reference to FIG. 20 and FIG. 21.

A secondary battery 913 illustrated in FIG. 20A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 20A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 20B, the housing 930 illustrated in FIG. 20A may be formed using a plurality of materials. For example, in the secondary battery 913 in FIG. 20B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 20C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIG. 21A to FIG. 21C, the secondary battery 913 may include a wound body 950a. The wound body 950a illustrated in FIG. 21A includes the negative electrode 931, the positive electrode 932, and the separators 933. The negative electrode 931 includes a negative electrode active material layer 931a. The positive electrode 932 includes a positive electrode active material layer 932a.

The negative electrode 570a obtained in the foregoing embodiment is used as the negative electrode 606, whereby the cylindrical secondary battery 616 can have high capacity, high charge and discharge capacity, and excellent cycle performance. The positive electrode active material composite 100z obtained in the foregoing embodiment is used in the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 21B, the negative electrode is electrically connected to the terminal 951. The terminal 951 is electrically connected to a terminal 911a. The positive electrode is electrically connected to the terminal 952. The terminal 952 is electrically connected to a terminal 911b.

As illustrated in FIG. 21C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 21B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 20A to FIG. 20C can be referred to for the other components of the secondary battery 913 illustrated in FIG. 21A and FIG. 21B.

### <Laminated Secondary Battery>

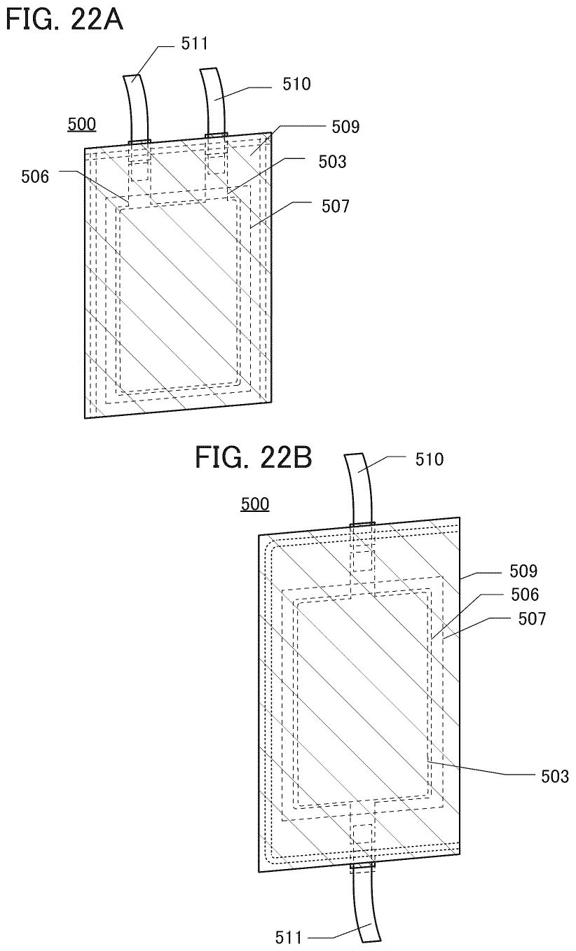

Next, examples of the appearance of a laminated secondary battery are illustrated in FIG. 22A and FIG. 22B. FIG. 22A and FIG. 22B each illustrate a positive electrode 503, a negative electrode 506, a separator 507, an exterior body 509, a positive electrode lead electrode 510, and a negative electrode lead electrode 511.

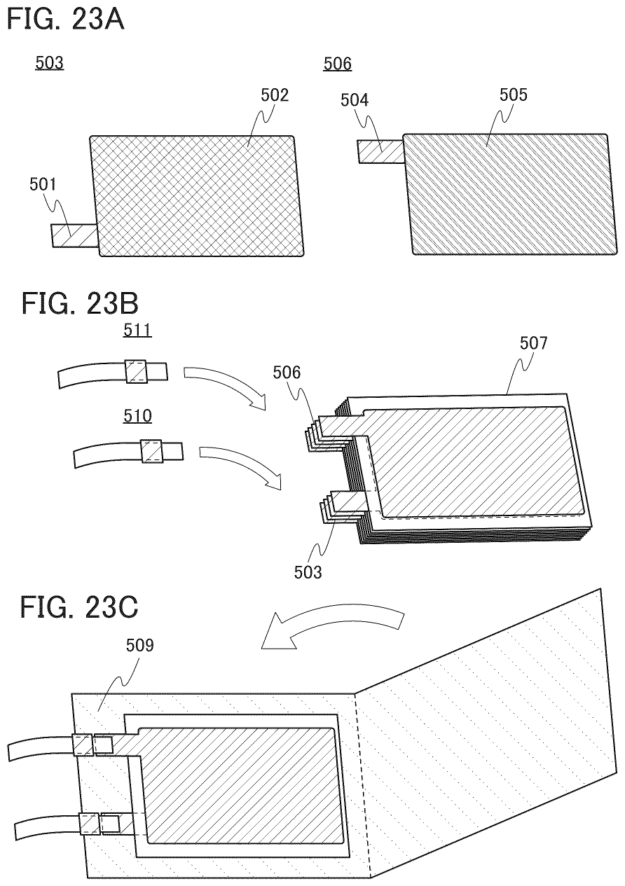

FIG. 23A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 23A.

### <Method for Fabricating Laminated Secondary Battery>

Here, an example of a method for fabricating the laminated secondary battery having the appearance illustrated in FIG. 22A will be described with reference to FIG. 23B and FIG. 23C.

First, the negative electrode 506, the separator 507, and the positive electrode 503 are stacked. FIG. 23B illustrates the negative electrodes 506, the separators 507, and the positive electrodes 503 that are stacked. Here, an example in which 5 negative electrodes and 4 positive electrodes are used is illustrated. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 23C. Then, the outer edges of the exterior body 509 are bonded to each other. The bonding can be performed by thermocompression, for example. At this time, a part (or one side) of the exterior body 509 is left unbonded (such part is hereinafter referred to as an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The negative electrode 570a obtained in the foregoing embodiment is used as the negative electrode 606, whereby the cylindrical secondary battery 616 can have high capacity, high charge and discharge capacity, and excellent cycle performance. The positive electrode active material composite 100z obtained in the foregoing embodiment is used in the positive electrode 503, whereby the secondary battery 500 can have high capacity, high charge and discharge capacity, and excellent cycle performance.

### [Examples of Battery Pack]

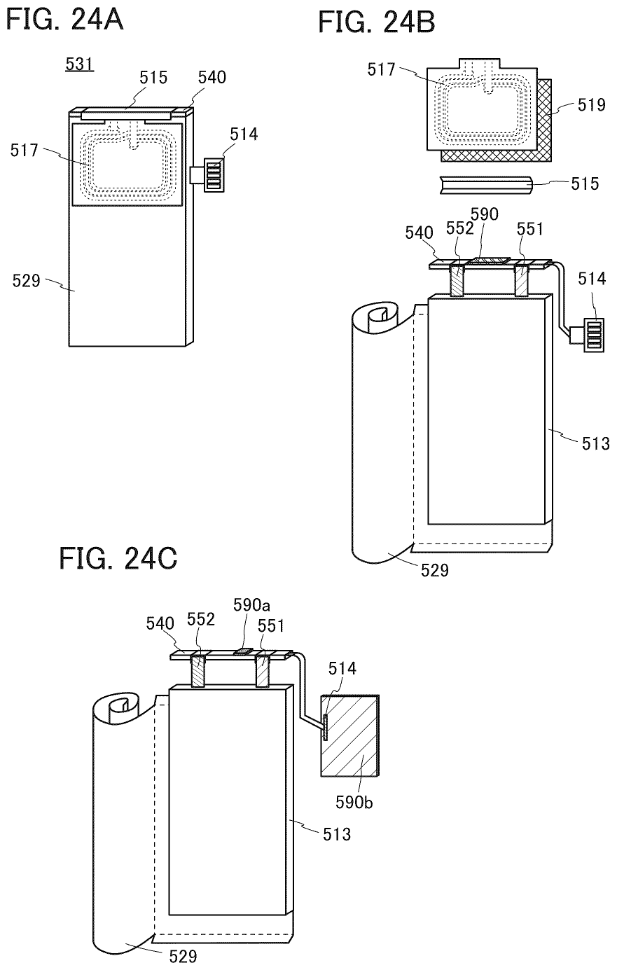

Examples of a secondary battery pack of one embodiment of the present invention that is capable of wireless charging using an antenna are described with reference to FIG. 24A to FIG. 24C.

FIG. 24A illustrates the appearance of a secondary battery pack 531 that has a rectangular solid shape with a small thickness (also referred to as a flat plate shape with a certain thickness).

FIG. 24B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 24B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 24C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with the contents in the other embodiments.

### Embodiment 5

This embodiment will describe an example in which an all-solid-state battery is fabricated using the positive electrode active material composite 100z obtained in the foregoing embodiment.

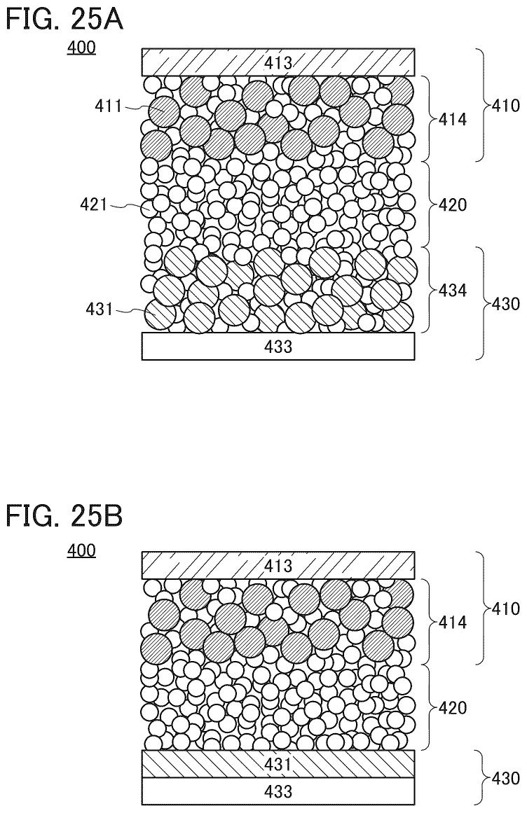

As illustrated in FIG. 25A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material composite 100z obtained in the foregoing embodiment is used for the positive electrode active material 411. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used as the negative electrode active material 431, metal lithium does not need to be processed into particles; thus, the negative electrode 430 that does not include the solid electrolyte 421 can be formed, as illustrated in FIG. 25B. The use of metal lithium for the negative electrode 430 is preferable because the energy density of the secondary battery 400 can be increased. As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S_{3.44}LiI, 63Li₂S·36SiS₂·1Li₃PO₄, 57Li₂S·38SiS₂·5Li₄SiO₄, and 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-Y}Al_{Y}Ti_{2-Y} (PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₋ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can employ a variety of materials and have a variety of shapes, and preferably has a function of applying pressure to the positive electrode, the solid electrolyte layer, and the negative electrode.

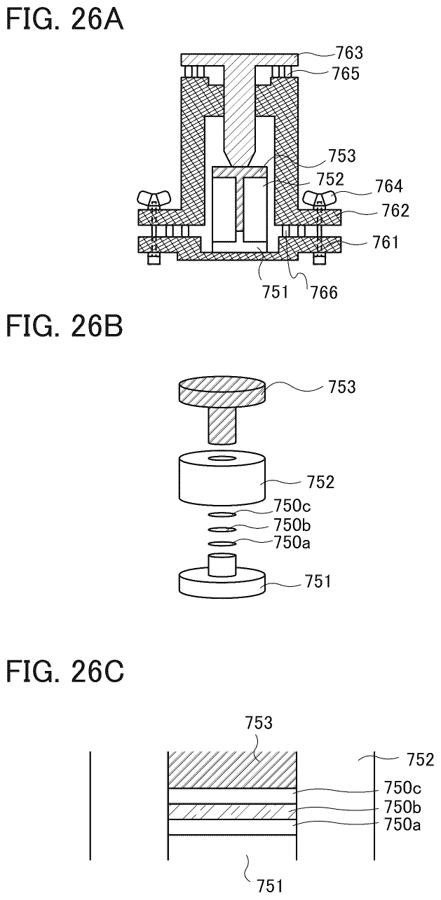

FIG. 26 illustrates an example of a cell for evaluating materials of an all-solid-state battery.

FIG. 26A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 26B is an enlarged perspective view of the evaluation material and its vicinity.

A stack of a positive electrode 750a, a solid electrolyte layer 750b, and a negative electrode 750c is illustrated as an example of the evaluation material, and its cross section is illustrated in FIG. 26C. Note that the same portions in FIG. 26A to FIG. 26C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

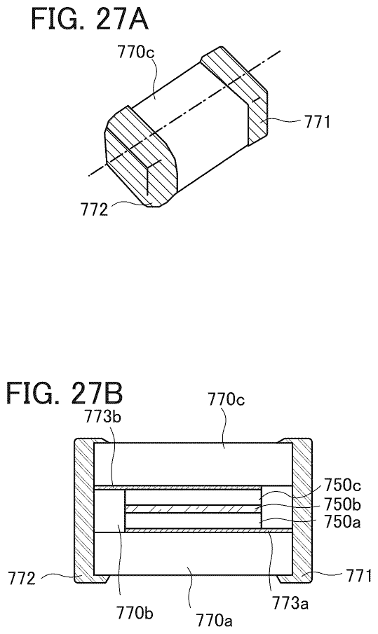

FIG. 27A is a perspective view of a secondary battery of one embodiment of the present invention that has an exterior body and a shape different from those in FIG. 26. The secondary battery in FIG. 27A includes external electrodes 771 and 772 and is sealed with an exterior body including a plurality of package components.

FIG. 27B illustrates an example of a cross section along the dashed-dotted line in FIG. 27A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material composite 100z described in the foregoing embodiment can achieve an all-solid-state secondary battery having a high energy density and favorable output characteristics.

The contents in this embodiment can be combined with the contents in the other embodiments as appropriate.

### Embodiment 6

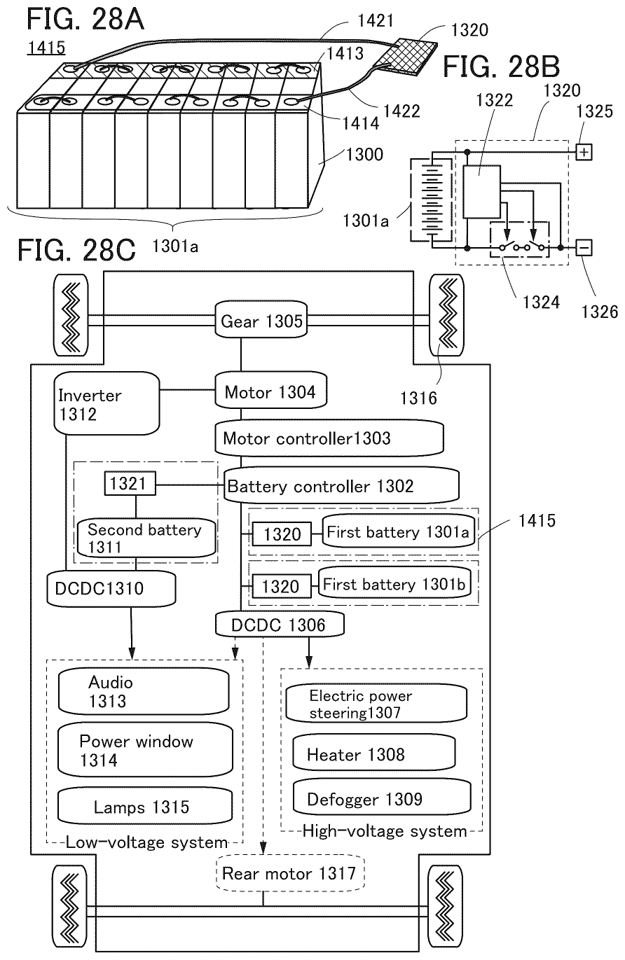

In this embodiment, an example different from the cylindrical secondary battery in FIG. 19D will be described. An example of application to an electric vehicle (EV) will be described with reference to FIG. 28C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 20A or FIG. 21C or the stacked structure illustrated in FIG. 22A or FIG. 22B. Alternatively, the first battery 1301a may be the all-solid-state battery in Embodiment 5. Using the all-solid-state battery in Embodiment 5 as the first battery 1301a achieves high capacity, a high degree of safety, reduction in size, and reduction in weight.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DCDC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DCDC circuit 1310.

The first battery 1301a will be described with reference to FIG. 28A.

FIG. 28A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment illustrates the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement.

When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the ratios of the numbers of In, Ga, and Zn atoms to the metal elements contained in the CAC-OS in an In—Ga—Zn oxide are denoted by [In], [Ga], and [Zn], respectively. For example, the first region in the CAC-OS in the In—Ga—Zn oxide has [In] higher than [In] in the composition of the CAC-OS film. Moreover, the second region has [Ga] higher than [Ga] in the composition of the CAC-OS film. Alternatively, for example, the first region has [In] higher than [In] in the second region and [Ga] lower than [Ga] in the second region. Moreover, the second region has [Ga] higher than [Ga] in the first region and [In] lower than [In] in the first region.

Specifically, the first region is a region including indium oxide, indium zinc oxide, or the like as its main component. The second region is a region including gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, in EDX mapping obtained by energy dispersive X-ray spectroscopy (EDX), it is confirmed that the CAC-OS in the In—Ga—Zn oxide has a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (μ), and favorable switching operation can be achieved.

An oxide semiconductor has various structures with different properties. Two or more kinds among the amorphous oxide semiconductor, the polycrystalline oxide semiconductor, the a-like OS (amorphous-like Oxide Semiconductor), the CAC-OS, the nc-OS (nanocrystalline Oxide Semiconductor), and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor and thus shows a smaller change in characteristics than the single crystal Si transistor when the secondary battery is overheated. The off-state current of the transistor using an oxide semiconductor is lower than or equal to the lower measurement limit even at 150° C.; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the degree of safety. When the control circuit portion 1320 is used in combination with a secondary battery including a positive electrode using the positive electrode active material composite 100z obtained in the foregoing embodiment, the synergy on safety can be obtained.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of the secondary battery include prevention of overcharge, prevention of overcurrent, control of overheating during charge, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

A cause of a micro-short circuit is a plurality of charging and discharging; an uneven distribution of positive electrode active materials leads to local concentration of current in part of the positive electrode and the negative electrode; and then part of a separator stops functioning or a by-product is generated by a side reaction, which is thought to generate a micro short-circuit.

It can be said that the control circuit portion 1320 not only detects a micro-short circuit but also senses a terminal voltage of the secondary battery and controls the charge and discharge state of the secondary battery. For example, to prevent overcharge, the control circuit portion 1320 can turn off an output transistor of a charge circuit and an interruption switch substantially at the same time.

FIG. 28B is an example of a block diagram of the battery pack 1415 illustrated in FIG. 28A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the input current from the outside, the output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used. For example, the all-solid-state battery in Embodiment 5 may be used. Using the all-solid-state battery in Embodiment 5 as the second battery 1311 achieves high capacity, reduction in size and reduction in weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charge.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, an outlet of a charger or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 kW, for example. Furthermore, charge can be performed with electric power supplied from external charge equipment by a contactless power feeding system or the like.

For fast charge, secondary batteries that can withstand high-voltage charge have been desired to perform charge in a short time.

The above-described secondary battery in this embodiment includes the positive electrode active material composite 100z obtained in the foregoing embodiment. Moreover, even when graphene is used as a conductive material and the electrode layer is formed thick to increase the loading amount, it is possible to achieve a secondary battery with significantly improved electrical characteristics while synergy such as a reduction in capacity and the retention of high capacity can be obtained. This secondary battery is particularly effectively used in a vehicle and can achieve a vehicle that has a long range, specifically a driving range per charge of 500 km or longer, without increasing the proportion of the weight of the secondary battery to the weight of the entire vehicle.

Specifically, in the above-described secondary battery in this embodiment, the use of the positive electrode active material composite 100z described in the foregoing embodiment can increase the operating voltage of the secondary battery, and the increase in charge voltage can increase the available capacity. Moreover, using the positive electrode active material composite 100z described in the foregoing embodiment in the positive electrode can provide an automotive secondary battery having excellent charge and discharge cycle performance.

Next, examples in which the secondary battery of one embodiment of the present invention is mounted on a vehicle, typically a transport vehicle, will be described.

Mounting the secondary battery illustrated in any of FIG. 19D, FIG. 21C, and FIG. 28A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

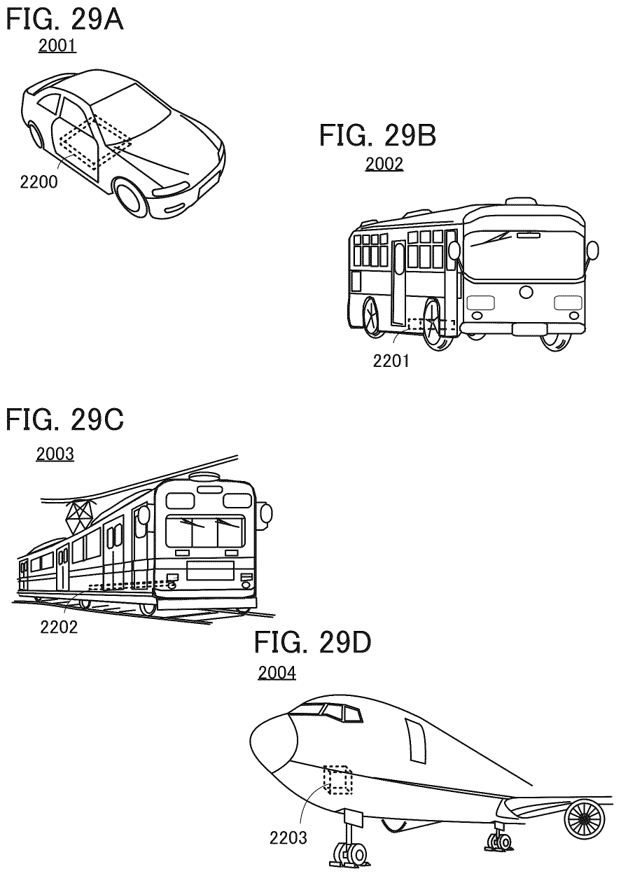

FIG. 29A to FIG. 29D illustrate examples of transport vehicles as one example of vehicles using one embodiment of the present invention. An automobile 2001 illustrated in FIG. 29A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 29A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charge equipment through a plug-in system, a contactless charge system, or the like. In charging, a given method such as CHAdeMO (registered trademark) or Combined Charging System may be employed as a charge method, the standard of a connector, and the like as appropriate. The secondary battery may be a charge station provided in a commerce facility or a household power supply. For example, a plug-in technique enables an exterior power supply to charge a power storage device incorporated in the automobile 2001. The charge can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 29B illustrates a large transporter 2002 having a motor controlled by electric power, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has a function similar to that in FIG. 29A except, for example, the number of secondary batteries forming the secondary battery module of the battery pack 2201 or the like is different; thus the description is omitted.

FIG. 29C illustrates a large transport vehicle 2003 having a motor controlled by electricity as an example. The secondary battery module of the transport vehicle 2003 has 100 or more secondary batteries with a nominal voltage of 3.0 V or higher and 5.0 V or lower connected in series, and the maximum voltage is 600 V, for example. The negative electrode 570a obtained in the foregoing embodiment is used as the negative electrode, whereby the cylindrical secondary battery 616 can have high capacity, high charge and discharge capacity, and excellent cycle performance. With the use of the positive electrode using the positive electrode active material composite 100z described in the foregoing embodiment, a secondary battery having favorable rate characteristics and charge and discharge cycle performance can be fabricated, which can contribute to higher performance and a longer life of the transport vehicle 2003. A battery pack 2202 has a function similar to that in FIG. 29A except that the number of secondary batteries forming the secondary battery module of the battery pack 2202 or the like is different; thus, the detailed description is omitted.

FIG. 29D illustrates an aircraft 2004 having a combustion engine as an example. The aircraft 2004 illustrated in FIG. 29D can be regarded as a kind of transport vehicle since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 29A except, for example, the number of secondary batteries forming the secondary battery module of the battery pack 2203; thus the detailed description is omitted.

The contents in this embodiment can be combined with the contents in the other embodiments as appropriate.

### Embodiment 7

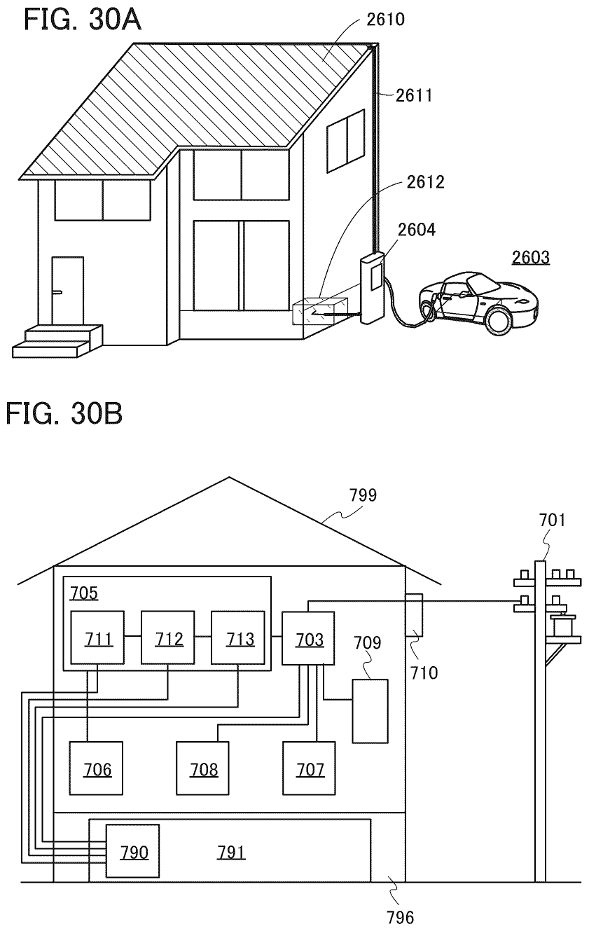

In this embodiment, examples in which the secondary battery of one embodiment of the present invention is mounted on a building will be described with reference to FIG. 30A and FIG. 30B.

A house illustrated in FIG. 30A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to a ground-based charge equipment 2604. The power storage device 2612 can be charged with electric power generated by the solar panel 2610. The secondary battery included in the vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 30B illustrates an example of a power storage device of one embodiment of the present invention. As illustrated in FIG. 30B, a power storage device 791 of one embodiment of the present invention is provided in an underfloor space 796 of a building 799. The power storage device 791 may be provided with the control circuit described in Embodiment 6. The negative electrode 570a obtained in the foregoing embodiment is used as the negative electrode, whereby the cylindrical secondary battery 616 can have high capacity, high charge and discharge capacity, and excellent cycle performance. The use of a secondary battery including a positive electrode using the positive electrode active material composite 100z obtained in the foregoing embodiment for the power storage device 791 enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 8

This embodiment will describe examples in which the power storage device of one embodiment of the present invention is mounted on a motorcycle and a bicycle.

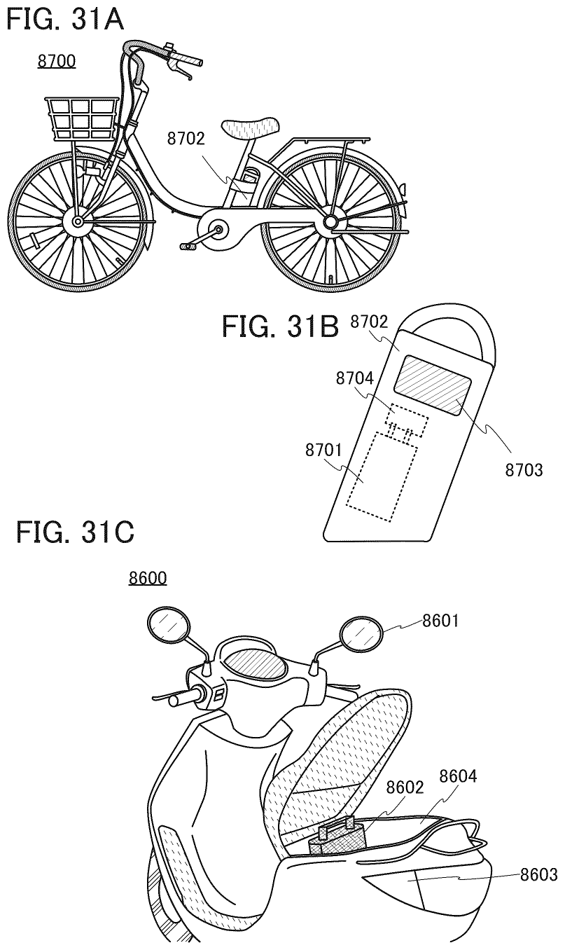

FIG. 31A illustrates an example of an electric bicycle using the power storage device of one embodiment of the present invention. The power storage device of one embodiment of the present invention can be used for an electric bicycle 8700 illustrated in FIG. 31A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 31B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may include the small solid-state secondary battery illustrated in FIG. 27A and FIG. 27B. When the small solid-state secondary battery illustrated in FIG. 27A and FIG. 27B is provided in the control circuit 8704, electric power can be supplied to store data in a memory circuit included in the control circuit 8704 for a long time. When the control circuit 8704 is used in combination with a secondary battery including a positive electrode using the positive electrode active material composite 100z obtained in the foregoing embodiment, the synergy on safety can be obtained. The secondary battery including the positive electrode using the positive electrode active material composite 100z obtained in the foregoing embodiment and the control circuit 8704 can contribute greatly to elimination of accidents due to secondary batteries, such as fires.

FIG. 31C illustrates an example of a motorcycle using the power storage device of one embodiment of the present invention. A motor scooter 8600 illustrated in FIG. 31C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material composite 100z obtained in the foregoing embodiment can have high capacity and contribute to a reduction in size.

In the motor scooter 8600 illustrated in FIG. 31C, the power storage device 8602 can be stored in an under-seat storage unit 8604. The power storage device 8602 can be stored in the under-seat storage unit 8604 even when the under-seat storage unit 8604 is small.

The contents in this embodiment can be combined with the contents in the other embodiments as appropriate.

### Embodiment 9

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book terminal, and a mobile phone.

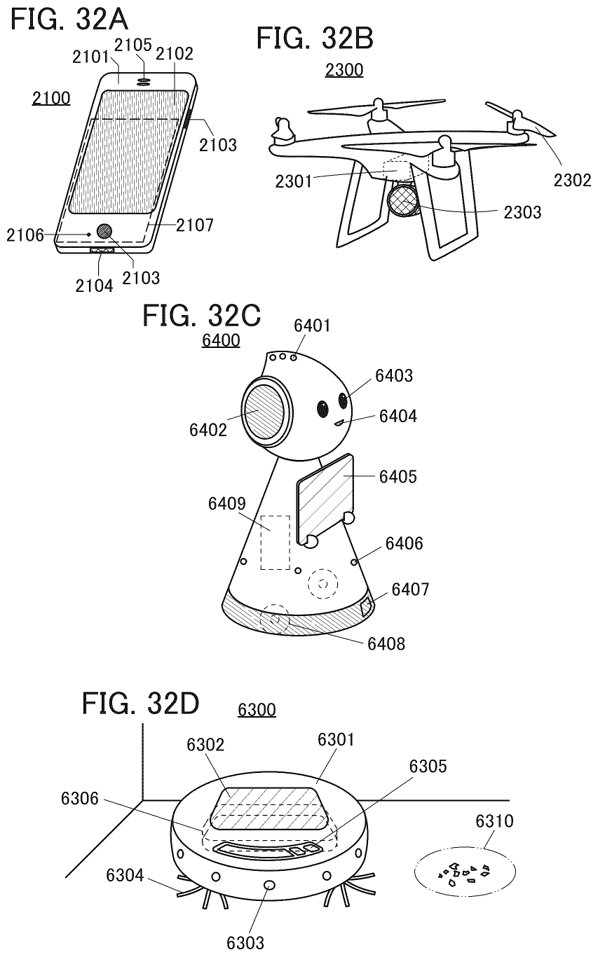

FIG. 32A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material composite 100z described in the foregoing embodiment achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 32B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material composite 100z obtained in the foregoing embodiment has high energy density and a high degree of safety and thus can be used safely for a long time over a long period of time and is suitable as the secondary battery included in the unmanned aircraft 2300.

FIG. 32C illustrates an example of a robot. A robot 6400 illustrated in FIG. 32C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material composite 100z obtained in the foregoing embodiment has high energy density and a high degree of safety and thus can be used safely for a long time over a long period of time and is suitable as the secondary battery 6409 included in the robot 6400.

FIG. 32D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material composite 100z obtained in the foregoing embodiment has high energy density and a high degree of safety and thus can be used safely for a long time over a long period of time and is suitable as the secondary battery 6306 included in the cleaning robot 6300.

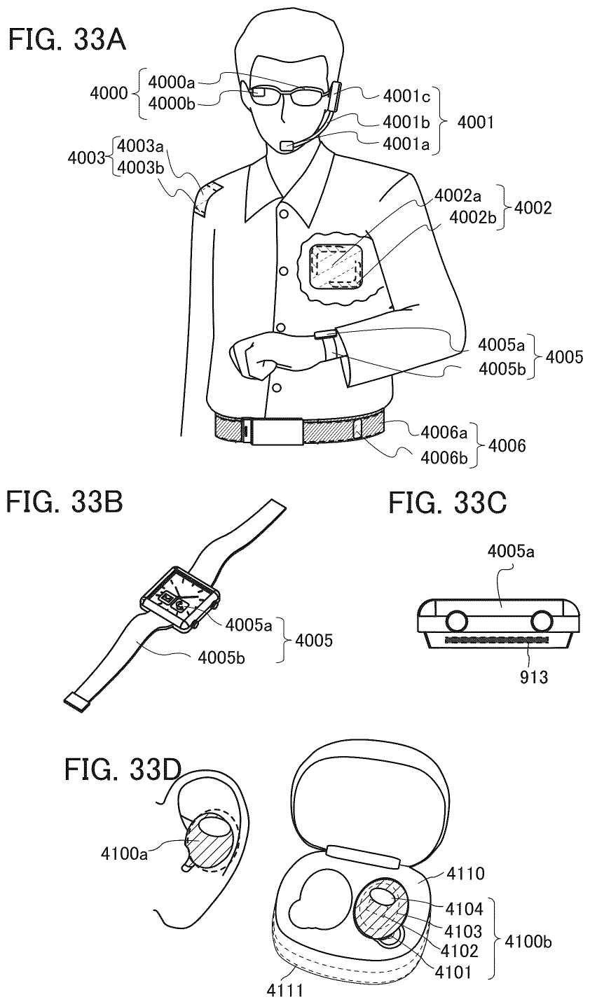

FIG. 33A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 as illustrated in FIG. 33A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material composite 100z obtained in the foregoing embodiment has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material composite 100z obtained in the foregoing embodiment has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 33B is a perspective view of the watch-type device 4005 that is detached from an arm.

FIG. 33C is a side view. FIG. 33C illustrates a state where the secondary battery 913 is incorporated in the inner region. The secondary battery 913 is the secondary battery described in Embodiment 4. The secondary battery 913 is provided to overlap the display portion 4005a, can have high density and high capacity, and is small and lightweight.

Since the secondary battery in the watch-type device 4005 is required to be small and lightweight, the use of the positive electrode active material composite 100z obtained in the foregoing embodiment in the positive electrode of the secondary battery 913 enables the secondary battery 913 to have high energy density and a small size.

FIG. 33D illustrates an example of wireless earphones. The wireless earphones illustrated as an example consist of, but not limited to, a pair of main bodies 4100a and 4100b.

Each of the main bodies 4100a and 4100b includes a driver unit 4101, an antenna 4102, and a secondary battery 4103. Each of the main bodies 4100a and 4100b may also include a display portion 4104. Moreover, each of the main bodies 4100a and 4100b preferably includes a substrate where a circuit such as a wireless IC is provided, a terminal for charge, and the like. Each of the main bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. The secondary battery obtained in the foregoing embodiment has a high energy density; thus, with the use of the secondary battery as the secondary battery 4103 and the secondary battery 4111, space saving required with downsizing of the wireless earphones can be achieved.

This embodiment can be implemented in appropriate combination with the other embodiments.

### Example 1

In this example, a negative electrode of one embodiment of the present invention was fabricated and the fabricated negative electrode was evaluated.

### <Fabrication of Negative Electrodes>

The negative electrode was fabricated according to the flowchart shown in FIG. 7. As the particles containing silicon, nanosilicon particles produced by ALDRICH were used. As the particles containing graphite, artificial graphite particles MCMB-G10 produced by Linyi Gelon New Battery Materials were used. As the graphene compound, graphene oxide was used. As the polyimide, a precursor of polyimide manufactured by Toray Industries, Inc. was used.

An electrode GS1 was fabricated as the negative electrode. The weight ratio of the materials prepared in Steps S61, S72, S80, and S87 in FIG. 7 was set to the weight ratio of the artificial graphite particles to the nanosilicon particles, the graphene oxide, and the polyimide precursor being 82.8:9.2:5:3. Note that the weight ratio of the artificial graphite particles to the nanosilicon particles is 9:1.

The nanosilicon particles and a solvent were prepared and mixed (Steps S61, S62, and S63 in FIG. 7). As the solvent, NMP was used. The mixing was performed at 2000 rpm for three minutes with use of a planetary centrifugal mixer (Awatori rentaro produced by THINKY CORPORATION) and the mixture was collected to give a mixture E-1 (Steps S64 and S65 in FIG. 7).

Next, the artificial graphite particles were prepared and mixed with the mixture E-1 (Steps S72 and S73 in FIG. 7). The mixing was performed at 2000 rpm for three minutes with use of the planetary centrifugal mixer and the mixture was collected to give a mixture E-2 (Steps S74 and S75 in FIG. 7).

Next, the mixture E-2 and a graphene compound were mixed repeatedly with a solvent added thereto. Graphene oxide was prepared as the graphene compound, mixing was performed at 2000 rpm for three minutes with use of the planetary centrifugal mixer, and the mixture was collected (Steps S80, S81, and S82 in FIG. 7). Then, the collected mixture was stiff-kneaded and NMP was added thereto as appropriate, mixing was performed at 2000 rpm for three minutes with use of the planetary centrifugal mixer, and the mixture was collected (Steps S83, S84, and Step S85 in FIG. 7). Step S83 to Step S85 were repeated five times to give a mixture E-3 (Step S86 in FIG. 7).

Next, the mixture E-3 and the precursor of polyimide were mixed (Step S88 in FIG. 7). The mixing was performed at 2000 rpm for three minutes with use of the planetary centrifugal mixer. After that, NMP was prepared and added to the mixture so that the viscosity of the mixture was adjusted (Step S89 in FIG. 7), further mixing was performed (twice at 2000 rpm for three minutes with use of the planetary centrifugal mixer), and the mixture was collected, whereby a mixture E-4 was obtained as a slurry (Steps S90, S91, and S92 in FIG. 7).

Next, a current collector was prepared and was applied to the mixture E-4 (Steps S93 and S94 in FIG. 7). A 18-μm-thick copper foil was prepared as the current collector and the mixture E-4 was applied to the copper foil with use of a doctor blade with a gap thickness of 100 μm.

Then, the first heating was performed on the copper foil to which the mixture E-4 was applied at 50° C. for one hour (Step S95 in FIG. 7). After that, the second heating was performed under reduced pressure at 400° C. for five hours (Step S96 in FIG. 7), whereby an electrode was obtained. By the heating, the graphene oxide is reduced, so that the amount of oxygen is decreased.

### <SEM>

SEM observation of the surface of the fabricated electrode was performed. S4800 produced by Hitachi High-Technologies Corporation was used as the SEM. The accelerating voltage was 5 kV.

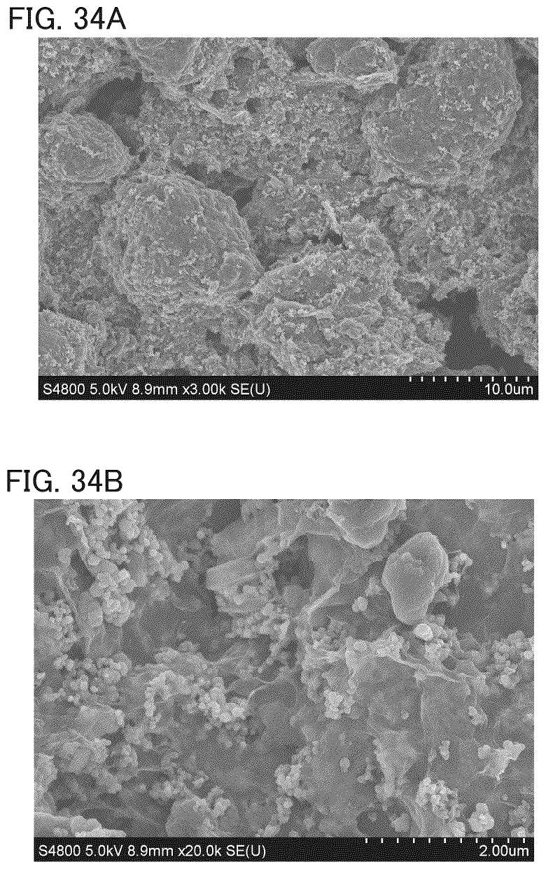

FIG. 34A and FIG. 34B are observed images of the surface of the electrode GS1. In the SEM images, the nanosilicon particles show relatively high contrast.

FIG. 34B is an enlarged image of the surface of the electrode GS1. A plurality of nanosilicon particles of approximately 50 nm to 250 nm existed on the surface of a graphite particle with a grain diameter of approximately 5 μm to 15 μm, and a region where the plurality of nanosilicon particles were covered with graphene (reduced graphene oxide) was observed. In other words, the electrode GS1 includes a region where a mixed layer of the nanosilicon particles and the graphene covers the graphite particle.

### <Fabrication of Coin Cells>

Next, five coin cells (GS-C1, GS-C2, GS-C3, GS-C4, and GS-C5, also referred to as coin-type secondary batteries) of CR2032 type (a diameter of 20 mm and a height of 3.2 mm) were fabricated using the fabricated electrode GS1.

Lithium metal was used for the counter electrode. An electrolyte solution was used in which lithium hexafluorophosphate (LiPF₆) was mixed at a concentration of 1 mol/L into a mixture of ethylene carbonate (EC) and diethyl carbonate (DEC) with EC:DEC=3:7 (in volume ratio).

As the separator, a 25-μm-thick separator formed of polypropylene was used.

A positive electrode can and a negative electrode can that were formed using stainless steel (SUS) were used.

### <Charge and Discharge Characteristics>

The evaluation of charge and discharge characteristics was performed on the fabricated five coin cells. Since lithium metal is used for the counter electrode, in each of the fabricated coin cells, the electrode GS1 functions as a positive electrode, lithium is occluded in the electrode in discharging, and lithium is released from the electrode in charging.

For the first charging and discharging of the fabricated five coin cells, the discharge condition (lithium occlusion condition) was set to constant current discharging (0.1 C and lower voltage limit of 0.01 V) and then constant voltage discharging (lower current density of 0.01 C), and charging condition (lithium release) was set to constant current charging (0.1 C and upper voltage limit of 1 V). Next, for the second charging and discharging, discharge condition (lithium occlusion condition) was set to constant current discharging (0.2 C and lower voltage limit of 0.01 V) and then constant voltage discharging (lower current density of 0.02 C), and charging condition (lithium release) was set to constant current charging (0.2 C and upper voltage limit of 1 V). Discharging and charging were performed at 25° C. Next, the third and subsequent charge and discharge cycle tests were performed in different conditions, i.e., no capacity limitation, capacity limitation of 90%, capacity limitation of 80%, capacity limitation of 70%, and capacity limitation of 60%, on the basis of the second charge capacity, in each of which discharge (lithium occlusion) condition was set to constant current discharging (0.2 C and lower voltage limit of 0.01 V) and then constant voltage discharging (lower current density of 0.02 C), and charging condition (lithium release) was set to constant current charging (0.2 C and upper voltage limit of 1 V). Discharging and charging were performed at 25° C.

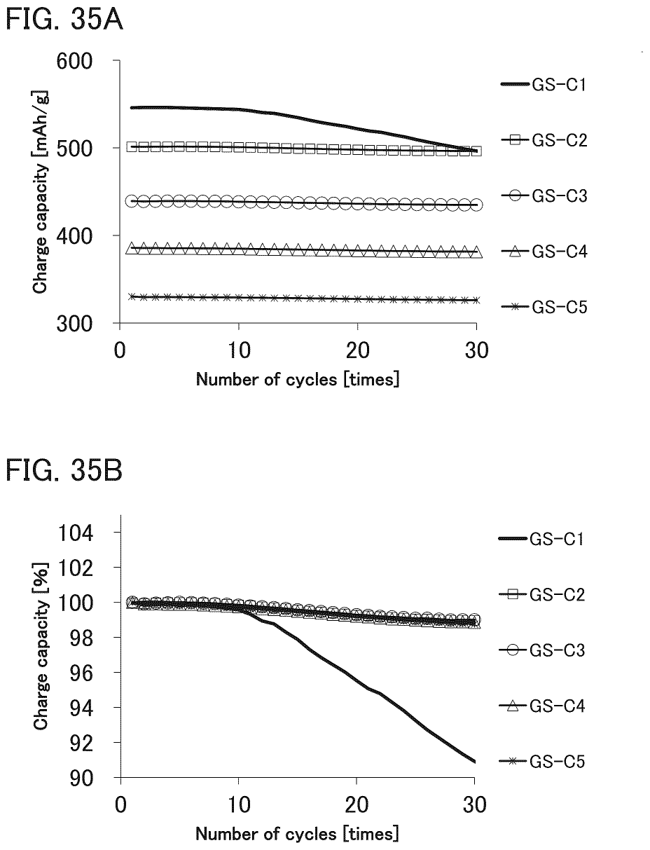

Table 2 shows the maximum charge capacities and 30-cycle retention rates of the coin cells GS-C1 to GS-C5. FIG. 35A and FIG. 35B show results of the charge and discharge cycle tests.

TABLE 2

| | | | Charge |
|---|---|---|---|
| | | Maximum | capacity |
| | Capacity | charge | at the |
| | limitation | capacity | 30th cycle |
| | condition | [mAh/g] | [%] |
| GS-C1 | No limitation | 546.1 | 90.91 |
| GS-C2 | 90% | 501.5 | 98.96 |
| GS-C3 | 80% | 439.2 | 99.00 |
| GS-C4 | 70% | 385.8 | 98.86 |
| GS-C5 | 60% | 330.1 | 98.75 |

As shown in FIG. 35A and FIG. 35B, an effect of inhibiting charge-capacity deterioration in the charge and discharge cycle test was found in the coin cells with capacity limitation (GS-C2 to GS-C5). Note that although the different conditions, i.e., the capacity limitation of 60%, 70, 80%, and 90%, were employed in the tests for GS-C2 to GS-C5, no significant difference was found among GS-C2 to GS-C5 in view of the charge capacity retention rate shown in FIG. 35B.

Next, the results of this experiment are considered together with the description in Calculation 1 for negative electrode and Calculation 2 for negative electrode in Embodiment 1.

On the basis of the description in Calculation 1 for negative electrode in Embodiment 1, an alloying ratio of silicon to lithium (Li/Si) was calculated for GS-C1 to GS-C5 with the use of Formula 1. Table 3 shows the calculation results.

$$Li / Si = \frac{\begin{matrix}actual charge capacity - 0.9 ( graphite proportion ) \times \\ 371.9 ( theoretical capacity of graphite )\end{matrix}}{\begin{matrix}0.1 ( silicon proportion ) \times \\ 4198.8 ( theoretical capacity of silicon )\end{matrix}} \frac{}{} \times 4.4 \text{(*} ) \qquad [ Formula 1 ]$$

$$* The theroetical limit equivalent of lithium - silicon alloy$$

TABLE 3

| | Capacity | |
|---|---|---|
| | limitation | |
| | condition | Li/Si |
| GS-C1 | No limitation | 2.22 |
| GS-C2 | 90% | 1.75 |
| GS-C3 | 80% | 1.09 |
| GS-C4 | 70% | 0.54 |

As shown in Table 3, Li/Si is calculated as 2.22 for GS-C1 whose charge and discharge characteristics were not excellent. Meanwhile, for GS-C2 with excellent charge and discharge characteristics, Li/Si is 1.75, which is found to be close to the ratio of the structure shown in FIG. 6B (the crystal structure with Li/Si=1.714). Given that the structure shown in FIG. 6B has Si—Si bonds, there is a possibility that charging and discharging were performed in GS-C2 to GS-C5 within the range where Si—Si bonds were not lost, which can be regarded as a factor allowing the favorable charge and discharge characteristics.

### Example 2

In this example, a coin cell fabricated using the electrode GS1 described in Example 1 and an ionic liquid was evaluated.

### <Fabrication of Coin Cell>

Next, a coin cell (GS-C6, also referred to as a coin-type secondary battery) of CR2032 type (a diameter of 20 mm and a height of 3.2 mm) was fabricated using the fabricated electrode GS1.

Lithium metal was used for the counter electrode. As the electrolyte solution, EMI-FSI containing LiFSI at a concentration of 2.15 mol/L was used.

As the separator, a 25-μm-thick separator made of polypropylene and a 260-μm-thick separator made of glass fiber were stacked to be used.

A positive electrode can and a negative electrode can that were formed using stainless steel (SUS) were used.

### <Charge and Discharge Characteristics>

The evaluation of charge and discharge characteristics was performed on the fabricated coin cell GS-C6. Since lithium metal is used as the counter electrode, in the fabricated coin cell, the electrode GS1 functions as a positive electrode, lithium is occluded in the electrode in discharging, and lithium is released from the electrode in charging

For the first charging and discharging of the fabricated coin cell GS-C6, the discharge condition (lithium occlusion condition) was set to constant current discharging (0.1 C and lower voltage limit of 0.01 V) and then constant voltage discharging (lower current density of 0.01 C), and charging condition (lithium release) was set to constant current charging (0.1 C and upper voltage limit of 1 V). Next, for the second charging and discharging, discharge condition (lithium occlusion condition) was set to constant current discharging (0.2 C and lower voltage limit of 0.01 V) and then constant voltage discharging (lower current density of 0.02 C) s, and charging condition (lithium release) was set to constant current charging (0.2 C and upper voltage limit of 1 V). Then, the third and subsequent charge and discharge cycle tests were performed in the condition with capacity limitation of 80% on the basis of the second charge capacity, in which discharge (lithium occlusion) condition was set to constant current discharging (0.2 C and lower voltage limit of 0.01 V) and then constant voltage discharging (lower current density of 0.02 C), and charging condition (lithium release) was set to constant current charging (0.2 C and upper voltage limit of 1 V). Discharging and charging were performed at 25° C.

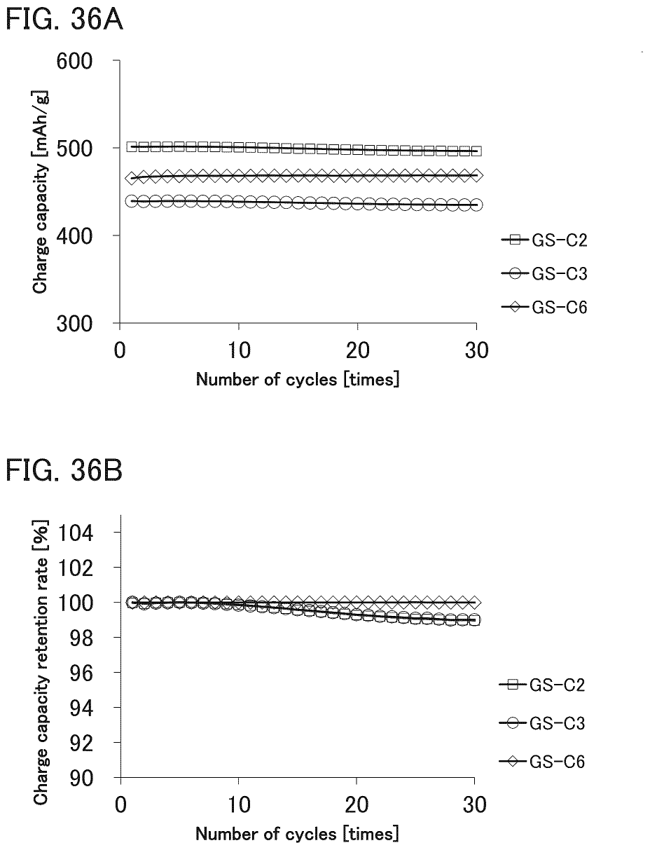

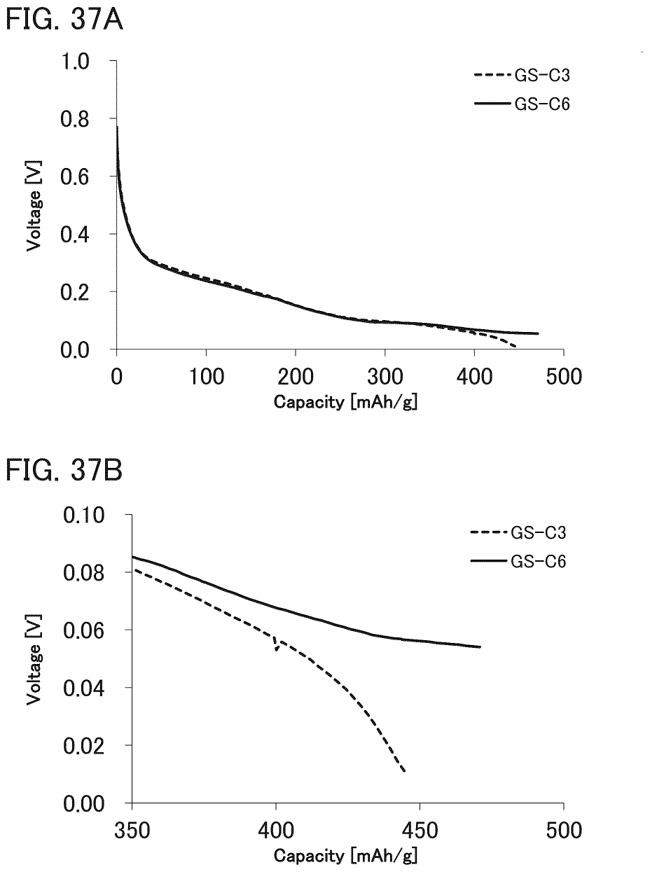

FIG. 36A and FIG. 36B show the results of the charge and discharge cycle test of GS-C6 together with the results of GS-C2 and GS-C3. The maximum charge capacity was 468 mAh/g and the 30-cycle retention rate was 99.99%, i.e., extremely excellent characteristics were obtained. Note that the calculation result of GS-C6 with the use of Formula 1 is Li/Si=1.40. FIG. 37A and FIG. 37B show curves of the third discharging (initial discharging in the capacity limitation condition) of GS-C3 and GS-C6. FIG. 37B is an enlarged view of part of FIG. 37A.

As shown in FIG. 36A and FIG. 36B, GS-C6 has excellent charge and discharge cycle characteristics. The relationship between the Li/Si ratio and the charge and discharge characteristics is described in Embodiment 1, and Li/Si=1.40 of GS-C6 is an intermediate value between the Li/Si value of GS-C2 and the Li/Si value of GS-C3; nevertheless, a significant result, i.e., charge and discharge cycle deterioration of 99.99%, is shown in FIG. 36B. Furthermore, as shown in FIG. 37B, the potential of GS-C6 is higher than or equal to 0.05 V even at the time of the termination of discharging (at the time of the termination of Li occlusion), which indicates a possibility that Li precipitation and reductive decomposition of the electrolyte solution are inhibited. In this manner, an effect of significant characteristics improvement, which cannot be easily assumed, was able to be obtained when the secondary battery including the negative electrode of one embodiment of the present invention and the ionic liquid was used under the capacity limitation conditions.

### REFERENCE NUMERALS

560a: negative electrode characteristic curve, 560b: positive electrode characteristic curve, 570a: negative electrode, 570b: positive electrode, 571a: negative electrode current collector, 571b: positive electrode current collector, 572a: negative electrode active material layer, 572b: positive electrode active material layer, 576: electrolyte, 581: first active material, 582: second active material, 583: graphene compound

1. A lithium-ion secondary battery comprising:
a positive electrode;
a negative electrode;
an electrolyte solution; and
a separator,
wherein the negative electrode comprises a first negative electrode active material comprising a silicon particle, a second negative electrode active material comprising graphite whose particle diameter is larger than a particle diameter of the silicon particle, and a graphene or a graphene compound,
wherein the silicon particle is in contact with the graphite, and the graphene or the graphene compound make surface contact with the first negative electrode active material and the second negative electrode active material, and
wherein the silicon particle comprises silicon oxide.

2. The lithium-ion secondary battery according to claim 1,
wherein the silicon oxide comprises amorphous.

3. The lithium-ion secondary battery according to claim 1,
wherein a particle diameter of the first negative electrode active material is less than or equal to 250 nm, and
wherein a particle diameter of the second negative electrode active material is greater than or equal to 5 μm.

4. The lithium-ion secondary battery according to claim 1,
wherein the negative electrode comprises a negative electrode current collector, and
wherein the negative electrode current collector comprises copper.

5. The lithium-ion secondary battery according to claim 1,
wherein the first negative electrode active material is in contact with the second negative electrode active material so as to cover, surround, or cling to the second negative electrode active material.

6. The lithium-ion secondary battery according to claim 1,
wherein the graphene or the graphene compound is in contact with the first negative electrode active material and the second negative electrode active material so as to cover, surround, or cling to the first negative electrode active material and the second negative electrode active material.

7. The lithium-ion secondary battery according to claim 1,
wherein the silicon particle comprises SiOx, and x is smaller than 2.

8. A lithium-ion secondary battery comprising:
a positive electrode;
a negative electrode;
an electrolyte solution; and
a separator,
wherein the negative electrode comprises a first negative electrode active material comprising a compound comprising silicon, a second negative electrode active material comprising graphite whose particle diameter is larger than a particle diameter of the compound comprising silicon, and a graphene or a graphene compound, and
wherein the compound comprising silicon is in contact with the graphite, and the graphene or the graphene compound make surface contact with the first negative electrode active material and the second negative electrode active material.

9. The lithium-ion secondary battery according to claim 8,
wherein the compound comprising silicon comprises Li₂SiO₃ or Li₄SiO₄.

10. The lithium-ion secondary battery according to claim 8,
wherein a particle diameter of the first negative electrode active material is less than or equal to 250 nm, and
wherein a particle diameter of the second negative electrode active material is greater than or equal to 5 μm.

11. The lithium-ion secondary battery according to claim 8,
wherein the negative electrode comprises a negative electrode current collector, and
wherein the negative electrode current collector comprises copper.

12. The lithium-ion secondary battery according to claim 8,
wherein the first negative electrode active material is in contact with the second negative electrode active material so as to cover, surround, or cling to the second negative electrode active material.

13. The lithium-ion secondary battery according to claim 8,
wherein the graphene or the graphene compound is in contact with the first negative electrode active material and the second negative electrode active material so as to cover, surround, or cling to the first negative electrode active material and the second negative electrode active material.

14. The lithium-ion secondary battery according to claim 8,
wherein the compound comprising silicon comprises SiOx, and x is smaller than 2.

15. A lithium-ion secondary battery comprising:
a positive electrode;
a negative electrode;
an electrolyte solution; and
a separator,
wherein the negative electrode comprises a first negative electrode active material comprising a silicon particle, a second negative electrode active material comprising graphite whose particle diameter is larger than a particle diameter of the silicon particle, and a conductive additive,
wherein the silicon particle is in contact with the graphite, and
wherein the silicon particle comprises silicon oxide.

16. The lithium-ion secondary battery according to claim 15,
wherein the silicon oxide comprises amorphous.

17. The lithium-ion secondary battery according to claim 15,
wherein a particle diameter of the first negative electrode active material is less than or equal to 250 nm, and
wherein a particle diameter of the second negative electrode active material is greater than or equal to 5 μm.

18. The lithium-ion secondary battery according to claim 15,
wherein the negative electrode comprises a negative electrode current collector, and
wherein the negative electrode current collector comprises copper.

19. The lithium-ion secondary battery according to claim 15,
wherein the first negative electrode active material is in contact with the second negative electrode active material so as to cover, surround, or cling to the second negative electrode active material.

20. The lithium-ion secondary battery according to claim 15,
wherein the graphene or the graphene compound is in contact with the first negative electrode active material and the second negative electrode active material so as to cover, surround, or cling to the first negative electrode active material and the second negative electrode active material.

21. The lithium-ion secondary battery according to claim 15,
wherein the silicon particle comprises SiOx, and x is smaller than 2.

22. A lithium-ion secondary battery comprising:
a positive electrode;
a negative electrode;
an electrolyte solution; and
a separator,
wherein the negative electrode comprises a first negative electrode active material comprising a compound comprising silicon, a second negative electrode active material comprising graphite, and a conductive additive, and
wherein the compound comprising silicon is in contact with the graphite.

23. The lithium-ion secondary battery according to claim 22,
wherein the compound comprising silicon comprises Li₂SiO₃ or Li₄SiO₄.

24. The lithium-ion secondary battery according to claim 22,
wherein a particle diameter of the first negative electrode active material is less than or equal to 250 nm, and
wherein a particle diameter of the second negative electrode active material is greater than or equal to 5 μm.

25. The lithium-ion secondary battery according to claim 22,
wherein the negative electrode comprises a negative electrode current collector, and
wherein the negative electrode current collector comprises copper.

26. The lithium-ion secondary battery according to claim 22,
wherein the first negative electrode active material is in contact with the second negative electrode active material so as to cover, surround, or cling to the second negative electrode active material.

27. The lithium-ion secondary battery according to claim 22,
wherein the compound comprising silicon comprises SiOx, and x is smaller than 2.

28. The lithium-ion secondary battery according to claim 22,
wherein a particle diameter of the graphite is larger than a particle diameter of the compound comprising silicon.
